(19) United States
(12) Patent Application Publication
(10) Pub. No.: US 2026/0096704 A1
(43) Pub. Date: Apr. 9, 2026

(54) SURFACE CLEANER WITH COANDA SEPARATOR

(71) Applicant: SHARKNINJA OPERATING LLC, Needham, MA (US)

(72) Inventors: Casey McClay, Alhambra, CA (US); Rachel Zou, Needham, MA (US)

(21) Appl. No.: 19/007,317

(22) Filed: Dec. 31, 2024

Related U.S. Application Data
(60) Provisional application No. 63/705,224, filed on Oct. 9, 2024.

(51) Int. Cl. A47L 9/16; B01D 45/16

(52) U.S. Cl. CPC A47L 9/1608; A47L 9/165; B01D 45/16

(57) ABSTRACT

Disclosed herein is a surface cleaner that provides an airflow away from a surface to remove debris. The surface cleaner can include a dirty air inlet, a clean air outlet, a suction motor moving air along a flow path from the dirty air inlet to the clean air outlet, and a Coanda separator positioned within the flow path to separate the air and the debris.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to surface cleaners and, in particular, surface cleaners with Coanda separators for removing particulate matter from an airflow.

### BACKGROUND

Surface cleaners can be configured to clean one or more surfaces (e.g., a floor). Surface cleaners may include, for example, a vacuum cleaner, a mop, a steam cleaning apparatus, a sweeper (e.g., a powered sweeper), and/or any other surface treatment apparatus. One example of a vacuum cleaner may include a handheld vacuum cleaner. A handheld vacuum cleaner is particularly suited for cleaning tasks that require increased maneuverability and/or involve surfaces that are not on the floor. Another example of a vacuum cleaner may include an upright vacuum cleaner. Upright vacuum cleaners may include a larger debris container and/or more powerful suction motor compared to a handheld vacuum cleaner since the weight of the upright vacuum cleaner is generally intended to be supported by the floor.

### SUMMARY

Disclosed herein is a surface cleaner that provides an airflow away from a surface to remove debris. The surface cleaner can comprise: a dirty air inlet; a clean air outlet; a suction motor that can move air along a flow path from the dirty air inlet to the clean air outlet, and a Coanda separator positioned within the flow path to separate the air and the debris. When the dirty air inlet is positioned proximate the surface, the moving air can transport debris away from the surface.

In some implementations, the Coanda separator comprises: a chamber including an inlet downstream of the dirty air inlet configured to introduce the air entrained with the debris into the chamber, the chamber comprising a peripheral surface having one or more planar faces; an inner core positioned within the chamber having hollow interior configured to conduct clean air toward the dirty air outlet; a plurality of core openings configured to conduct air from the chamber to the hollow interior of the inner core without the debris; and a plurality of curved surfaces on the inner core adjacent to the plurality of core openings configured to induce the air to travel along the curved surface toward the plurality of core opening with a Coanda effect to separate the air from the debris.

In some implementations, the inlet of the chamber is configured to introduce the air entrained with the debris into the chamber tangentially to the inner core.

In some implementations, the inlet of the chamber is configured to introduce the air entrained with the debris into the chamber at an angle with respect to at least one of the planar faces of the peripheral surface.

In some implementations, the peripheral surface has a polygonal cross-sectional profile.

In some implementations, the plurality of curved surfaces are arranged around a longitudinal axis of the chamber and induce the air to flow toward the plurality of core openings out of the chamber to inhibit the air from forming a cyclone around the longitudinal axis of the chamber.

In some implementations, the Coanda separator is configured to form a pressure gradient in the chamber wherein the air entrained with the debris travels at faster velocities adjacent to the peripheral surface than adjacent to the inner core positioned along the longitudinal axis of the chamber, wherein the pressure gradient inhibits the air from forming a cyclone around the longitudinal axis of the chamber.

Disclosed herein is a multi-stage vacuum cleaner comprising: a suction motor moving air along a flow path from a dirty air inlet to a clean air outlet, the dirty air inlet configured to receive the air mixed with comparatively larger and smaller debris, the clean air outlet configured to discharge the air without the larger and smaller debris; a primary separator within the flow path and shaped to divide the comparatively larger debris and the air; and a secondary separator within the flow path downstream from the primary separator and shaped to divide the comparatively smaller debris from the air. In some aspects, one or more of the primary separator and secondary separators comprise a Coanda separator.

In some implementations, the primary separator comprises the Coanda separator shaped to remove the air from the comparatively larger debris.

In some implementations, the secondary separator comprises an additional Coanda separator shaped to remove the air from the comparatively smaller debris.

In some implementations, the secondary separator comprises a Cyclone separator shaped to remove the comparatively smaller debris from the air.

In some implementations, the secondary separator comprises the Coanda separator shaped to remove the air from the comparatively smaller debris.

In some implementations, the primary separator comprises an additional Coanda separator shaped to remove the air from the comparatively larger debris.

In some implementations, the primary separator comprises a Cyclone separator shaped to remove the comparatively larger debris from the air.

In some implementations, the secondary separator comprises more than two (2) secondary separators.

In some implementations, the other of the primary separator and secondary separator that does not comprises the Coanda separator comprises a filter.

Disclosed herein is a surface cleaner that removes debris by directing airflow away from a surface. The surface cleaner can comprise: a suction motor moving air along a flow path away from the surface; a separating chamber including a dirty air inlet upstream of a clean air outlet along the flow path; a hollow core positioned within the separating chamber, the hollow core including a clean air return along an interior of the hollow core downstream of the dirty air inlet and upstream of the clean air outlet of the separating chamber; a plurality of curved surfaces protruding from an exterior of the hollow core; and a plurality of openings along the exterior of the hollow core forming vias from the interior of the separating chamber to the clean air return of the hollow core, the air staying attached to the curved surfaces, bending toward the openings, and flowing through the vias to the clean air return while the debris ricochets off the curved surfaces causing separation from the air.

In some implementations, an inlet housing surface within the chamber configured to disrupt airflow within the separating chamber after the air enters the separating chamber from the dirty air inlet to inhibit air from circulating around the separating chamber in a circle after entering the separating chamber.

In some implementations, the hollow core is positioned along a longitudinal center of the separating chamber.

Disclosed herein is a vacuum cleaner comprising: a dirty air inlet receiving air and debris; a clean air outlet discharging the air without the debris; a suction motor moving the air along a flow path from the dirty air inlet to the clean air outlet; and a separator positioned within the flow path to divide the air and the debris. The separator can include: a chamber including an inlet downstream of the dirty air inlet, and an outlet upstream of the clean air outlet, at least a portion of the interior of the chamber forming a polygon having side segments; a core positioned within an approximate center of the chamber including a longitudinal axis and a hollow interior along the longitudinal axis forming a clean air flow path toward the outlet of the chamber; a plurality of vias through an exterior of the core, each via forming one or more through holes from the hollow interior of the chamber to the clean air flow path within the core; and a plurality of Coanda foils on the exterior of the core; the inlet of the chamber directing air toward an exterior of the core along the plurality of Coanda foils, each Coanda foil bending air flow along a surface of the Coanda foil toward one or more of the vias and into the clean air flow path of the core while the debris ricochets around the side segments of the chamber dividing the debris from the air flowing through the vias.

In some implementations, the vacuum cleaner comprises an air filter downstream of the separator and upstream of the clean air outlet.

In some implementations, the inlet of the chamber directs the air tangential to the exterior of the core.

In some implementations, the vacuum cleaner comprises a passageway configured to conduct the air and the debris from the dirty air inlet to the inlet of the chamber.

In some implementations, the passageway is positioned outside of the chamber.

In some implementations, the passageway extends through the chamber.

In some implementations, the passageway extends through the hollow interior of the core along the longitudinal axis of the chamber.

In some implementations, the vacuum cleaner comprises a debris collecting region in the chamber configured to collect debris.

In some implementations, the vacuum cleaner comprises a baffle configured to separate the debris collecting region from the hollow core.

Various combinations of the above and below recited features, embodiments, implementations, and aspects are also disclosed and contemplated by the present disclosure. Additional implementations of the disclosure are described below in reference to the appended claims, which may serve as an additional summary of the disclosure.

### BRIEF DESCRIPTION OF THE DRAWINGS

Various implementations will be described hereinafter with reference to the accompanying drawings. These implementations are illustrated and described by example only, and are not intended to limit the scope of the disclosure. In the drawings, similar elements may have similar reference numerals.

FIG. 1 is a schematic block diagram illustrating a prior art surface cleaner with cyclone separator(s).

FIGS. 2A-2D illustrate example prior art surface cleaners.

FIGS. 3A-3B illustrate cutaway views of a prior art cyclone separator.

FIG. 4A is a computational fluid mechanics diagram illustrating a fluid flow path through a cyclone separator at the cross section shown in FIG. 4B.

FIG. 4C is a schematic diagram illustrating force acting on debris in a cyclone separator.

FIG. 4D is a computational fluid mechanics diagram illustrating a fluid flow path through a cyclone separator at the cross section shown in FIG. 4E.

FIGS. 5A-5G illustrates flow paths of air and debris in a cyclone separator.

FIGS. 6A-6B are cross-sectional views of an example Coanda surface configured to separate air from debris.

FIGS. 7A-7I illustrate an example Coanda separator according to some implementations.

FIGS. 8A-8G illustrate flow paths of air and debris in a Coanda separator.

FIG. 9A is a cross-sectional view of Coanda separator shown at the cross section of FIG. 9B.

FIG. 9C is a computational fluid mechanics diagram illustrating a fluid flow path through Coanda separator at the cross section shown in FIG. 9B.

FIG. 9D is a computational fluid mechanics diagram illustrating a fluid flow path through Coanda separator at the cross section shown in FIG. 9E.

FIG. 9F is a schematic diagram illustrating force acting on debris in a Coanda separator.

FIG. 9G is a computational fluid mechanics diagram illustrating a fluid flow path through a Coanda separator at the cross section shown in FIG. 9I.

FIG. 9H is an exploded view of a portion of an inner core of Coanda separator.

FIG. 9J is a computational fluid mechanics diagram illustrating a fluid flow path through Coanda separator at the cross section shown in FIG. 9K.

FIG. 9L is a computational fluid mechanics diagram illustrating a fluid flow path through Coanda separator at the cross section shown in FIG. 9M.

FIGS. 10A-10D are schematic block diagrams illustrating a surface cleaner with Coanda separator according to various example implementations.

FIGS. 11A-11B are cross sectional views of an example inner core.

FIG. 11C is a cross-sectional view of an example chamber of a Coanda separator.

FIG. 12A is a side view of an example Coanda separator.

FIGS. 12B, 12D, and 12F are computational fluid mechanics diagram illustrating fluid flow paths through a Coanda separator at the cross sections shown in FIGS. 12C, 12E, and 12G, respectively.

FIGS. 13A-13D illustrate an example Coanda separator according to some implementations.

FIGS. 14A-14C illustrate an example inner core.

FIGS. 15A-15D illustrate an example Coanda separator according to some implementations.

FIG. 16A is a side view of an example Coanda separator.

FIGS. 16B, 16D, and 16F are computational fluid mechanics diagram illustrating fluid flow paths through a Coanda separator at the cross sections shown in FIGS. 16C, 16E, and 16G, respectively.

FIGS. 17A-17C are computational fluid mechanics diagram illustrating fluid flow paths through a Coanda separator.

FIG. 18A is a side view of an example Coanda separator.

FIGS. 18B, 18D, and 18F are computational fluid mechanics diagram illustrating fluid flow paths through a Coanda separator at the cross sections shown in FIGS. 18C, 18E, and 18G, respectively.

FIGS. 19A-19B illustrate an example Coanda separator according to some implementations.

FIG. 20 illustrates an example Coanda separator according to some implementations.

FIGS. 21A-21B illustrate an example Coanda separator according to some implementations.

FIGS. 22A-22C illustrate an example Coanda separator according to some implementations.

FIGS. 23A-23B illustrate an example Coanda separator with fine debris chamber.

FIGS. 24A-24B illustrate an example Coanda separator and inner core.

FIG. 25A is a side view of an example Coanda separator.

FIGS. 25B, 25D, 25F, and 25H, are computational fluid mechanics diagram illustrating fluid flow paths through Coanda separator at the cross sections shown in FIGS. 25C, 25E, 25G, and 25I respectively.

FIG. 25J is an exploded view of inner core with curved surface and core openings.

FIG. 26A is a side view of an example Coanda separator.

FIGS. 26B, 26D, 26F, and 26H, are computational fluid mechanics diagram illustrating fluid flow paths through Coanda separator at the cross sections shown in FIGS. 26C, 26E, 26G, and 26I respectively.

FIG. 26J is an exploded view of inner core with curved surface and core openings.

FIG. 27A is a side view of an example Coanda separator.

FIGS. 27B, 27D, 27F, and 27H, are computational fluid mechanics diagram illustrating fluid flow paths through Coanda separator at the cross sections shown in FIGS. 27C, 27E, 27G, and 27I respectively.

FIG. 27J is an exploded view of inner core with curved surface and core openings.

FIG. 28A is a side view of an example Coanda separator.

FIGS. 28B, 28D, 28F, and 28H, are computational fluid mechanics diagram illustrating fluid flow paths through Coanda separator at the cross sections shown in FIGS. 28C, 28E, 28G, and 28I respectively.

FIG. 28J is an exploded view of inner core with curved surface and core openings.

FIGS. 29A-29B illustrate an example Coanda separator according to some implementations.

FIGS. 29C-29D illustrate an example Coanda separator according to some implementations.

FIG. 30A illustrates an example Coanda separator with chamber separator.

FIG. 30B illustrates an example inner core.

FIG. 31A illustrates an example inner core.

FIG. 31B illustrates an example Coanda separator with step adjacent to inlet.

FIGS. 32A-32B illustrate an example Coanda separator according to some implementations.

FIGS. 33A-33B illustrate an example Coanda separator according to some implementations.

FIG. 34A illustrates an example Coanda separator according to some implementations.

FIGS. 34B-34J illustrate example fluid flow paths of air entrained with debris through Coanda separator.

FIGS. 35-36 illustrate an example Coanda separator according to some implementations.

FIGS. 37-38 illustrate an example Coanda separator according to some implementations.

FIGS. 39A-39B illustrate an example Coanda separator according to some implementations.

FIGS. 40A-40B illustrate an example Coanda separator according to some implementations.

FIG. 41 illustrates an example Coanda separator according to some implementations.

FIG. 42 illustrates an example Coanda separator with chamber separator.

FIGS. 43A-43B illustrate an example Coanda separator with fine debris chamber.

FIGS. 44A-44B illustrate an example Coanda separator according to some implementations.

FIGS. 45A-45C illustrate an example Coanda separator according to some implementations.

FIGS. 46A-46C illustrate an example Coanda separator according to some implementations.

FIGS. 47A-47B illustrate an example Coanda separator according to some implementations.

FIGS. 48A-48D illustrate an example Coanda separator according to some implementations.

FIGS. 49A-49B illustrate an example surface cleaner according to some implementations.

FIGS. 50A-50C illustrate an example Coanda separator according to some implementations.

### DETAILED DESCRIPTION

The present disclosure will now be described with reference to the accompanying figures, wherein like numerals may refer to like elements throughout. Specifically, reference numerals with the same last two digits may refer to components, devices, aspects, elements, etc. that may have similar structural and/or operational features. The following description is merely illustrative in nature and is in no way intended to limit the disclosure, its application, or uses. Furthermore, the devices, systems, and/or methods disclosed herein can include several novel features, no single one of which is solely responsible for its desirable attributes or which is essential to practicing the devices, systems, and/or methods disclosed herein. Additionally, the structures, systems, and/or devices described herein may be embodied as integrated components or as separate components.

Some aspects and/or implementations have been described in connection with the accompanying drawings. The figures are drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps. Various steps within a method may be executed in different order without altering the principles of the present disclosure.

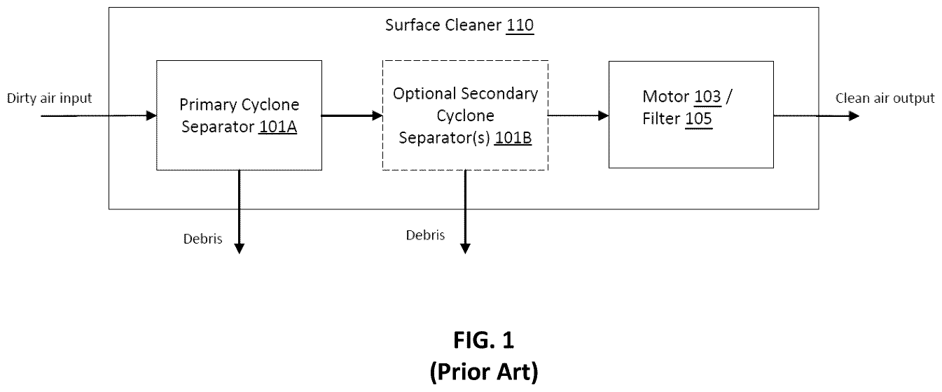

The use of a cyclone, or multiple cyclones connected in parallel or series, has long been known to be advantageous in the separation of materials of differing density, size, and shape in a fluid stream. FIG. 1 is a schematic block diagram illustrating a prior art surface cleaner 110 with cyclone(s). Surface cleaner 110 includes a primary cyclone separator 101A, optional secondary cyclone separator 101B, a motor 103, and a filter 105. The motor 103 generates an airflow to introduce dirty air to the primary cyclone separator 101A which utilizes centrifugal forces and/or pressure caused by spinning motion to separate particulate matter from the airflow. Typically, the particles which are suspended or entrained in a fluid stream are not homogeneous in their particle size distribution. The fact that particle sizes take on a spectrum of values often necessitates that a plurality of cyclone separators be used in series. If a high degree of separation is required, it is known to connect a plurality of cyclones in series. Thus, surface cleaner 110 can include one or more optional secondary cyclone separators 101B. Primary cyclone separator 101A removes larger particles which are entrained in an air stream. The smaller particles remain entrained in the air stream and are transported to the secondary cyclone separator(s) 101B. The secondary cyclone separator(s) 101B remove the smaller particles which are entrained in the air stream using centrifugal forces and/or pressure caused by spinning motion. The airflow passes from the secondary cyclone separator(s) 101B through the air filter 105 and is output from the surface cleaner 110 as clean air. Additional cyclone separators are disclosed in U.S. Pat. Nos. 6,231,645 and/or 6,168,716 which are incorporated herein by reference in their entireties.

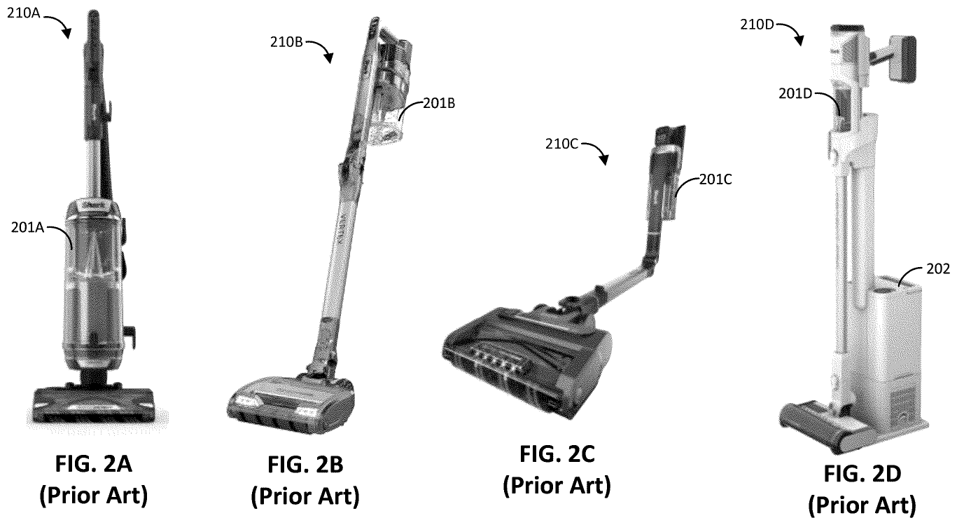

FIGS. 2A-2D illustrate example prior art surface cleaners 210A-210D which include cyclone separators 201A-201D. Surface cleaner 210A is a corded surface cleaner. Cyclone separator 201A is attached to a body of the surface cleaner 210A. Surface cleaners 210B-210D are cordless surface cleaners. Cyclone separators 201B-201D are attached to handles of the surface cleaners 210B-210D, respectively. Surface cleaner 210D is connectible to an auto-evacuation dock 202 which can include one or more cyclone separators that fluidly connects to cyclone separator 201D and generates an airflow from the cyclone separator 201D to the auto evacuation dock 202.

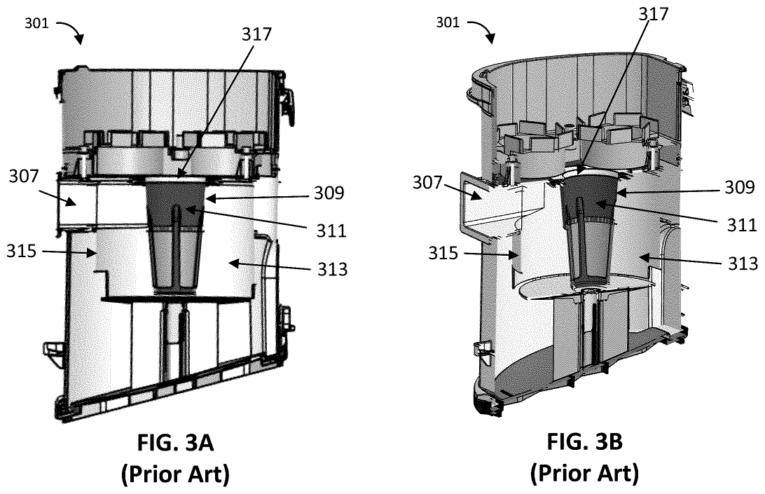

FIGS. 3A-3B illustrate cutaway views of a prior art cyclone separator 301. The cyclone separator 301 includes an inlet 307, housing 313, inner body 311, and an outlet 317. The inner body 311 is positioned within the housing 313. The inner body 311 has a body surface 309. The housing 313 includes a housing surface 315. The housing surface 315 can be cylindrical or frustoconical. The body surface 309 can be cylindrical or frustoconical.

A relatively high-speed fluid stream is introduced through the inlet 307 into the housing 313 tangentially to the housing surface 315. The dirty air stream is accelerated around the periphery of the housing 313 adjacent to the housing surface 315. The shape of inlet 307, housing surface 315, and body surface 309 induce the air stream to spin creating a vortex. The centrifugal acceleration caused by the travel of the fluid in a cyclonic stream through the housing 313 causes the particulate matter to be disentrained from the fluid flow. Larger or more dense particles are forced outwards to the housing surface 315 where the drag of the spinning air as well as the force of gravity causes the particles to fall down the housing surface 315 and collect at the bottom of the housing 313. An outlet 317 is provided for the extraction of the fluid from the top of the housing 313, as is well known in the art. The separation process in cyclones generally requires a steady flow, free of fluctuations or short term variations in the flow rate.

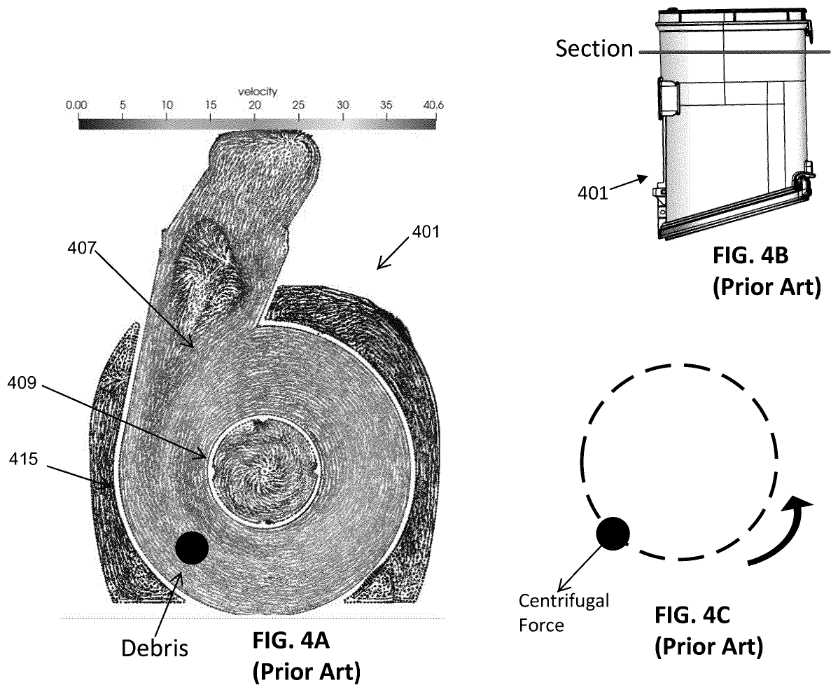

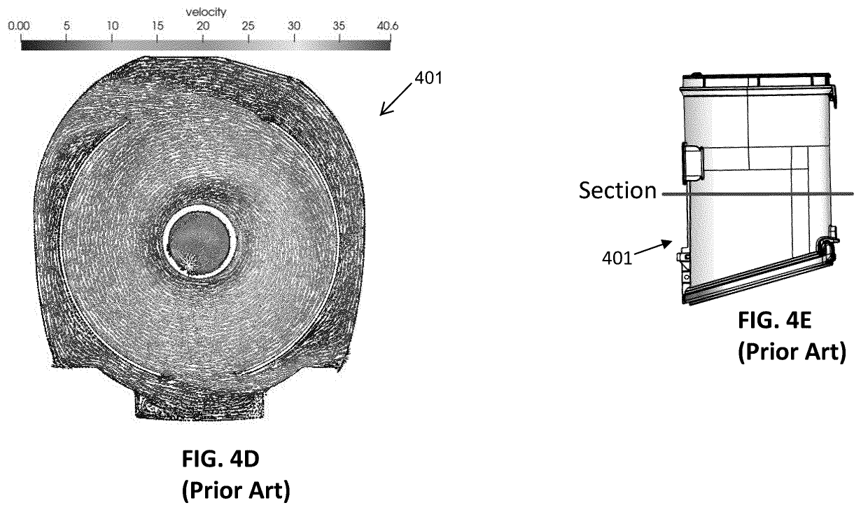

FIG. 4A is a computational fluid mechanics diagram illustrating a fluid flow path through a cyclone separator 401 at the cross section shown in FIG. 4B. Cyclone separator 401 includes inlet 407, a body surface 409, and a housing surface 415. Body surface 409 and/or housing surface 415 may be cylindrical or frustoconical. Thus, cross-sectional profiles of the body surface 409 and housing surface 415 are cylindrical, as shown in FIG. 4A.

The inlet 407 introduces a fluid stream comprising air entrained with debris tangentially to the housing surface 415. The shape of inlet 407, housing surface 415, and/or body surface 409 induce the air to travel circularly around the body surface 409. The circularly spinning air travels at varying velocities that are inversely related with radial distance from body surface 409. For example, air travels fastest adjacent to the body surface 409 and slowest adjacent to the housing surface 415 which creates a pressure gradient with areas of low pressure at the center and high pressure at the peripheries. As shown in FIG. 4C, centrifugal force caused by the circular flow path of the air forces debris outward toward the housing surface 415 which causes the debris to be disentrained from the air. As debris circles around housing surface 415, debris slows down due in part to the slower spinning air at the peripheries and due in part to friction against the housing surface 415. Gravity causes the slower moving debris to fall and collect at the bottom of the cyclone separator 401.

FIG. 4D is another computational fluid mechanics diagram illustrating a fluid flow path through a cyclone separator 401 at the cross section shown in FIG. 4E. As shown, the air rotates circularly at higher velocities near the center and lower velocities near the peripheries.

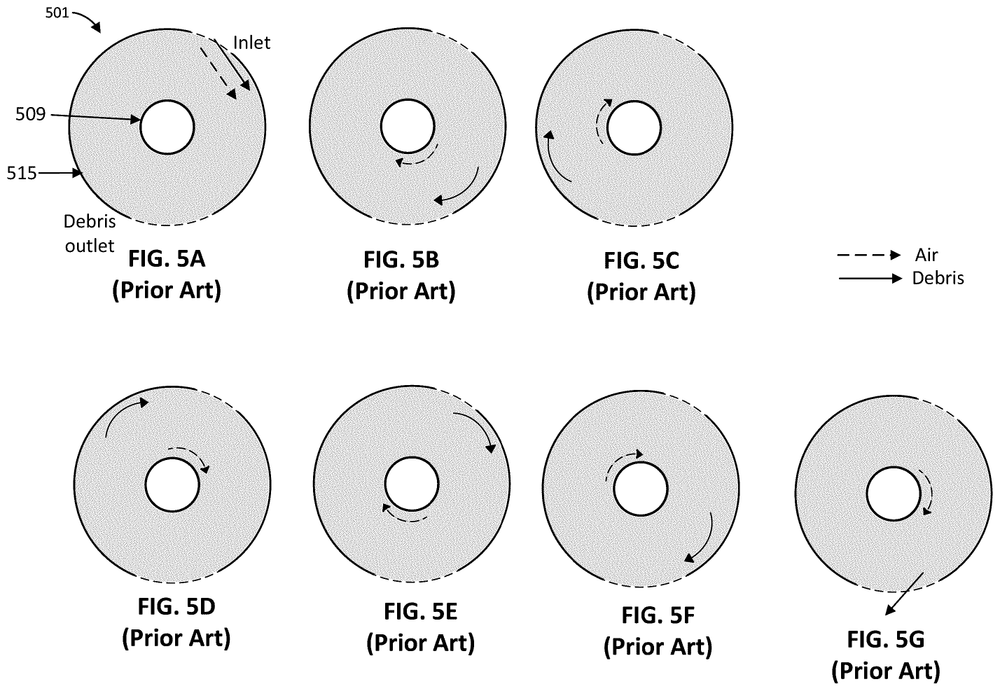

FIGS. 5A-5G illustrate flow paths of air and debris in a cyclone separator 501. As shown in FIG. 5A, air entrained with debris enters the cyclone separator 501 from an inlet. The inlet introduces the air and debris tangential to the housing surface 515. As shown in FIG. 5B, air is induced to spin around the body surface 509 circularly in a vortex. Centrifugal force caused by the circular flow path of the air causes the debris to be disentrained from the air and forces the debris outward toward the housing surface 515. As shown in FIGS. 5C-5F, the air continues to rotate circularly at higher velocities around the body surface 509 than near the housing surface 515 and the debris rotates circularly at a periphery of the cyclone separator 501 against the housing surface 515. Drag from the housing surface 515 slows the rotation of the debris until the debris exits at the debris outlet as shown in FIG. 5G.

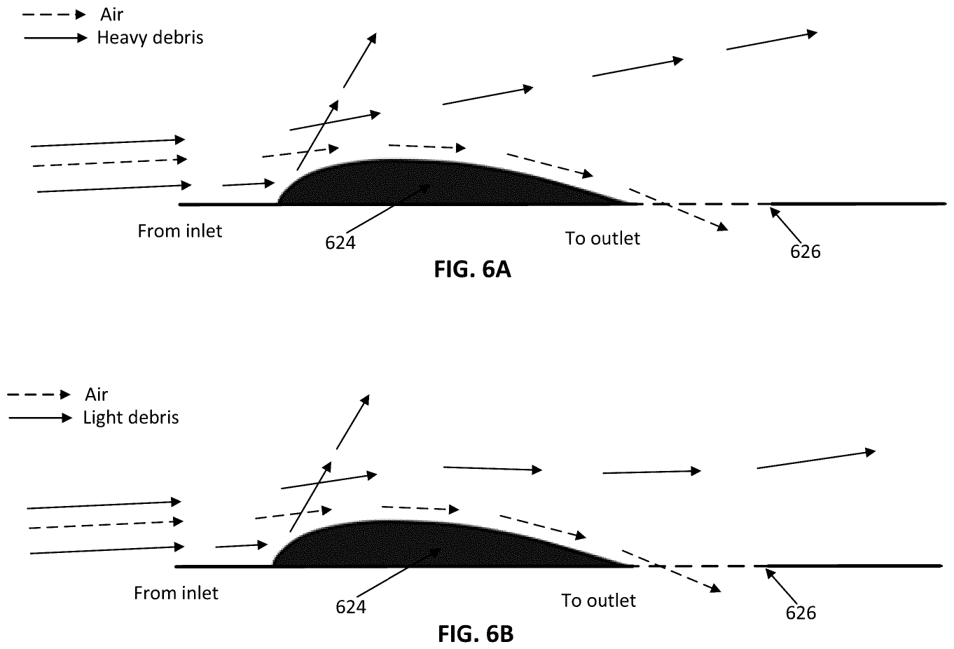

FIGS. 6A-6B are cross-sectional views of an example curved surface 624 configured to separate air from debris. The curved surface 624 is a Coanda surface and may be convex. As shown in FIG. 6A, a fluid stream comprising air and heavy debris passes over the curved surface 624 from left to right. Due to the Coanda effect, the air flow path follows the curved surface 624. Thus, the curved surface 624 changes the direction of travel of the air. The direction of travel of the heavy debris that passes adjacent to the curved surface 624 remains substantially unaffected by the Coanda effect and thus the path of travel of the heavy debris does not follow the curved surface 624. Heavy debris that contacts curved surface 624 can ricochet off curved surface 624 and travel away from curved surface 624 and/or opening 626. Thus, the curved surface 624 separates the air from the heavy debris with the Coanda effect and/or with ricochet force. The air travels along curved surface 624 following its curvature to pass through opening 626 positioned adjacent to, and downstream from, the curved surface 624 and then continues to the outlet.

As shown in FIG. 6B, a fluid stream comprising air and light debris passes over the curved surface 624 from left to right. As described, the air changes direction of travel to follow the curved surface 624 due to the Coanda effect. The light debris may, at least slightly, change direction of travel with the air, due to the smaller mass of the light debris being affected by the force of the moving air but will however continue travelling away from the curved surface 624 whereas the air follows the curved surface 624. Light debris that contacts curved surface 624 can ricochet off curved surface 624 and travel away from curved surface 624 and/or opening 626. Thus, the curved surface 624 separates the air from the light debris with the Coanda effect. The air passes through opening 626 positioned adjacent to, and downstream from, the curved surface 624 and then continues to the outlet.

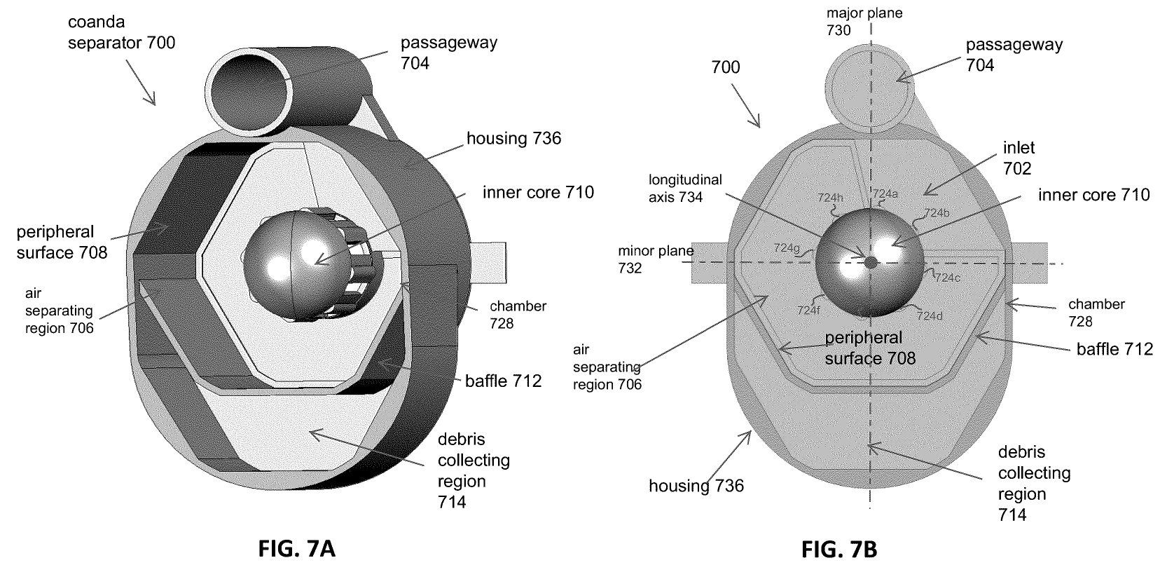

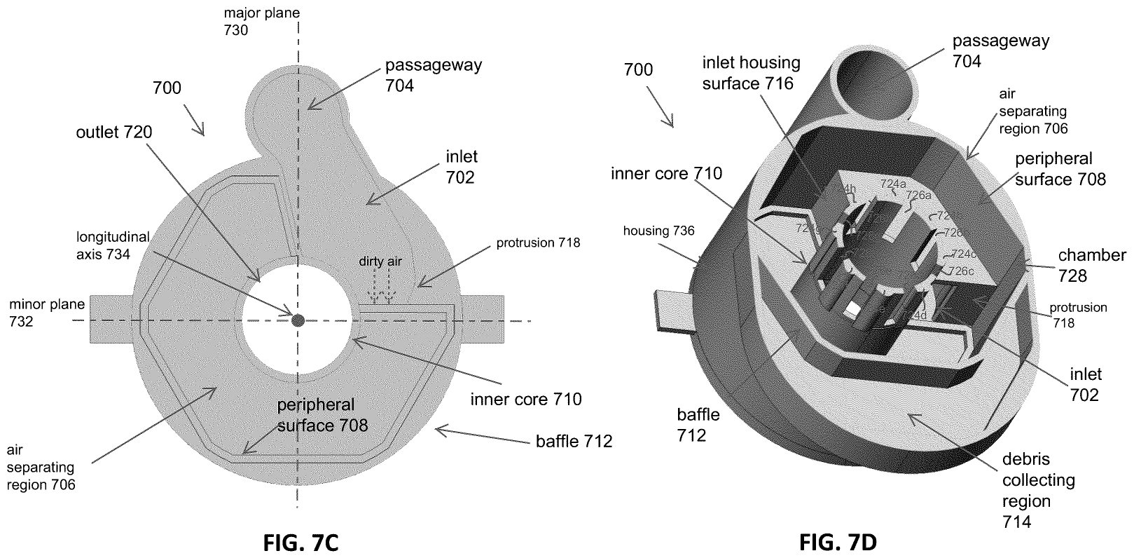

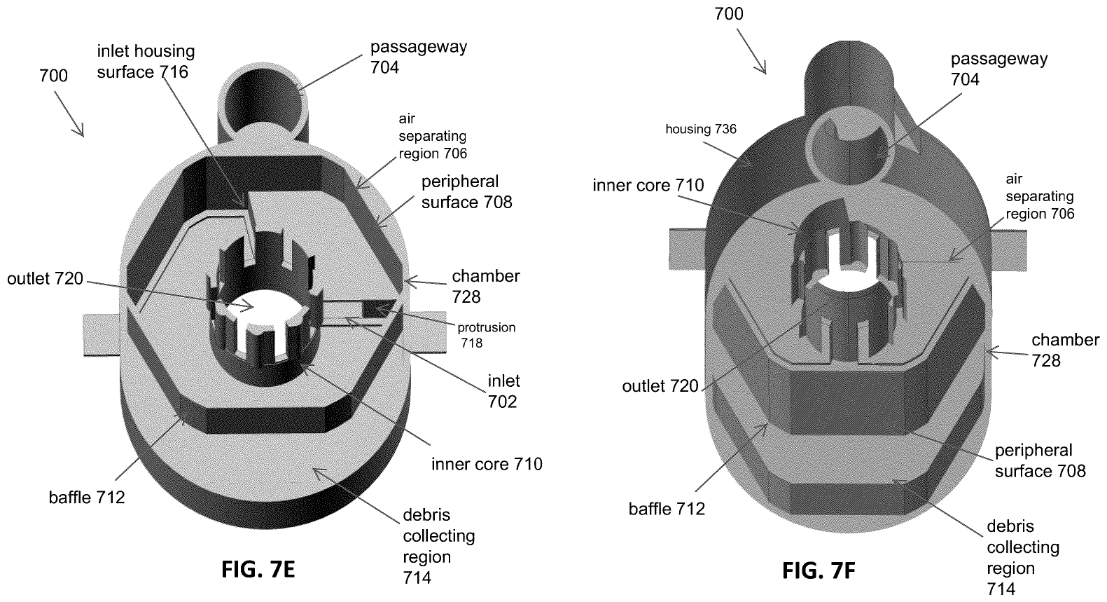

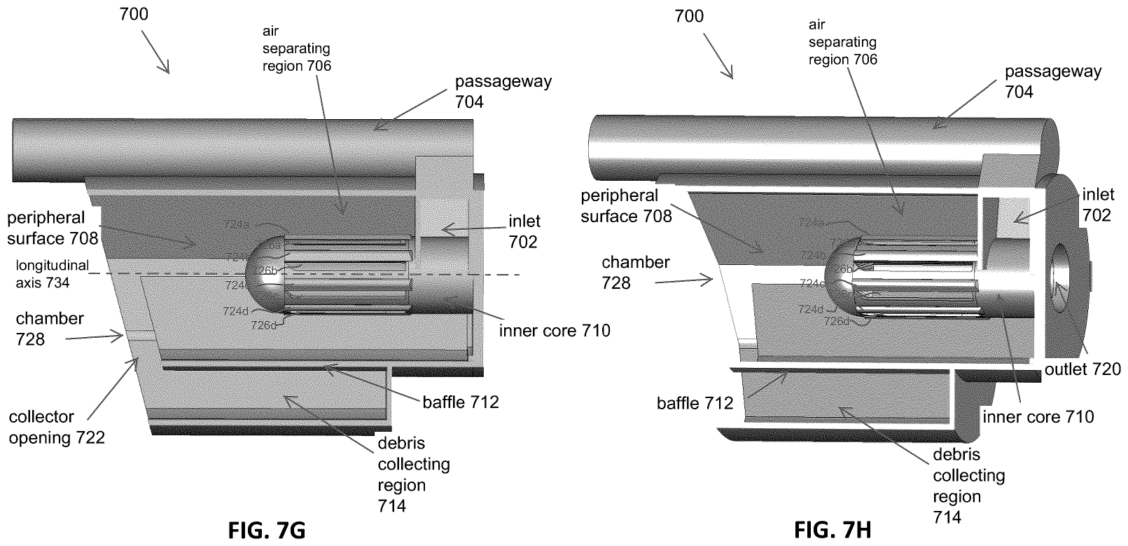

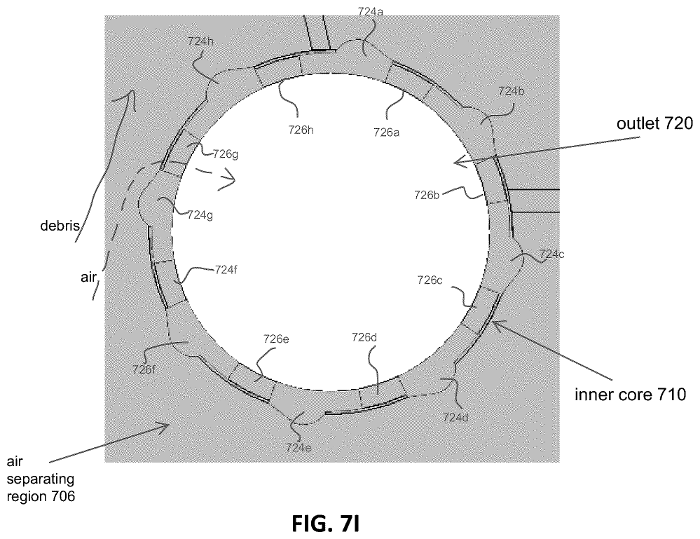

FIGS. 7A-7I illustrate an example Coanda separator 700. FIG. 7A is a perspective view of Coanda separator 700. Coanda separator 700 includes housing 736. Housing 736 includes chamber 728 which may also be referred to as “hollow body” or “separating chamber”. Chamber 728 includes air separating region 706 and debris collecting region 714. Debris collecting region 714 is positioned adjacent to air separating region 706 within chamber 728. Baffle 712 at least partially separates air separating region 706 from debris collecting region 714. Peripheral surface 708 at least partially defines chamber 728 and air separating region 706. For example, peripheral surface 708 encloses air separating region 706. Peripheral surface 708 is at least partially disposed on baffle 712. Chamber 728 houses inner core 710 within the air separating region 706. Inner core 710 may also be referred to as “hollow core” or simply “core”. Inner core 710 is surrounded by peripheral surface 708. Inner core 710 may be substantially cylindrical with a domed end. In this example, passageway 704 is positioned on housing 736 adjacent to chamber 728 and air separating region 706. Passageway 704 is connected to inlet 702 and conducts dirty air (e.g., air entrained with debris) to inlet 702.

Coanda separator 700 (or any of the other Coanda separators shown and/or described herein) can separate air and debris having a variety of shapes and/or sizes (e.g., volumes, masses, weights, thicknesses, mesh size). Debris can include dust, hair (pet hair, human hair), sand (fine sand, coarse sand), dirt, fluids, particles, organic material, food (baking soda, oats, coffee grounds), gravel (aquarium gravel), paper, garbage, discarded detritus, combinations of some or all of the foregoing or other particles, etc. Debris size can be determined by thickness which can be between 10 microns and 100 microns, between 100 microns and 250 microns, between 250 microns and 750 microns, between 750 microns and 1000 microns, between 1 mm and 5 mm, between 5 mm and 10 mm, between 10 mm and 20 mm, between 20 mm and 40 mm, or greater. In some aspects, debris size can be determined by mesh size which can be between 1250 mesh and 400 mesh, between 400 mesh and 100 mesh, between 100 mesh and 50 mesh, or between 50 mesh and 10 mesh. Coanda separator 700 can operate to remove debris out of air at a variety of separation efficiencies. In some implementations, Coanda separator 700 (or any of the other Coanda separators shown and/or described herein) can remove debris from airflow with a separation efficiency between 70% and 100%, between 80% and 100%, between 90% and 100%, between 85% and 95%, between 90% and 95%, or between 95% and 100%.

FIG. 7B is a front view of Coanda separator 700 with major plane 730, minor plane 732, and longitudinal axis 734 superimposed thereon for illustrative purposes. Major plane 730, minor plane 732, and longitudinal axis 734 extend into and out of the page. Longitudinal axis 734 is positioned at the intersection of the major plane 730 and the minor plane 732. Major plane 730 bisects passageway 704, housing 736, chamber 728, air separating region 706, peripheral surface 708, inner core 710, baffle 712, and debris collecting region 714. Minor plane 732 bisects air separating region 706, peripheral surface 708, and inner core 710. As shown in FIGS. 7B and/or 7G, longitudinal axis 734 extends through a geometric center of air separating region 706 and inner core 710. Inner core 710 extends longitudinally through chamber 728 at a geometric center of air separating region 706. One or more curved surfaces 724 (e.g., 724a-724h) are positioned on inner core 710, as shown and/or described in greater detail with respect to FIG. 7I.

Peripheral surface 708 extends contiguously around air separating region 706. Peripheral surface 708 has a polygonal cross-sectional profile that defines air separating region. In this example, air separating region 706 is defined by twelve sides (of peripheral surface 708) including six long sides and six short sides. In this example, peripheral surface 708 may be referred to as having a hexagonal cross-sectional profile (although there are twelve sides) accounting only for the long sides and disregarding the short sides. In some implementations, all sides of the cross-sectional profile of air separating region 706 may be equal length. The polygonal cross-sectional profile of peripheral surface 708 that defines air separating region 706 can have anywhere from three sides to twenty sides, for example, which may be of equal or different lengths. The various sides of polygonal cross-sectional profile may adjoin at angles or curves. Peripheral surface 708 may be non-cylindrical such that the cross-sectional profile of peripheral surface 708 is non-circular. Peripheral surface 708 may comprise a plurality of planar faces.

In this example, chamber 728 has a polygonal cross-sectional profile defined by at least twelve sides including eight long sides and at least four short sides. In this example, chamber 728 may be referred to as having an octagonal cross-sectional profile (although there are at least twelve sides) accounting only for the long sides and disregarding the short sides. In some implementations, all sides of the cross-sectional profile of chamber 728 may be equal length. The polygonal cross-sectional profile of chamber 728 can have anywhere from three sides to twenty sides, for example, which may be of equal or different lengths. The various sides of polygonal cross-sectional profile may adjoin at angles or curves. Chamber 728 may have a non-circular cross-sectional profile.

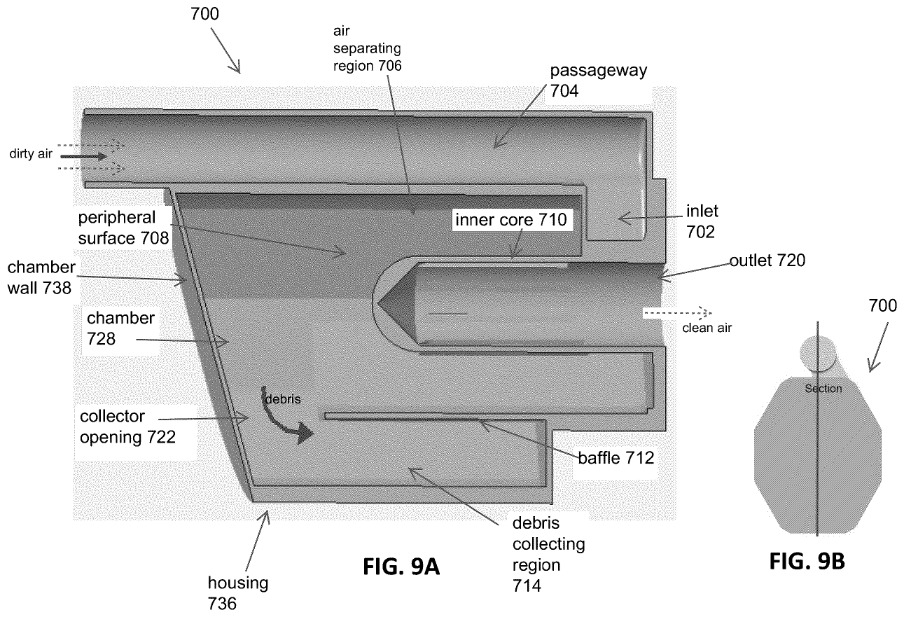

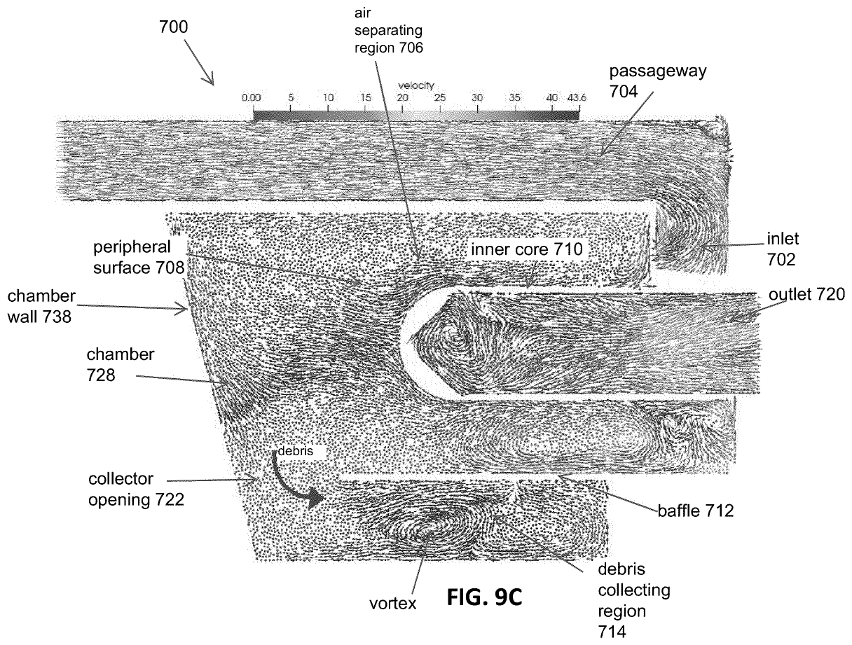

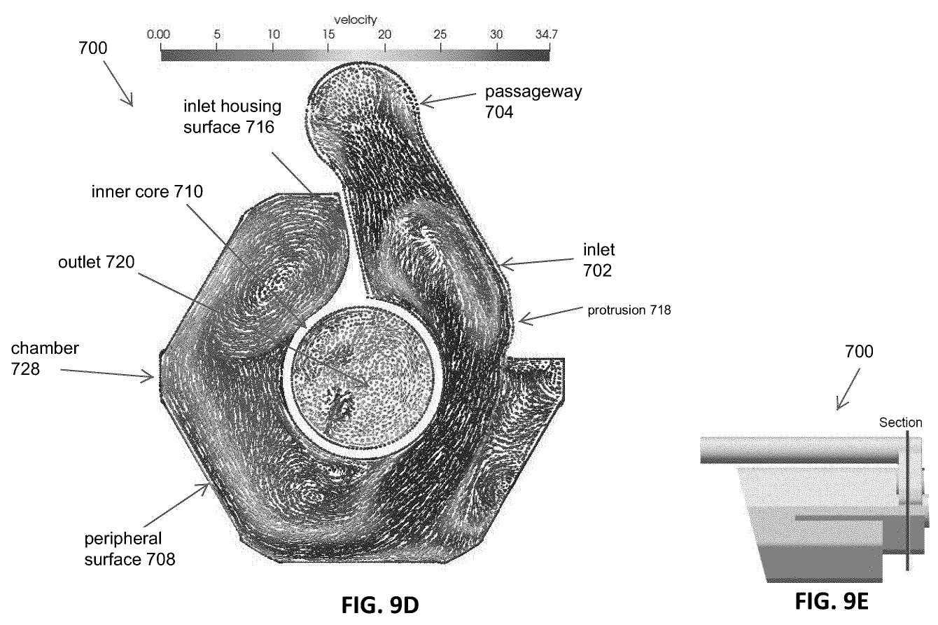

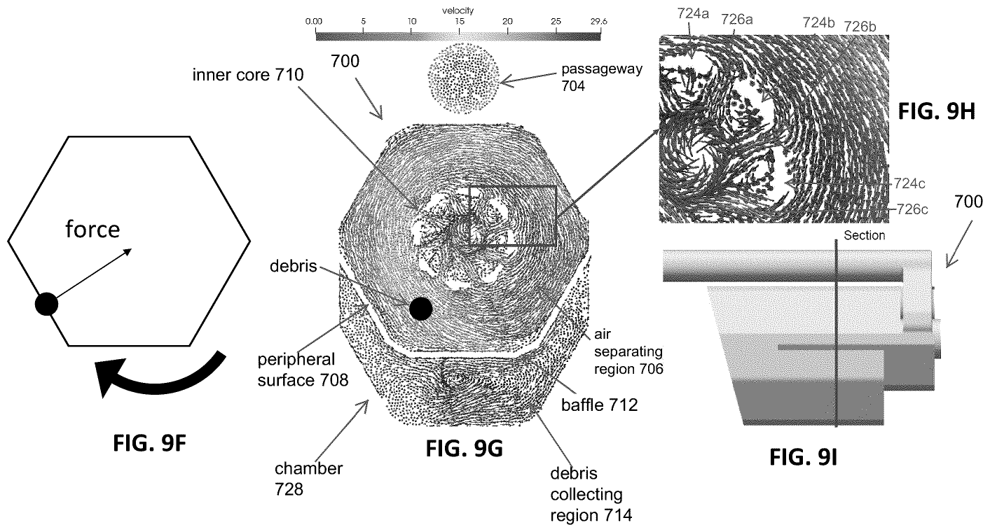

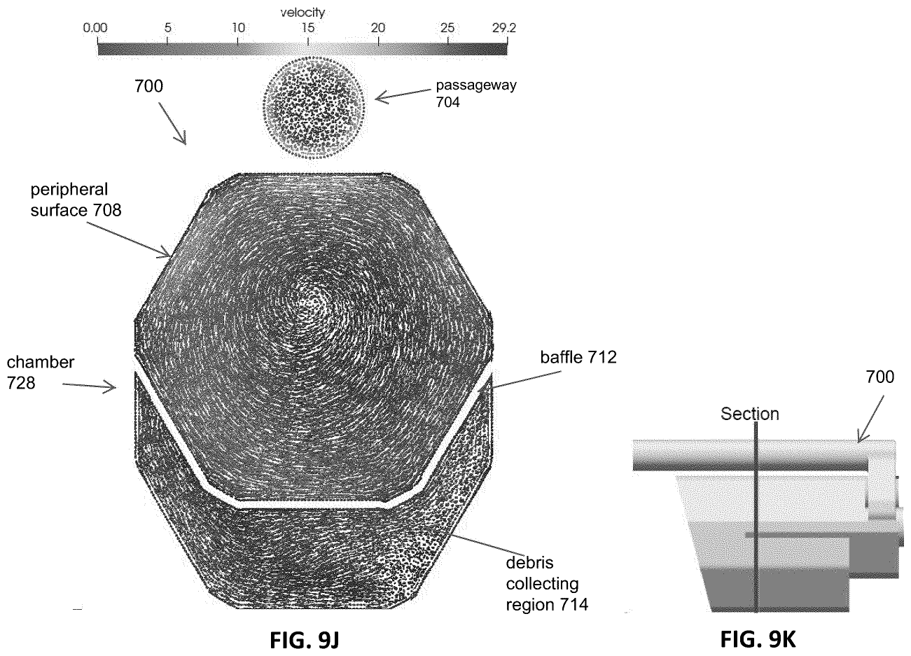

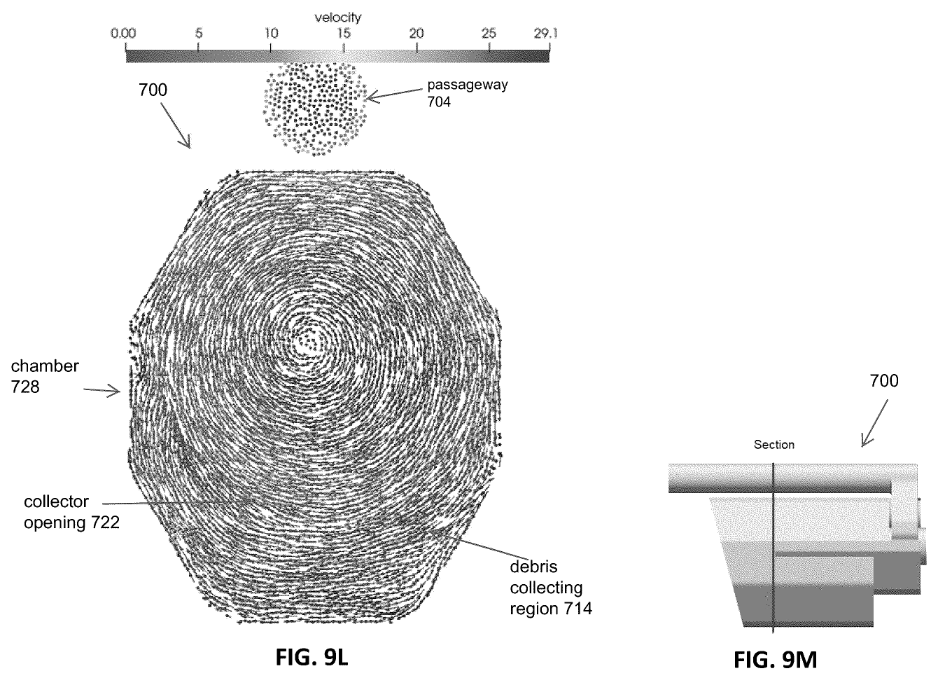

FIG. 7C is a cross-sectional view of coanda separator 700 shown at, or substantially near, the cross section shown in FIG. 9E. Passageway 704 is connected to inlet 702. Passageway 704 conducts air to the inlet 702, for example, air entrained with particulate matter (e.g., debris) which may be referred to as dirty air. Inlet 702 introduces dirty air into the air separating region 706 of chamber 728. Inlet 702 can introduce dirty air into the air separating region 706 tangentially to inner core 710. Dirty air entering air separating region 706 may not be tangential to one or more sides of peripheral surface 708 at least because peripheral surface 708 is non-circular. Inlet 702 can introduce dirty air into the air separating region 706 at an angle (e.g., non-parallel) with respect to one or more sides, or all sides, of peripheral surface 708 and may even introduce dirty air orthogonally with respect to one or more sides of peripheral surface 708. Inlet 702 is positioned adjacent to, and connected with, inner core 710. Inner core 710 may form a portion of inlet 702 such that air traveling through inlet 702 contacts inner core 710 while in the inlet 702.

In this example, inlet 702 includes protrusion 718 positioned adjacent to the opening of inlet 702 into air separating region 706. Protrusion 718 can redirect the flow of dirty air as the air exits inlet 702 before the dirty air enters the air separating region 706. For example, protrusion 718 can direct the dirty air toward the inner core 710 and/or away from the peripheral surface 708 such that dirty air exiting the inlet 702 flow tangential to the inner core 710 and away from (e.g., non-tangential and/or non-parallel) with the peripheral surface 708, as shown and/or described in greater detail at FIG. 9D.

Dirty air can circulate throughout the air separating region 706 until it exits through the inner core 710 and outlet 720. Outlet 720 is bisected by the major plane 730 and minor plane 732 such that longitudinal axis 734 extends through the geometric center of outlet 720. Outlet 720 is circular but may have a different size and/or shape. Outlet 720 is connected to inner core 710. Air enters outlet 720 from inner core 710. Outlet 720 conducts air away from chamber 728 and air separating region 706. For example, outlet 720 can conduct clean air away from air separating region 706 after the air has been separated from debris.

FIG. 7D-7F are perspective cross-sectional views of Coanda separator 700 shown at, or substantially near, the cross section shown in FIG. 9H. As shown, inlet housing surface 716 is connected to inner core 710 and peripheral surface 708 and extends contiguously between inner core 710 and peripheral surface 708. As shown and/or described in greater detail in FIG. 9D, inlet housing surface 716 disrupts airflow circulating throughout air separating region 706 after air enters air separating region 706 from inlet 702. For example, inlet housing surface 716 can inhibit dirty air from flowing continuously around inner core 710 after exiting inlet 702. Accordingly, dirty air may not flow in a circle throughout air separating region 706 after exiting inlet 702.

As shown in FIGS. 7D-7F, inner core 710 includes one or more curved surfaces 724 and one or more core openings 726. Curved surfaces 724 may be separated by core openings 726 such that a core opening 726 is positioned between adjacent curved surfaces 724. Curved surfaces 724 may be uniformly spaced from each other by core openings 726. In some implementations, curved surfaces 724 may be integrally formed with inner core 710 such that inner core 710 and curved surfaces 724 form a single, unitary structure. In some implementations, curved surfaces 724 may be removably connected to inner core 710. Air can enter inner core 710 after passing over one or more curved surfaces 724 and passing through a core opening 726. Air can then exit through the outlet 720 after having passed through the core openings 726. Core openings 726 may also be referred to as “holes”, “vias”, “slits”, “apertures”, or “openings”.

FIG. 7G-7H are cross-section views of Coanda separator 700 shown to the right of the cross section shown in FIG. 9B. As shown, inner core 710 extends along longitudinal axis 734 such that longitudinal axis 734 extends through the center of inner core 710. Inner core 710 extends only partially the length of chamber 728. Air entrained with debris can enter the air separating region 706 of the chamber 728 from inlet 702. The air and/or debris can circulate throughout the air separating region 706 around inner core 710. Air can be separated from the debris by the curved surfaces 724 and can pass through the core openings 726 as clean air without debris. The clean air can exit through outlet 720. In this example, curved surfaces 724 are a uniform length and core openings 726 are a uniform length. Curved surfaces 724 and core openings 726 extend along inner core 710 parallel to longitudinal axis 734.

Debris can pass from air separating region 706 to debris collecting region 714 through collector opening 722. Debris collecting region 714 can hold the debris. Baffle 712 separates debris collected in the debris collecting region 714 from the air separating region 706 and/or the inner core 710 such that debris in the debris collecting region 714 is inhibited from passing through core openings 726 and exiting through outlet 720. The baffle 712 is longer than, and extends past, the inner core 710. The collector opening 722 can be between 0.25 in and 2 in, between 0.5 in and 1.5, or between 0.5 in and 1.0 in. In this example, baffle 712 has a variable length. Collector opening 722 extends transversely through chamber 728 (e.g., orthogonally to longitudinal axis 734).

FIG. 7I is a cross sectional exploded view of inner core inner core 710 with curved surfaces 724 (e.g., 724a-724h) and core openings 726 (e.g., 726a-726h). As shown, curved surfaces 724 are positioned radially around inner core 710. Curved surfaces 724 may be Coanda surfaces. Curved surfaces 724 may extend away from inner core 710 with a height of between 1 mm and 5 mm, between 1 mm and 3 mm, between 1 mm and 2 mm, or between 2 mm and 3 mm. Curved surfaces may all have a uniform height, or in some aspects, their height from vary from each other. Core openings 726 are positioned adjacent to curved surfaces 724. Air entrained with debris can circulate around inner core 710 in a generally clockwise direction and can interact with curved surfaces 724 and/or core openings 726. Air can pass from the air separating region 706 to the outlet 720 via the core openings 726. As an example, air is shown passing over curved surface 724g and passing through core opening 726. Curved surface 724g induces air to change direction of travel due the Coanda effect. For example, the air travelling adjacent to the curved surface 724g may be induced to follow the curvature of curved surface 724g, and to thus flow toward and through core opening 726g. Debris may be unaffected by the Coanda effect. Thus, debris may not be induced to change direction of travel and/or to follow the curvature of the curved surface 724g and thus may continue travelling in a straight or substantially linear course without entering core opening 726g. Thus, curved surface 724g can alter the flow path of air with the Coanda effect to separate the air from debris. The example discussed with respect to curved surface 724g and core opening 726g is illustrative of each of the other curved surfaces 724 and core openings 726. In this example, eight curved surface 724 are shown, however, any number of curved surfaces may be implemented in Coanda separator 700, such as one, two, three, four, five, six, seven, nine, ten, eleven, twelve, or more than twelve curved surfaces.

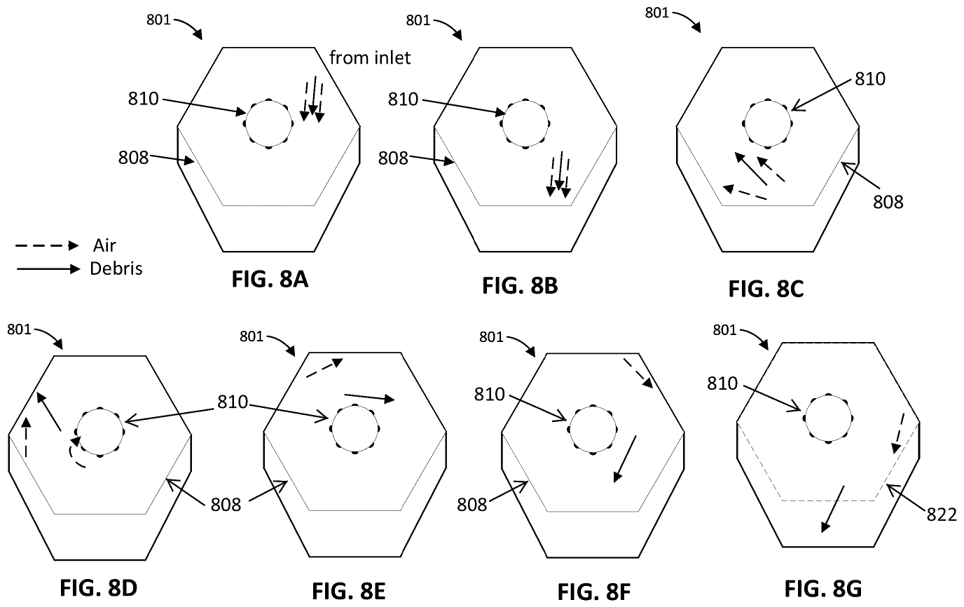

FIGS. 8A-8G illustrate flow paths of air and debris in a Coanda separator 801. In this example, peripheral surface 808 has a hexagonal cross-sectional profile. In some implementations, peripheral surface 808 may have another polygonal cross-sectional profile, such as a triangle, quadrilateral, pentagon, heptagon, octagon, nonagon, decagon, etc. Thus, peripheral surface 808 can have a plurality of sides, including any number of sides of sides between 3 and 10, or between 10 and 20, etc. In some implementations, one or more sides of peripheral surface 808 may be different lengths. In some implementations, one or more sides of peripheral surface 808 may be curved, and in some aspects, peripheral surface 808 may have a curved cross-sectional profile, such as circular or ovular. As shown in FIG. 8A, air entrained with debris enters the Coanda separator 801 from an inlet. The inlet introduces the air and debris tangential to the inner core 810 which may be non-tangential with the peripheral surface 808 or one or more sides thereof. As shown in FIG. 8B, the air and debris continue to travel linearly until they contact the peripheral surface 808. The peripheral surface 808 imposes a force on the air and debris (which may be referred to as a reactionary force or ricochet force) which cause the air and debris to change direction of travel. Contact with the peripheral surface 808 and resulting force imposed by the peripheral surface 808 on the air and debris causes the air and debris to separate from each other (e.g., scatter) as shown in FIG. 8C. Thus, the reactionary force from the peripheral surface 808 disentrains the air and debris.

As shown in FIG. 8D, a portion of the air travelling linearly adjacent to the inner core 810 can be pulled radially inward due to the Coanda effect from the inner core 810. For example, a portion of the air can follow the curved surfaces of the inner core 810. Thus, the Coanda effect from the inner core 810 can separate the air away from the debris as the debris continues to travel linearly past the inner core 810.

As shown in FIGS. 8D-8F, portions of the air travelling at a distance from the inner core 810 (e.g., adjacent to the peripheral surface 808) may not be affected by the Coanda effect imposed by the inner core 810 and thus may continue to travel linearly (except when bouncing off the peripheral surface 808). Thus, portions of the air may travel (e.g., linearly) adjacent to the peripheral surface 808 while other portions of travelling adjacent to the inner core 810 may be pulled radially inward by the Coanda effect. The debris continues to travel in linear increments around the Coanda separator 801 without following (adhering to) the peripheral surface 808 and/or without having a curved path of travel. For example, the debris may ricochet away from the peripheral surface 808. The debris and air can change direction as they ricochet off the peripheral surface 808. As shown in FIG. 8G, the debris exits through collector opening 822.

FIG. 9A is a cross-sectional view of Coanda separator 700 shown at the cross section of FIG. 9B. This example depiction of Coanda separator 700 shows chamber wall 738. Chamber wall 738 can be removably secured to housing 736 and can cover chamber 728. Removing chamber wall 738 can provide access to chamber 728 such as to remove debris from debris collecting region 714. Passageway 704 conducts dirty air to inlet 702 where inlet 702 introduces the dirty air into chamber 728. Dirty air circulates around the inner core 710 within the air separating region 706 of the chamber 728. Air can be separated from the debris around the inner core 710 as the Coanda effect induces the air to pass through core openings 726 where the air can then exit through outlet 720 as clean air. Debris circulates around chamber 728 where it can ricochet off peripheral surface 708. Chamber wall 738 and/or gravity induce debris to move toward collector opening 722. Debris can pass through collector opening 722 from the air separating region 706 to the debris collecting region 714. Baffle 712 separates air separating region 706 from debris collecting region 714 and inhibits debris from reentering air separating region 706 and/or interacting with inner core 710 after it has entered the debris collecting region 714.

FIG. 9C is a computational fluid mechanics diagram illustrating a fluid flow path through Coanda separator 700 at the cross section shown in FIG. 9B. Dirty air flows through passageway 704 and inlet 702 at a relatively high velocity due in part to the small cross sectional area of passageway 704 and/or inlet 702. Inlet 702 introduces dirty air into chamber 728 at a relatively high velocity where the dirty air velocity decreases due in part to the larger volume of the chamber 728. As discussed, dirty air can circulate throughout air separating region 706 where the dirty air can ricochet off peripheral surface 708. Air travelling adjacent to inner core 710 can separate from debris where the air can then exit through outlet 720 as clean air. Debris can travel away from inlet 702 toward chamber wall 738. Debris can ricochet off peripheral surface 708 until it passes through collector opening 722 and/or gravity can pull debris toward collector opening 722. In some implementations, a vortex may form within debris collecting region 714. The vortex can pull debris toward the vortex to induce the debris to enter debris collecting region 714. The baffle 712 may induce the vortex to form. The baffle 712 can separate the vortex from air separating region 706 and from inner core 710.

FIG. 9D is a computational fluid mechanics diagram illustrating a fluid flow path through Coanda separator 700 at the cross section shown in FIG. 9E. Inlet 702 introduces dirty air into chamber 728 at relatively high velocities tangential to inner core 710. Dirty air travels linearly through chamber 728 until the dirty air contacts peripheral surface 708 where it ricochets off peripheral surface 708 and continues to circulate (e.g., in linear increments) around inner core 710. As shown in FIGS. 9D and 9G, dirty air travels faster near peripheral surface 708 than near the inner core 710. Inlet housing surface 716 is connected to inner core 710 and peripheral surface 708 and inhibits dirty air from rotating completely around inner core 710 at this cross section. Thus, at this cross section where inlet 702 introduces dirty air into chamber 728, the dirty air does not circulate completely around inner core 710 to rejoin dirty air being introduced from inlet 702. Rather, as shown at this cross section, inlet housing surface 716 creates a backflow of dirty air.

FIG. 9G is a computational fluid mechanics diagram illustrating a fluid flow path through Coanda separator 700 at the cross section shown in FIG. 9I. FIG. 9H is an exploded view of a portion of air separating region 706 and inner core 710 with curved surfaces 724A-724C and core openings 726A-726C. As shown in FIG. 9H, air travelling adjacent to curved surfaces 724A-724C can follow the surface of the curved surfaces 724A-724C due to the Coanda effect. The curved surfaces 724A-724C can thus direct the air to pass through core openings 726A-726C into the inner core 710 and out of the air separating region 706.

As shown in FIG. 9G, dirty air travels faster near peripheral surface 708 than near the inner core inner core 710 thus creating a pressure gradient that corresponds to radial distance (e.g., faster velocities/lower pressure at greater radial distances from center), which inhibits a cyclone from forming around inner core 710. Moreover, air travelling adjacent to inner core 710 can exit the air separating region 706 through the core openings 726 thus inhibiting air from circulating around inner core 710 in the immediate vicinity of inner core 710 which can further inhibit air from accumulating and travelling at high velocities immediately adjacent to inner core 710 thus further inhibiting a cyclone from forming around inner core 710.

As shown in FIG. 9G and/or FIG. 9F, debris circulating throughout air separating region 706 can interact with peripheral surface 708. For example, debris can travel linearly throughout air separating region 706 until it contacts peripheral surface 708. Reactionary force from peripheral surface 708 can cause debris to change direction of travel (e.g., away from peripheral surface 708 toward inner core 710).

FIG. 9J is a computational fluid mechanics diagram illustrating a fluid flow path through Coanda separator 700 at the cross section shown in FIG. 9K. As shown, air travels faster near peripheral surface 708 than at the center of chamber 728 thus creating a pressure gradient that is inversely related to radial distance (e.g., faster velocities/lower pressure at greater radial distances from center), which inhibits a cyclone from forming. Baffle 712 inhibits debris collected in debris collecting region 714 from leaving debris collecting region 714.

FIG. 9L is a computational fluid mechanics diagram illustrating a fluid flow path through Coanda separator 700 at the cross section shown in FIG. 9M. At this cross section, air circulating in chamber 728 can enter the debris collecting region 714 through collector opening 722. Air within debris collecting region 714 may travel at slower velocities than throughout other portions of chamber 728.

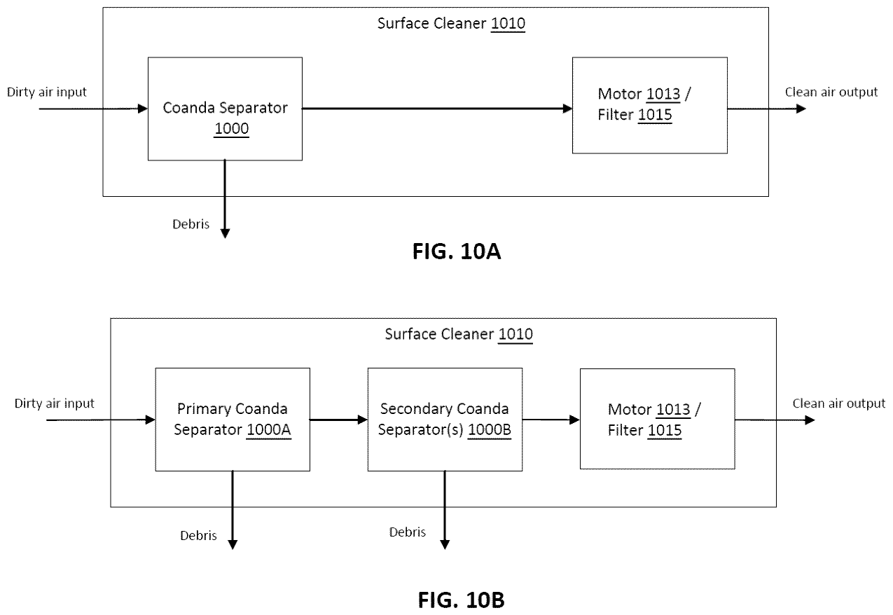

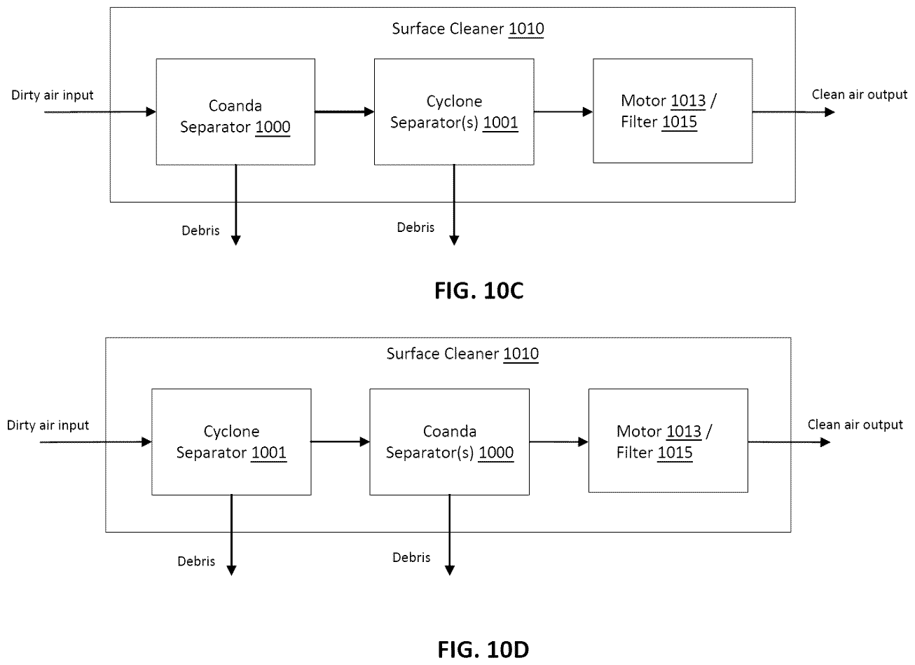

FIGS. 10A-10D are schematic block diagrams illustrating a surface cleaner 1010 according to various example implementations. The structural and/or operational features of surface cleaner 1010 shown and/or described in FIGS. 10A-10D can be rearranged and/or combined across the various example implementations. Surface cleaner 1010 can include any of the structural and/or operational features of example surface cleaners 210A-210D shown and/or described in FIGS. 2A-2D. For example, surface cleaner 1010 can be corded or cordless. As another example, Coanda separator 1000 can be implemented on a body, handle, and/or adjacent to a handle of surface cleaner 1010. As another example, Coanda separator 1000 can be implemented in separate device and/or housing from the surface cleaner 1010, or components thereof, such as an auto-evacuation dock to which surface cleaner 1010 connects. Surface cleaner 1010 can operate to remove debris from air at a variety of separation efficiencies. In some implementations, surface cleaner 1010 can remove debris from airflow with a separation efficiency between 70% and 100%, between 80% and 100%, between 90% and 100%, between 85% and 95%, between 90% and 95%, or between 95% and 100%. Surface cleaner 1010 may be a vacuum cleaner.

As shown in FIG. 10A, surface cleaner 1010 can include a Coanda separator 1000 which may have any of the structural and/or operational features of any of the example Coanda separators shown and/or described herein. The Coanda separator 1000 can receive dirty air. The motor 1013 can generate an airflow to provide the dirty to the Coanda separator 1000. Coanda separator 1000 utilizes Coanda effect to separate air from particulate matter in the airflow. Clean air exiting Coanda separator 1000 can pass through filter 1015 which can further disentrain particulate matter from the air. In some implementations, the filter 1015 may be placed in a fluid flow path between the Coanda separator 1000 and the motor 1013 and can protect the motor 1013 from particulate matter. In some implementations, the filter 1015 may be placed downstream from the motor 1013. In some implementations, the surface cleaner 1010 can include more than one filter which may be placed downstream and/or upstream from the motor 1013. Clean air substantially free of particulate matter can leave the surface cleaner 1010 as clean air output after having passed through filter 1015.

FIG. 10B shows surface cleaner 1010 with a primary Coanda separator 1000A and one or more secondary Coanda separators 1000B. Primary Coanda separator 1000A can separate air from particulate matter having a relatively large volume and/or mass. Air entrained with particulate matter having relatively small volume and/or mass can then pass from primary Coanda separator 1000A to secondary Coanda separator(s) 1000B which can separate air from the smaller particulate matter. Advantageously, the primary Coanda separator 1000A and one or more secondary Coanda separators 1000B can separate air from non-homogeneous particular matter (e.g., having varying volumes and/or masses) which can effectuate a higher degree of separation. In the example shown, primary Coanda separator 1000A and secondary Coanda separator(s) 1000B are fluidly connected in series such that air passes through primary Coanda separator 1000A before passing through secondary Coanda separator(s) 1000B. In some implementations, primary Coanda separator 1000A and secondary Coanda separator(s) 1000B are fluidly connected in parallel. In implementations with a plurality of secondary Coanda separators 1000B, the secondary Coanda separators 1000B can be fluidly connected with each other in series and/or parallel. A surface cleaner with a plurality of separators (whether Coanda separators or cyclone separators), may be referred to as a multi-stage surface cleaner.

FIG. 10C shows surface cleaner 1010 with a Coanda separator 1000 and one or more cyclone separators 1001. The Coanda separator 1000 can be a primary Coanda separator 1000 that separates air from relatively large particulate matter. The one or more cyclone separators 1001 can be secondary cyclone separators that separate relatively small particulate matter from air. The Coanda separator 1000 can be fluidly connected with the cyclone separator(s) 1001 in series and/or parallel. In implementations with a plurality of cyclone separators 1001, the cyclone separators 1001 can be fluidly connected with each other in series and/or parallel.

FIG. 10D shows surface cleaner 1010 with a cyclone separator 1001 and one or more Coanda separators 1000. The cyclone separator 1001 can be a primary cyclone separator 1001 that separates relatively large particulate matter from air. The one or more Coanda separators 1000 can be secondary Coanda separators that separate air from relatively small particulate matter. The cyclone separator 1001 can be fluidly connected with the Coanda separator(s) 1000 in series and/or parallel. In implementations with a plurality of Coanda separators 1000, the Coanda separators 1000 can be fluidly connected with each other in series and/or parallel. In some implementations, one or more cyclone separators 1001 and one/or more Coanda separators 1000 can be positioned downstream from a Coanda separator 1000 and/or cyclone separator 1001.

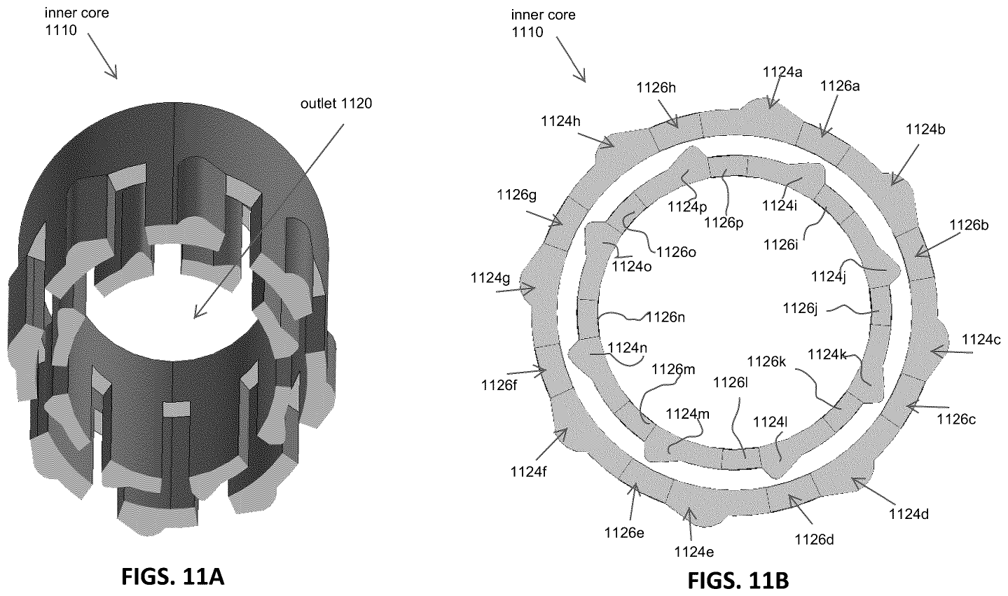

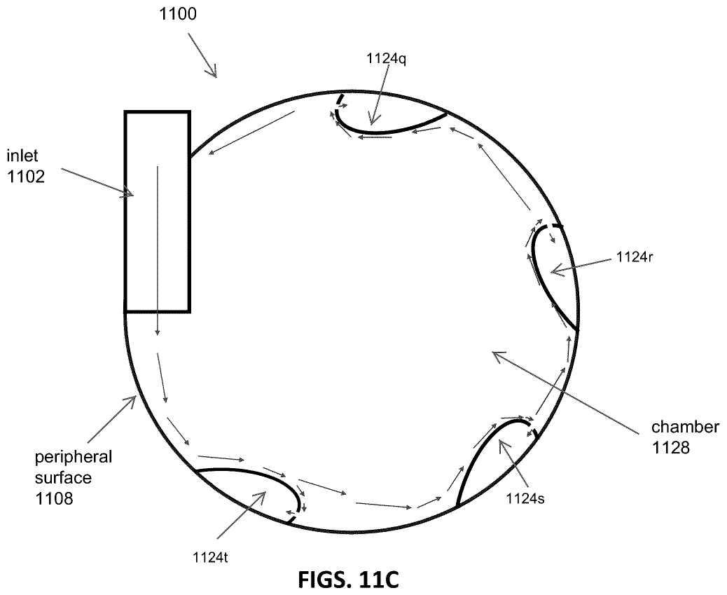

FIGS. 11A-11B illustrate cross sectional views of an example inner core 1110 which can be implemented in any of the example Coanda separators shown and/or described herein. In this example, inner core 1110 includes sixteen curved surfaces 1124a-1124p and sixteen core openings 1126a-1126p. Curved surfaces 1124i-1124p are positioned radially inward from curved surfaces 1124a-1124h. Curved surfaces 1124i-1124p are positioned adjacent to core openings 1126a-1126h such that air passing through core openings 1126a-1126h interacts with curved surfaces 1124i-1124p. Air that exits through outlet 1120 will have passed through two core openings and may have travelled along one or more curved surfaces. Curved surfaces 1124i-1124p are oriented in an opposite direction from curved surfaces 1124a-1124h such that the curved surfaces taper in different directions. In some implementations, all the curved surfaces 1124a-1124p may be oriented in a same direction. Advantageously, curved surfaces 724i-724p positioned radially inward from core openings 726a-726h can further facilitate separating air from debris with Coanda effect.

FIG. 11C illustrates an example chamber 1128 of a Coanda separator 1100. In this example, curved surfaces 1124q-1124t are positioned on peripheral surface 1108. In this example, peripheral surface 1108 has a circular cross-sectional profile. In some implementations, peripheral surface 1108 may have a polygonal cross-sectional profile. Air circulating throughout chamber 1128 can be pulled toward peripheral surface 1108 by Coanda effect imposed on the air by the curved surfaces 1124q-1124t. Peripheral surface 1108 shown and/or described in FIG. 11C can be implemented with any of the Coanda separators and/or inner cores shown and/or described herein.

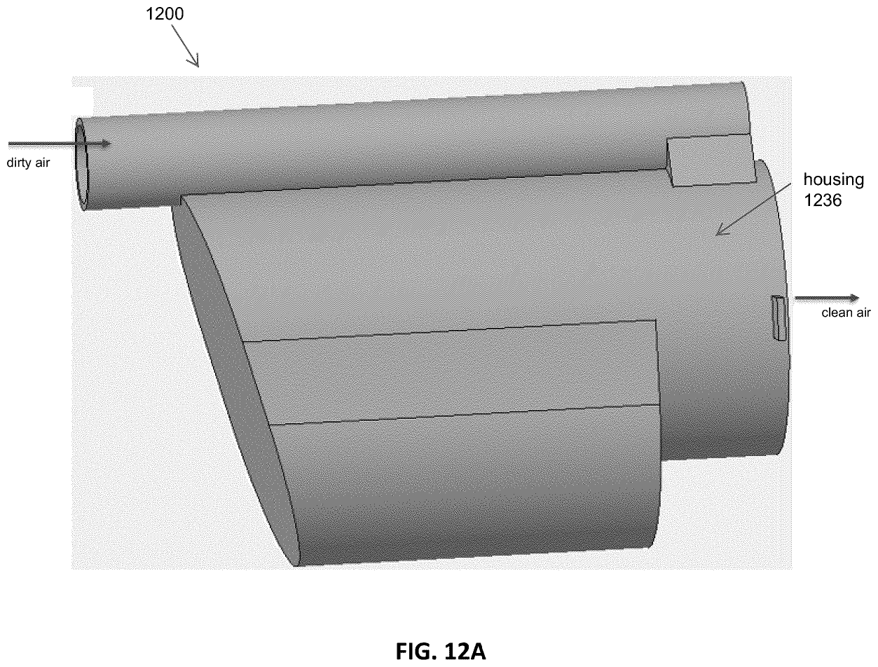

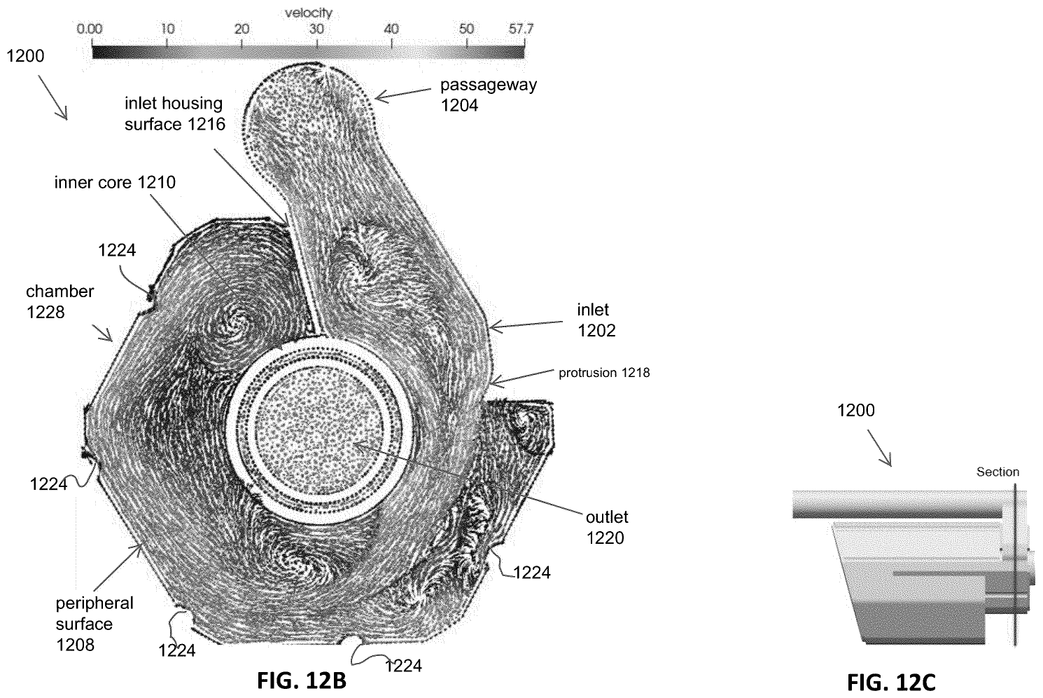

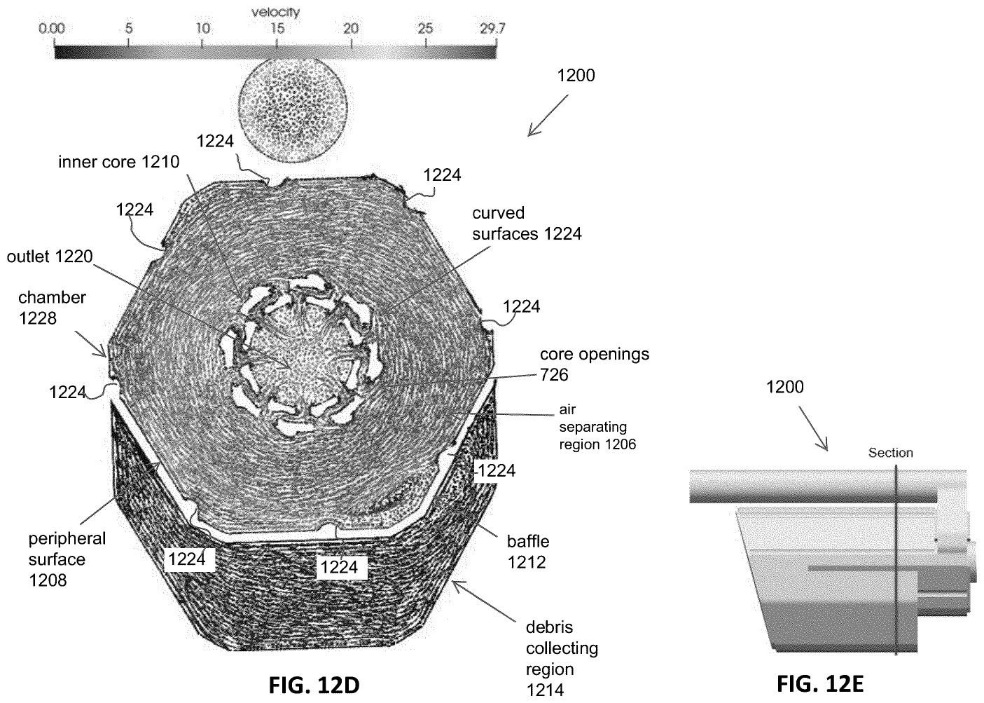

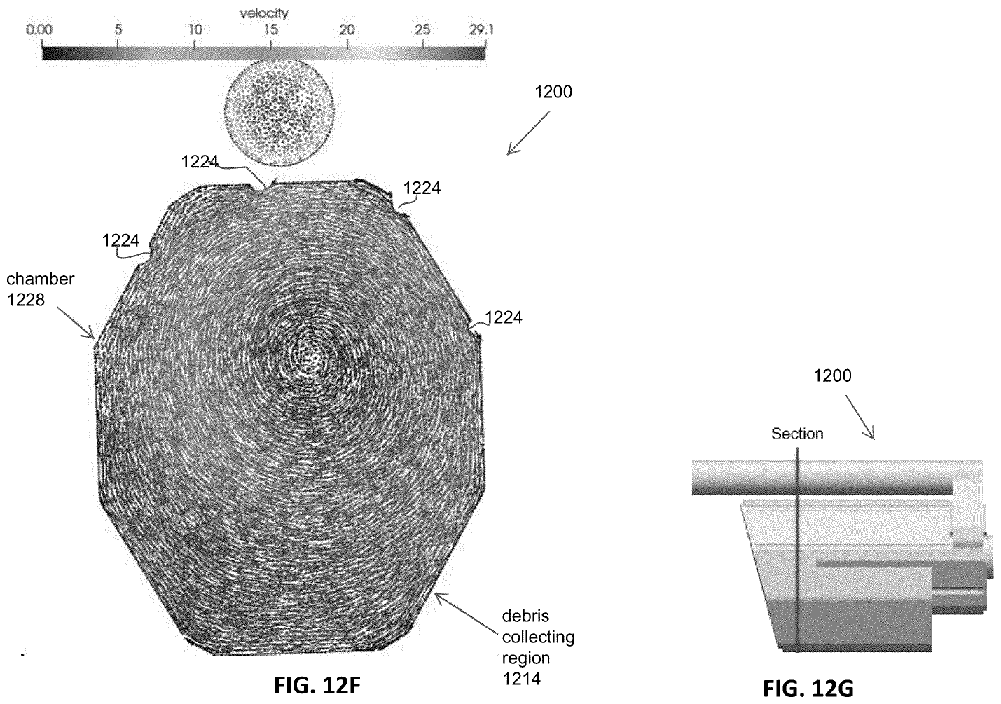

FIG. 12A is a side view of an example Coanda separator 1200. FIGS. 12B, 12D, and 12F are computational fluid mechanics diagram illustrating fluid flow paths through Coanda separator 1200 at the cross sections shown in FIGS. 12C, 12E, and 12G, respectively. In this example, peripheral surface 1208 of chamber 1228 has a polygonal cross-sectional profile with one or more curved surfaces 1224 distributed throughout chamber 1228 on the peripheral surface 1208. Inner core 1210 may have similar structural and/or operational features as inner core 1110 shown and/or described herein. For example, inner core 1210 has concentrically arranged curved surfaces 1224 with some of the curved surfaces of the inner core 1210 being positioned closer to peripheral surface 1208 than other curved surfaces on the inner core 1210 which are positioned radially inward.

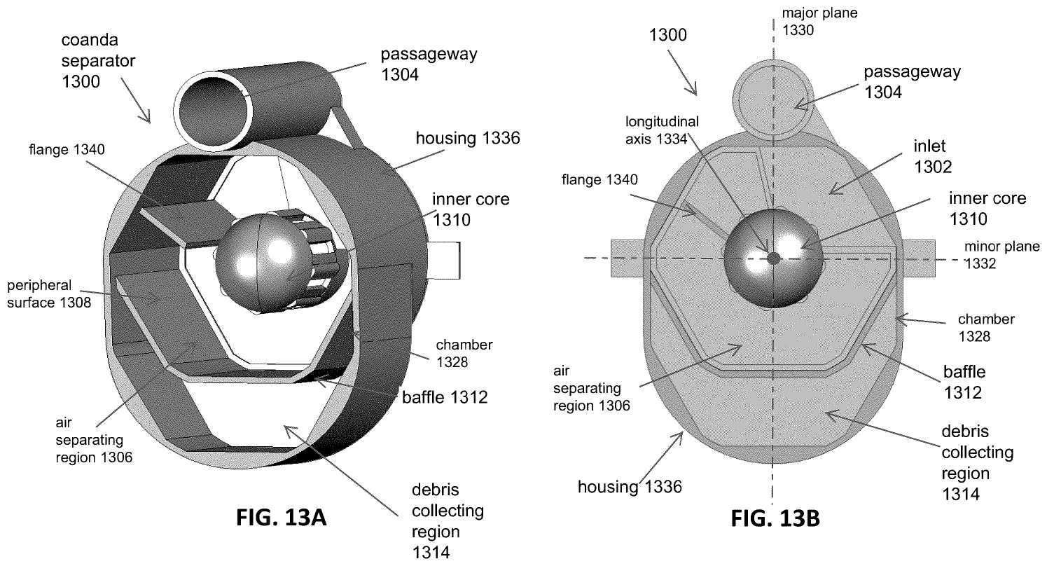

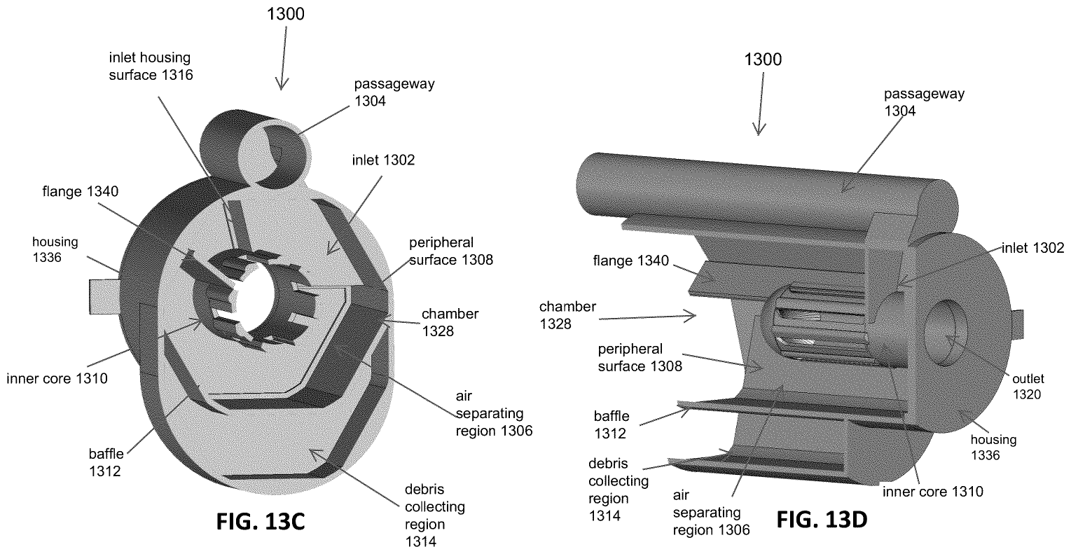

FIGS. 13A-13D illustrate an example Coanda separator 1300. In this example, Coanda separator 1300 includes flange 1340 positioned within air separating region 1306 of chamber 1328. The flange 1340 is connected to peripheral surface 1308 and inner core 1310 extends contiguously between inner core 1310 and peripheral surface 1308. Flange 1340 may be connected perpendicularly with peripheral surface 1308 and/or inner core 1310. Flange 1340 can be connected to at least one of the curved surfaces 1324, or immediately adjacent to at least one of the curved surfaces 1324 and can at least partially occlude at least one of the core openings 1326. Flange 1340 can disrupt airflow circulating throughout air separating region 1306. For example, flange 1340 can inhibit dirty air from flowing continuously around inner core 1310. Accordingly, dirty air may not flow in a circle (e.g., around inner core 1310) throughout air separating region 1306. In this example, flange 1340 extends throughout the length of the chamber 1328 and is longer than inner core 1310. In some implementations, flange 1340 may be the same length as inner core 1310 or may be shorter than inner core 1310 and extend only partially along a length of chamber 1328 and/or only partially along a length of air separating region 1306. In some implementations, a plurality of flanges 1340 may be positioned within chamber 1328. As shown in FIG. 13B, flange 1340 may be positioned across major plane 1330 from inlet 1302 (and on a same side as minor plane 1332). Accordingly, flange 1340 may be positioned at least 180 degrees around longitudinal axis 1334 from inlet 1302. Accordingly, dirty air may circulate a majority distance around inner core 1310 before reaching flange 1340 after exiting inlet 1302. In some implementations, flange 1340 may be positioned across minor plane 1332 from inlet 1302 and/or on a same side of major plane 1330 as inlet 1302.

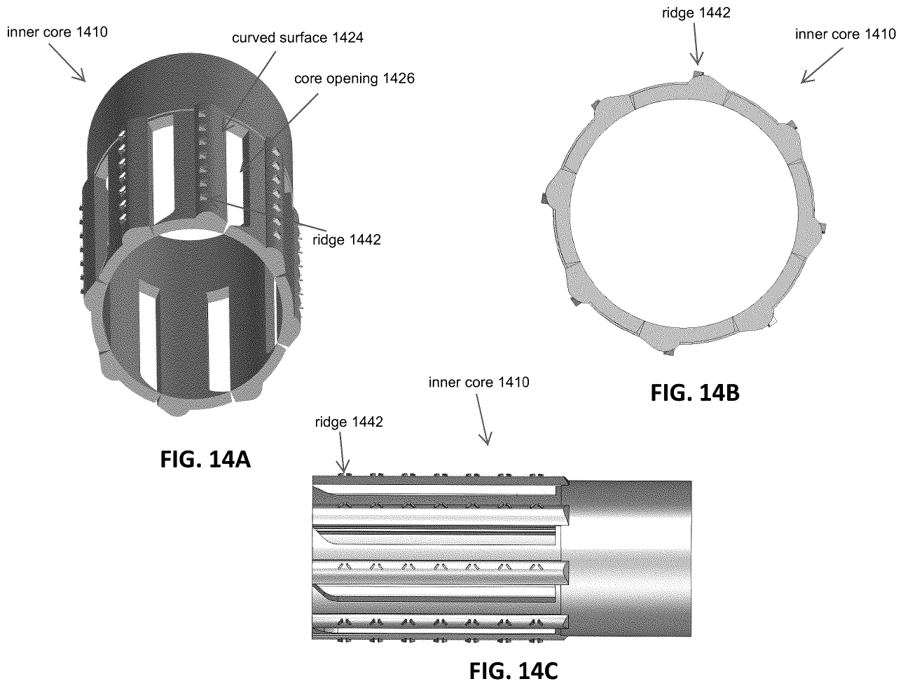

FIGS. 14A-14C illustrate an example inner core 1410 shown at cross sections near the end of inner core 1410. Inner core 1410 can be implemented with any of the example Coanda separators shown and/or described herein. For clarity, less than all of the curved surfaces 1424 and core openings 1426 shown in FIGS. 14A-14C are labeled. Inner core 1410 can include one or more ridges 1442. For clarity, less than all of the ridges 1442 shown in FIGS. 14A-14C are labeled. Ridges 1442 can be positioned on curved surfaces 1424 and can extend radially outward from the curved surfaces 1424. Ridges 1442 can be arranged in pairs with each ridge 1442 in a pair being a mirror image of the other in the pair. In this example, each curved surface 1424 includes seven pairs of ridges 1442. Ridges 1442 can be angled with respect to the direction of air flow over the curved surfaces and each pair of ridges 1442 can form a substantially triangular formation as shown in FIG. 14C. Ridges 1442 can direct airflow that travels over curved surfaces 1424. For example, ridges 1442 can funnel airflow into channels between ridges 1442 (e.g., between adjacent pairs of ridges).

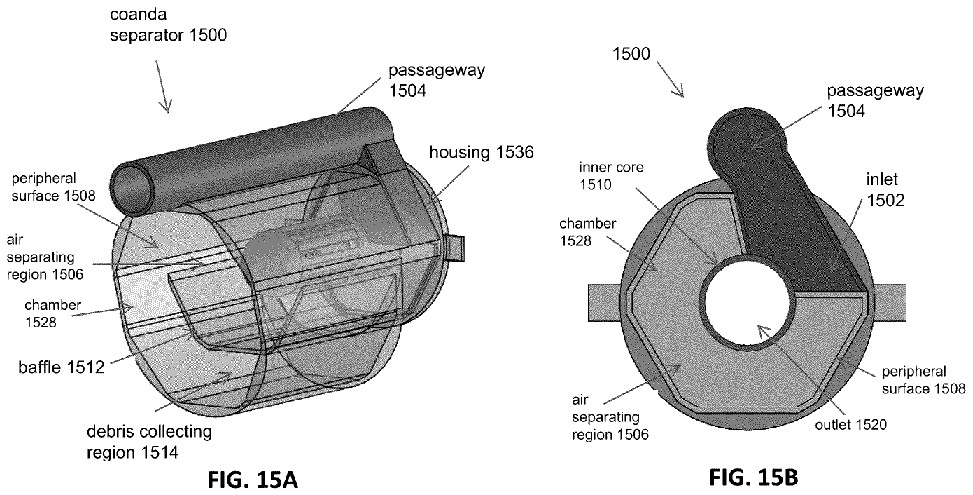

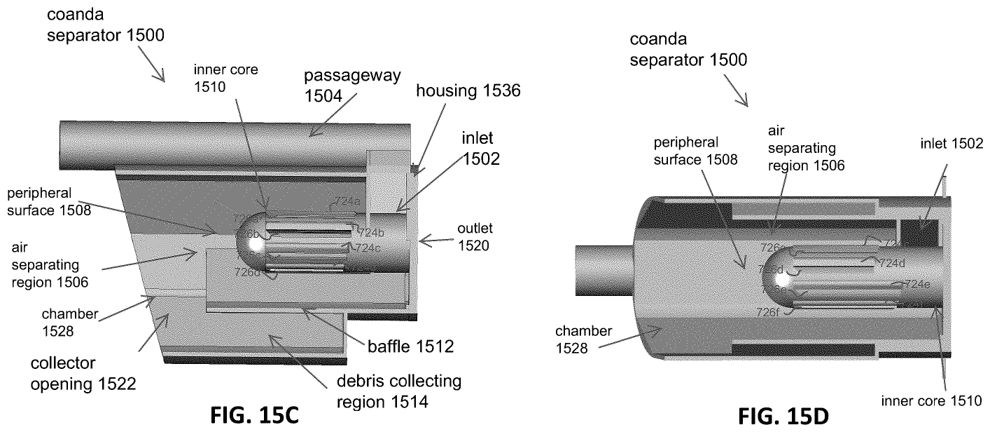

FIGS. 15A-15D illustrate an example Coanda separator 1500. In this example, inlet 1502 connect to chamber 1528 without a protrusion directing the airflow between the inlet 1502 and the chamber 1528. Accordingly, dirty air may travel from the inlet 1502 to the chamber 1528 substantially uninhibited and may travel in a direction toward peripheral surface 1508 immediately after exiting inlet 1502. For example, inlet 1502 may introduce dirty air into chamber toward peripheral surface 1508 such that at least a portion of dirty air exiting inlet 1502 is incident upon peripheral surface 1508 at an angle (e.g., non-tangential with peripheral surface 1508). Inlet 1502 may introduce dirty air into chamber 1528 tangentially with inner core 1510.

As shown in FIG. 15C, baffle 1512 has a uniform length and extends beyond inner core 1510. Collector opening 1522 has a variable width which may be between 0.5 inches and 2.0 inches, between 0.5 inches and 1.5 inches, or between 0.5 inches and 1.0 inch.

As shown in FIGS. 15C-15D, curved surfaces 724 may be different lengths than each other and core openings 726 may be different lengths than each other. The shortest curved surface 724d is adjacent to the longest curved surface 724e. The other curved surfaces 724 (other than 724d and 724e) may each be positioned between curved surfaces 724 that are longer and shorter than itself such that the curved surfaces 724 are arranged around the inner core 1510 in order of decreasing length (or increasing length if going the other way around the inner core 1510). The longest curved surface 724e may be positioned at the bottom of the inner core 1510 closest to the baffle 1512. Each of the core openings 726 may be a substantially similar length as the curved surface 724 to which it is immediately adjacent.

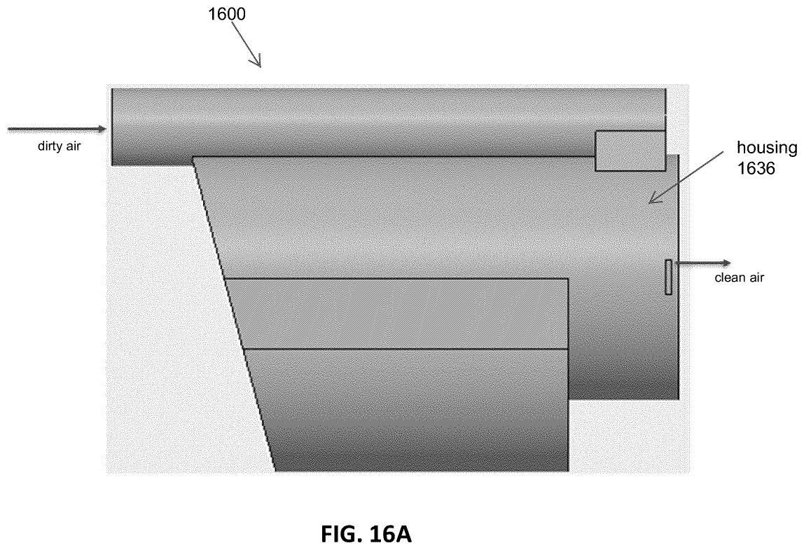

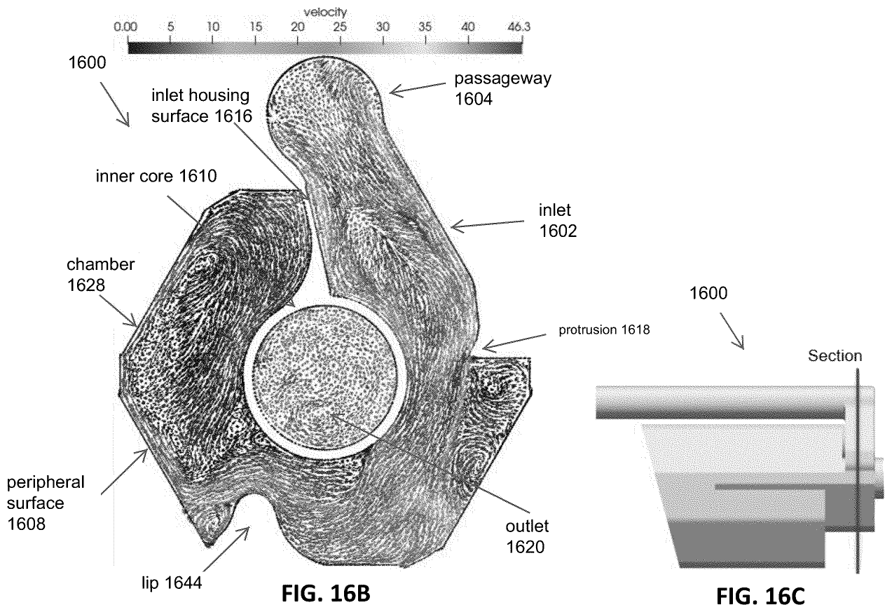

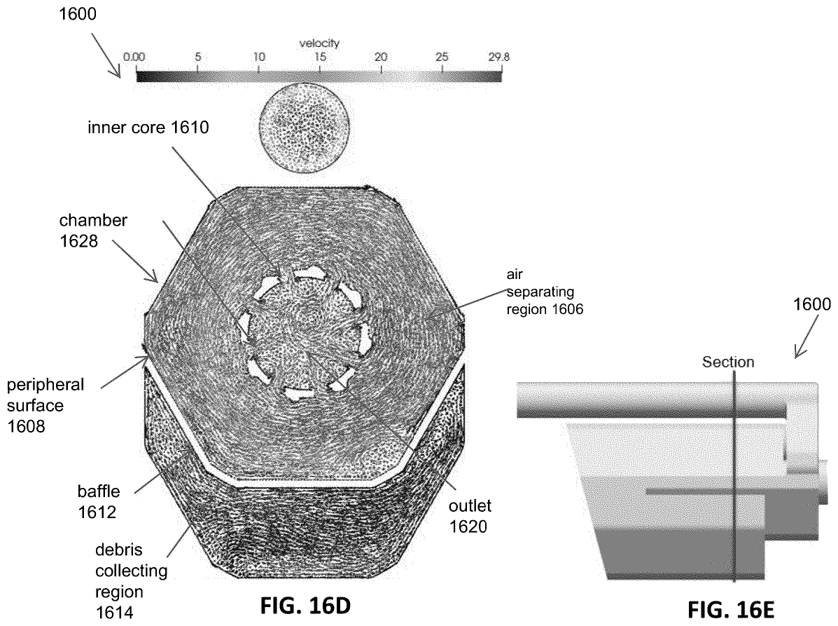

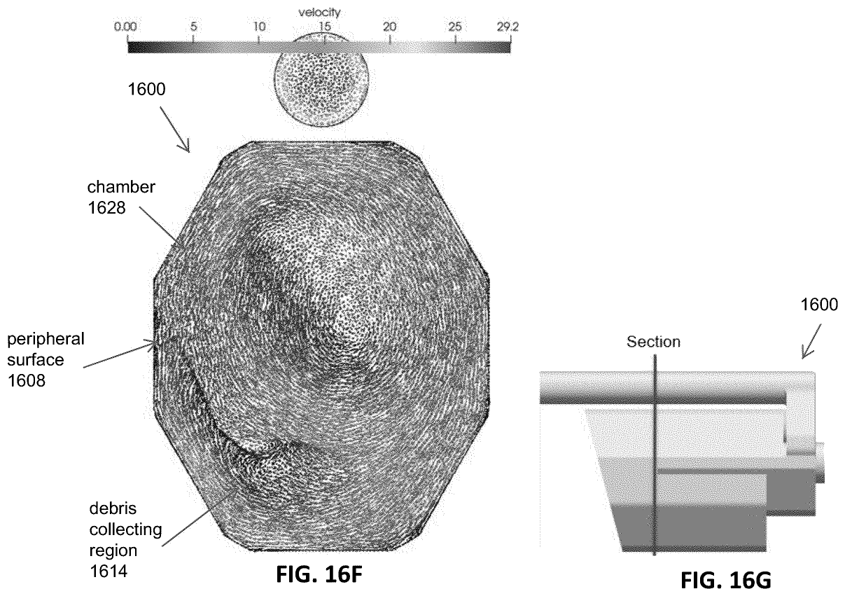

FIG. 16A is a side view of an example Coanda separator 1600. FIGS. 16B, 16D, and 16F are computational fluid mechanics diagram illustrating fluid flow paths through Coanda separator 1600 at the cross sections shown in FIGS. 16C, 16E, and 16G, respectively. In this example, Coanda separator 1600 includes lip 1644 as a curved portion of peripheral surface 1608. All portions of peripheral surface 1608 may be planar faces except lip 1644 which may be curved. The portion of lip 1644 closest to inner core 1610 may be rounded. Lip is positioned across the chamber 1628 from inlet housing surface 1616. Lip 1644 may be positioned at any region of peripheral surface 1608. Lip 1644 can disrupt airflow throughout chamber 1628 and direct the airflow away from the periphery of chamber 1628 toward inner core 1610. Accordingly, lip 1644 may inhibit air from travelling in a circle around inner core 1610. In some implementations, peripheral surface 1608 includes a plurality of lips 1644.

Lip 1644 is positioned at the same cross-sectional region of chamber 1628 as inlet 1602 such that lip 1644 may affect airflow of air entering chamber 1628 from inlet 1602. Lip may not extend longitudinally throughout the chamber 1828 beyond the inlet 1602 (e.g., to and/or throughout the air separating region 1606). Accordingly, lip 1644 may not affect airflow in the air separating region 1606.

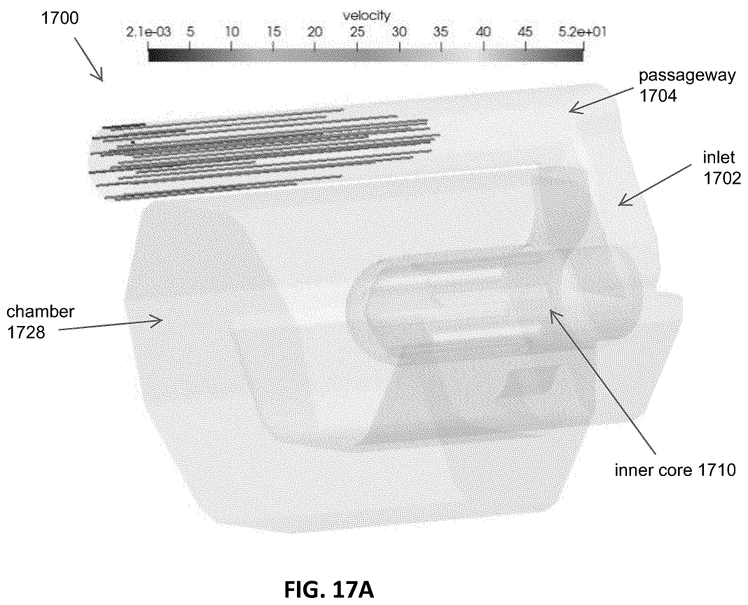

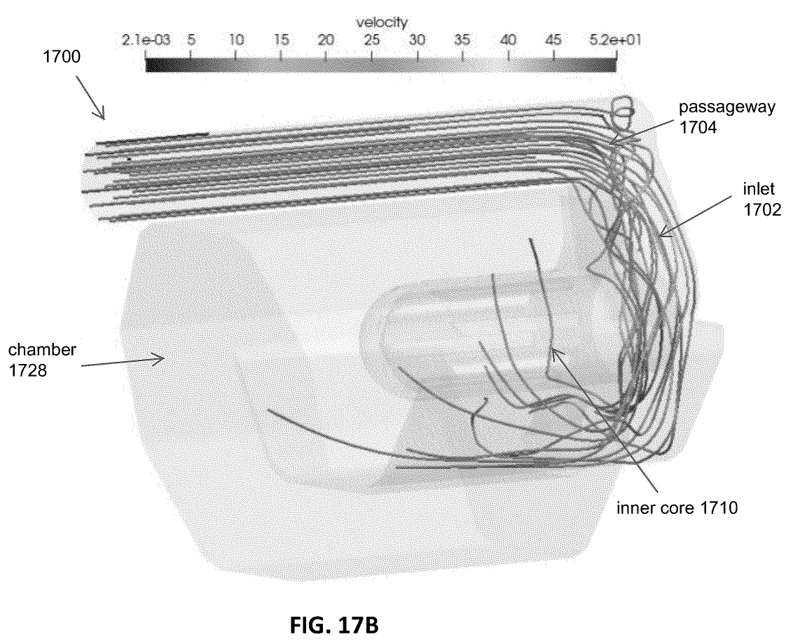

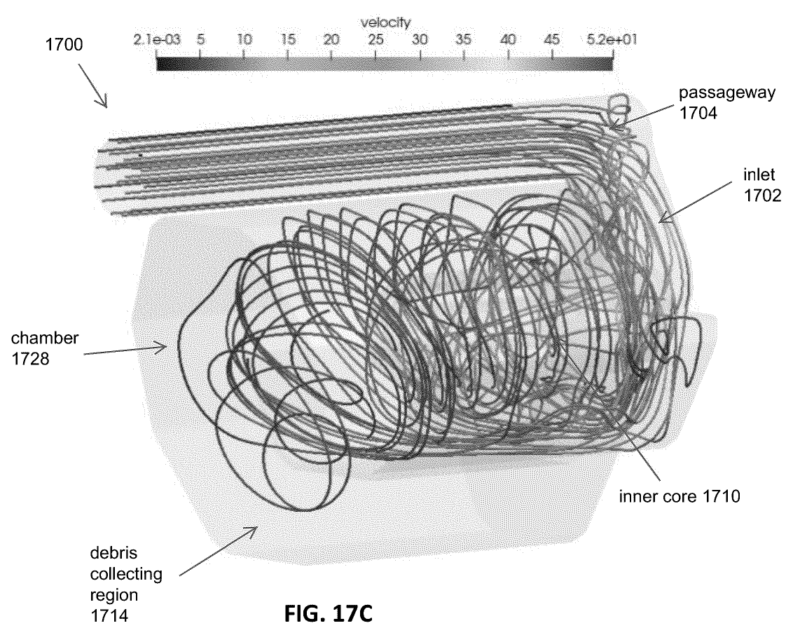

FIGS. 17A-17C are computational fluid mechanics diagram illustrating fluid flow paths through Coanda separator 1700. As shown, dirty air travels through passageway 1704 toward inlet 1702 which introduces the dirty air into chamber 1728. The dirty air travels throughout chamber 1728 adjacent to inner core 1710. The dirty air may travel in a non-circular path throughout chamber 1728 around inner core 1710. Air and/or debris can enter debris collecting region 1714. In some implementations, flowing air can conduct debris into debris collecting region 1714 independently of the force of gravity.

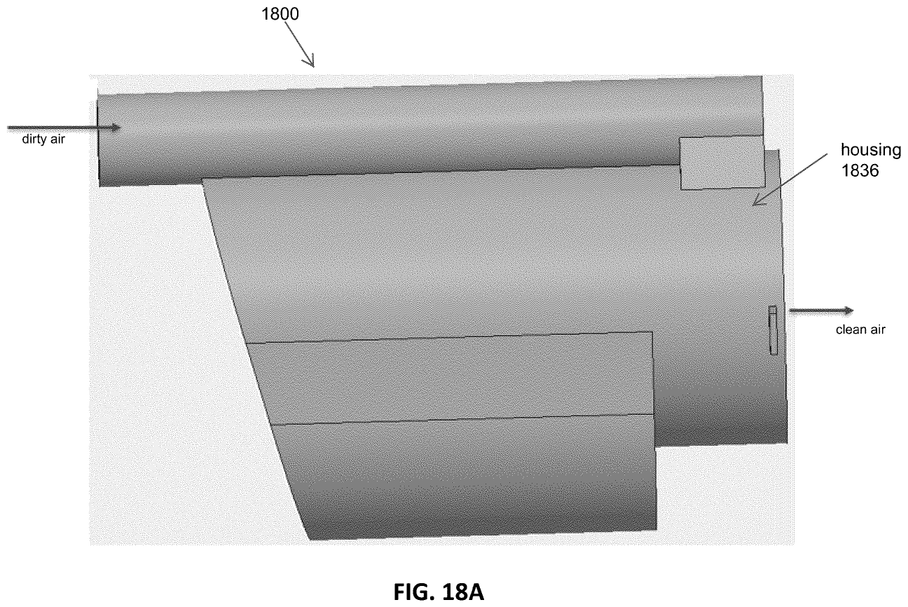

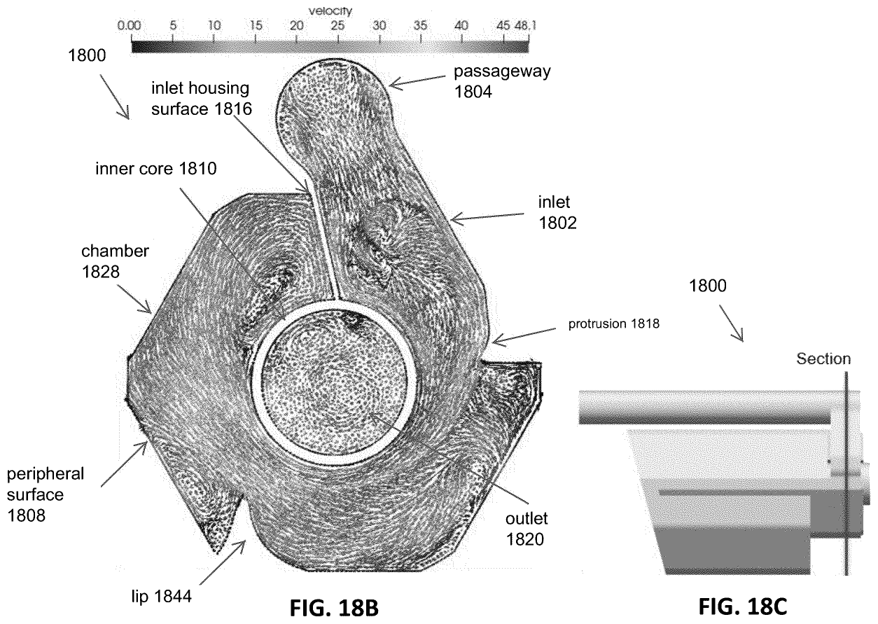

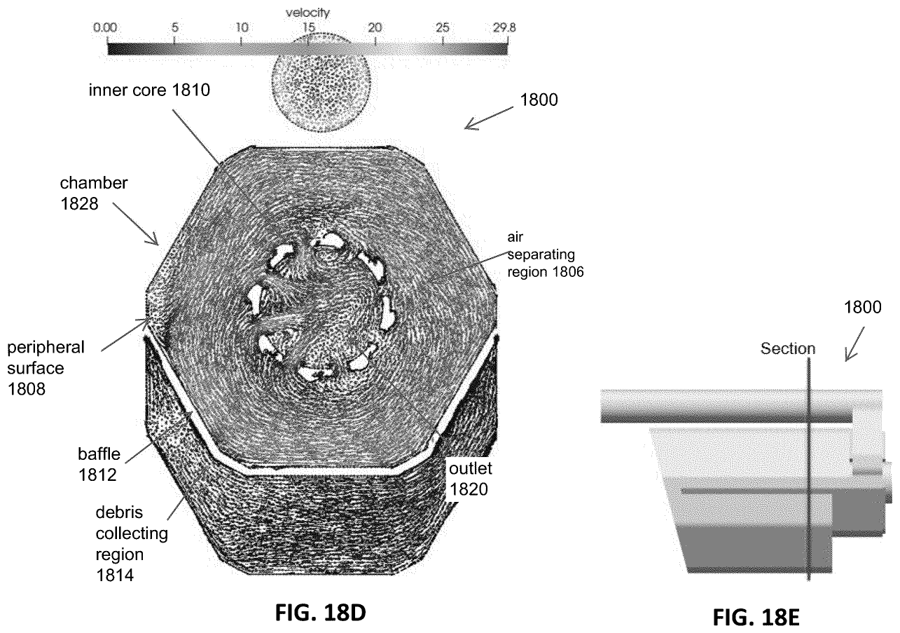

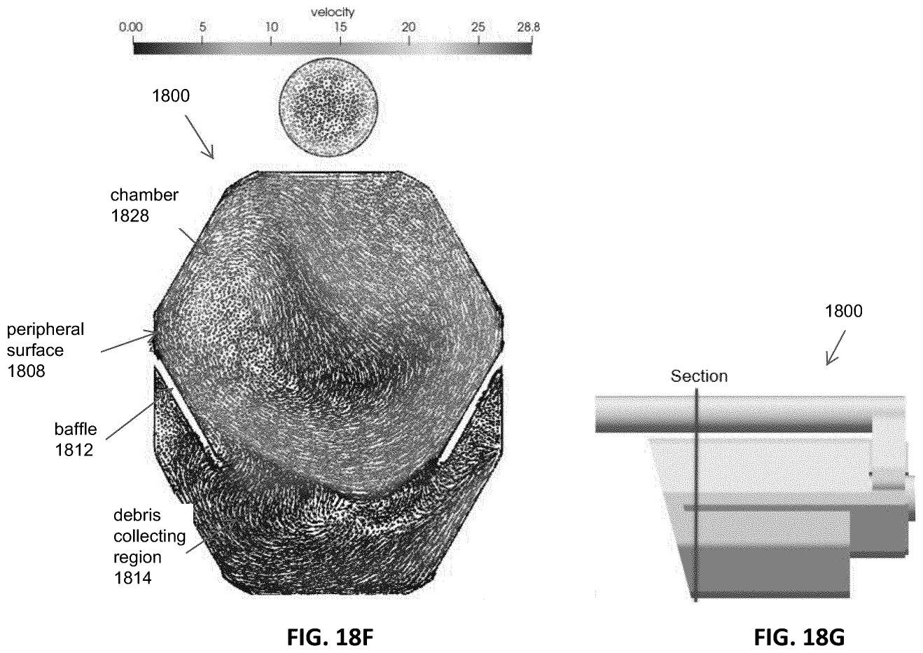

FIG. 18A is a side view of an example Coanda separator 1800. FIGS. 18B, 18D, and 18F are computational fluid mechanics diagram illustrating fluid flow paths through Coanda separator 1800 at the cross sections shown in FIGS. 18C, 18E, and 18G, respectively. In this example, Coanda separator 1800 includes lip 1844 as a curved and/or non-planar portion of peripheral surface 1808. All portions of peripheral surface 1808 may be planar faces except lip 1844 which may be curved. The portion of lip 1844 closest to inner core 1810 may be pointed (e.g., non-rounded). Lip is positioned across the chamber 1828 from inlet housing surface 1816. Lip 1844 may be positioned at any region of peripheral surface 1808. Lip 1844 can disrupt airflow throughout chamber 1828 and direct the airflow away from the periphery of chamber 1828 toward inner core 1810. Accordingly, lip 1844 may inhibit air from travelling in a circle around inner core 1810. In some implementations, peripheral surface 1808 includes a plurality of lips 1844.

Lip 1844 is positioned at the same cross-sectional region of chamber 1828 as inlet 1802 such that lip 1844 may affect airflow of air entering chamber 1828 from inlet 1802. Lip may not extend longitudinally throughout the chamber 1828 beyond the inlet 1602 (e.g., to and/or throughout the air separating region 1806). Accordingly, lip 1844 may not affect airflow in the air separating region 1806.

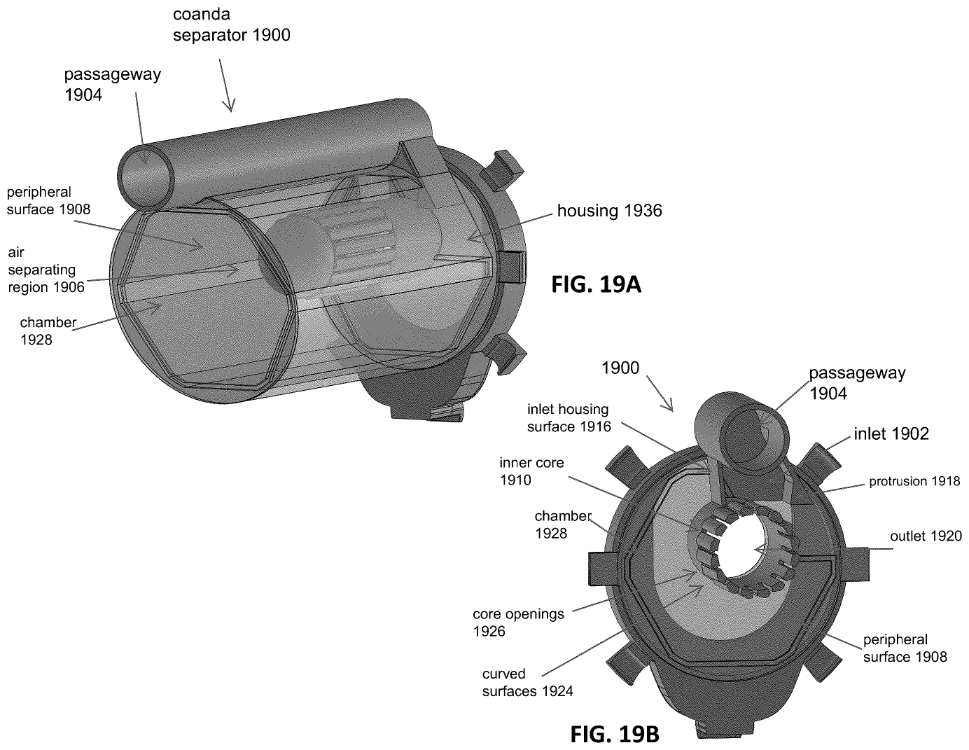

FIGS. 19A-19B illustrate an example Coanda separator 1900. In this example, Coanda separator 1900 does not include a baffle. Accordingly, chamber 1928 may not include a debris collecting region and/or a debris separating region may be part of air separating region 1906. In this example, Coanda separator 1900 includes sixteen curved surfaces 1924 and sixteen core openings 1926 distributed around inner core 1910. Inlet 1902 is flush, or substantially flush, with inner core 1910 such that inlet 1902 does not extend beyond inner core 1910.

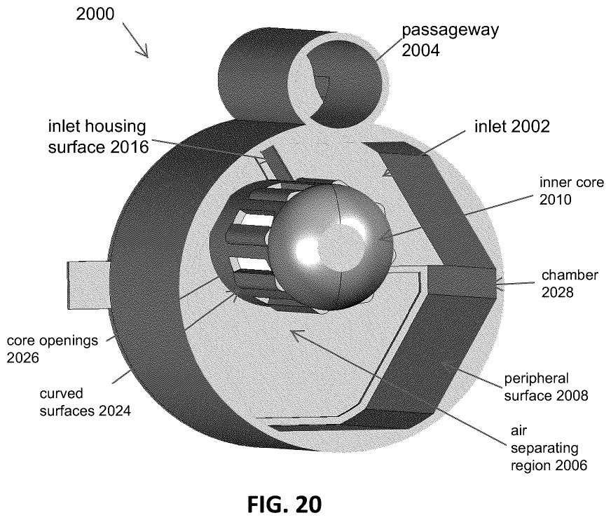

FIG. 20 illustrates an example Coanda separator 2000. In this example, Coanda separator 2000 does not include a baffle. Accordingly, chamber 2028 may not include a debris collecting region and/or a debris separating region may be part of air separating region 2006. In this example, Coanda separator 2000 includes eight curved surfaces 2024 and eight core openings 2026 distributed around inner core 1910.

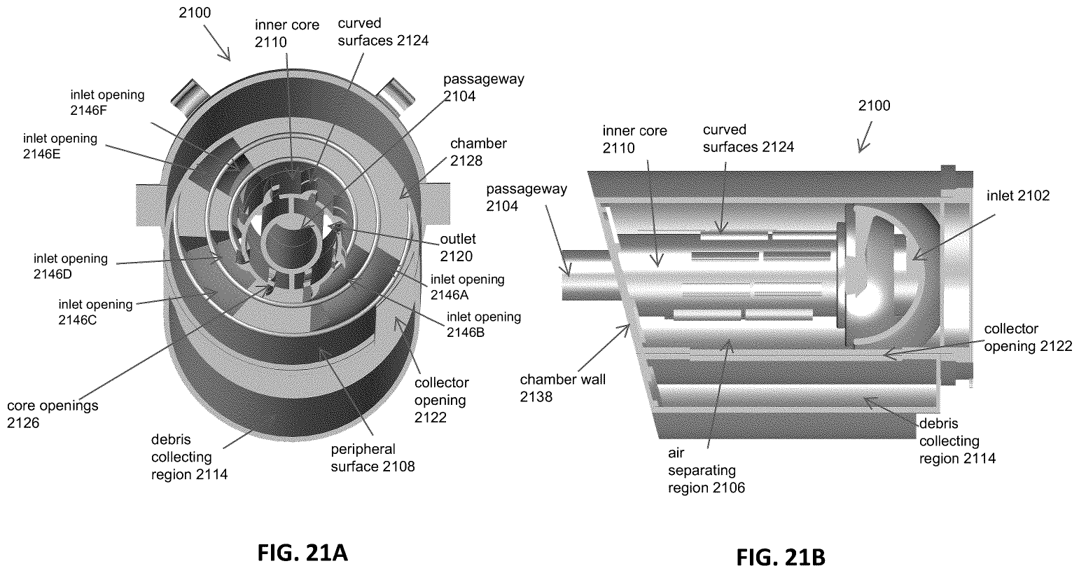

FIGS. 21A-21B illustrate an example Coanda separator 2100. In this example, passageway 2104 is positioned within inner core 2110 and conducts air through the inner core toward inlet 2102. Passageway 2104 is positioned adjacent to outlet 2120 such that air is conducted through inner core 2110 (exterior to passageway 2104) toward outlet 2120. Outlet 2120 comprises two portions separated from each other such that air travelling through outlet 2120 travels through either the left side or right side of the outlet 2120. The two portions of outlet 2120 inhibit air from rotating circularly within inner core 2110. In this example, Coanda separator 2100 comprises fourteen curved surfaces 2124 and fourteen core openings 2126. The curved surfaces 2124 are flush with the core openings 2126 such that the curved surfaces 2124 do not taper to the core openings 2126. Curved surfaces 2124 each curve to a point. As shown in FIG. 21B, curved surfaces 2124 are arranged in pairs on inner core 2110 such that each curved surface 2124 in a pair is positioned longitudinally adjacent to the other curved surface 2124 in the pair. Each pair of curved surfaces 2124 is longitudinally offset from adjacent pairs of curved surfaces 2124. Collector openings 2122 is positioned within chamber 2128 on a same side of inner core 2110 as inlet 2002. Collector opening 2122 extends longitudinally through chamber 2128. Inner core 2110 extends longitudinally through the entire length of chamber 2128 and abuts against chamber wall 2138.

Inlet 2102 can be connected with, and/or divided into, a plurality of inlet openings 2146A-2146F which open the inlet 2102 into the chamber 2148. The inlet openings 2146A-2146F are positioned at various positions circumferentially around the inner core 2110 and are also positioned at various positions radially away from inner core 2110. Accordingly, air may enter chamber 2148 via inlet openings 2146A-2146F at various positions around inner core 2110 and/or at various distances away from inner core 2110.

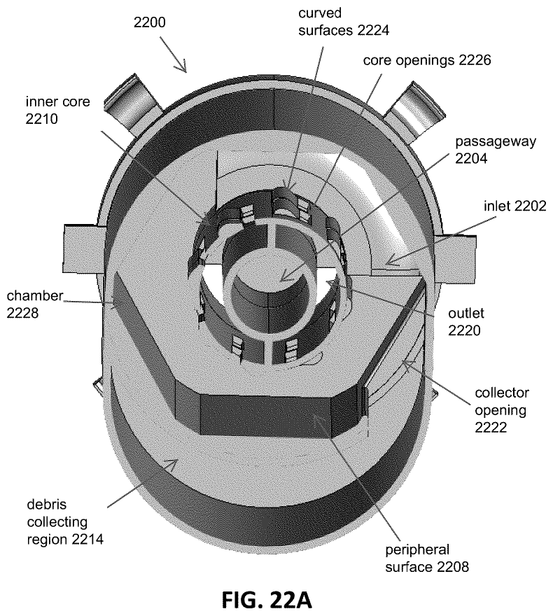

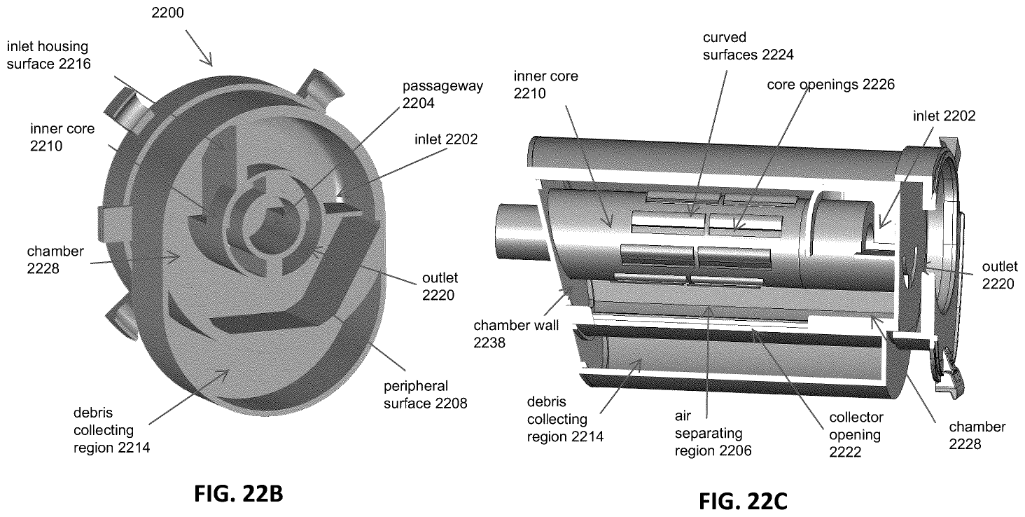

FIGS. 22A-22C illustrate an example Coanda separator 2200 with passageway 2204 extending through inner core 2210.

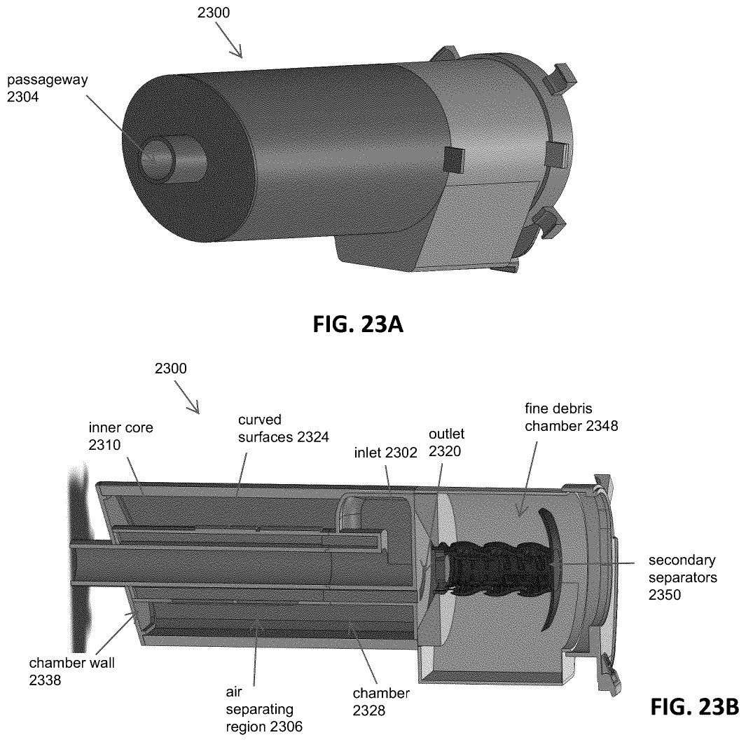

FIGS. 23A-23B illustrate an example Coanda separator 2200 with fine debris chamber 2348 positioned downstream from outlet 2320. Air having been separated from large debris within chamber 2328 can pass through outlet 2320 to fine debris chamber 2348. Fine debris chamber 2348 includes one or more secondary separators 2350 which can be Coanda separators (e.g., one or more curved surfaces separating air from debris with Coanda effect) and/or cyclone separators. The secondary separators 2350 can separate air from debris that is smaller (e.g., smaller mass and/or volume) than in chamber 2328.

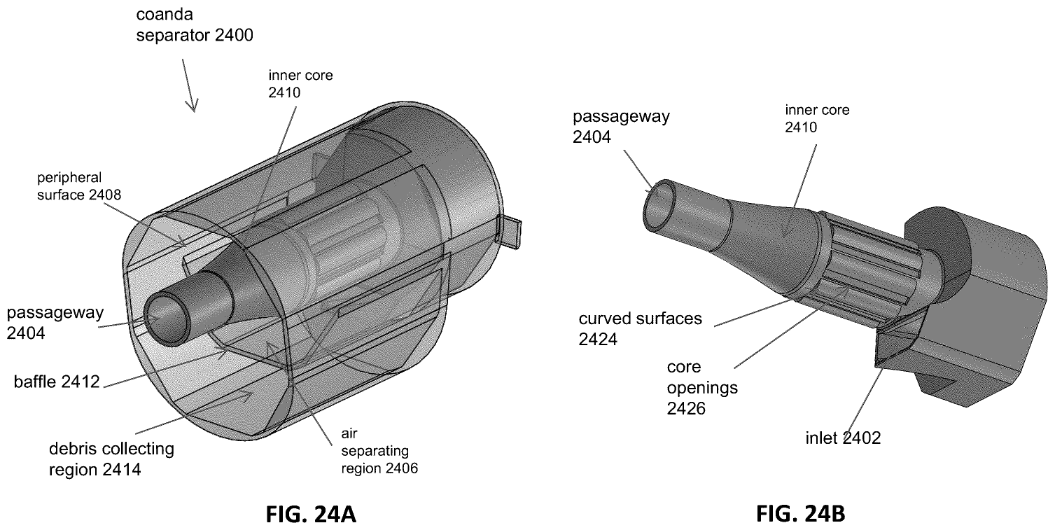

FIGS. 24A-24B illustrate an example Coanda separator 2400. Inlet 2402 is positioned between inner core 2410 and baffle 2412. Inlet 2402 may extend from the inner core 2410 to the baffle 2412. At least a portion of inner core 2410 may be cylindrical and at least a portion of inner core 2410 may be frustoconical. Curved surfaces 2424 and core openings 2426 may occupy a cylindrical portion of inner core 2410.

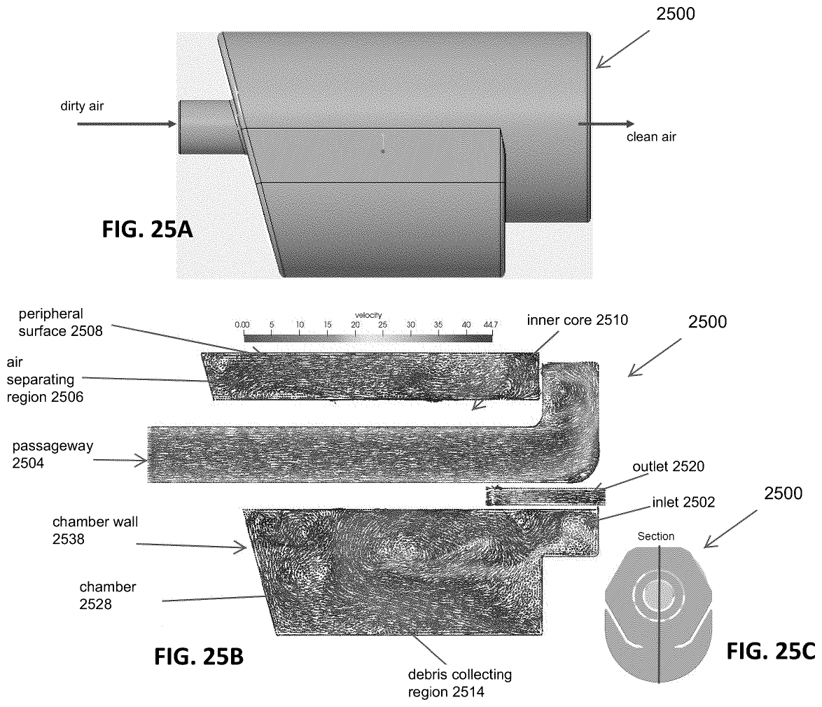

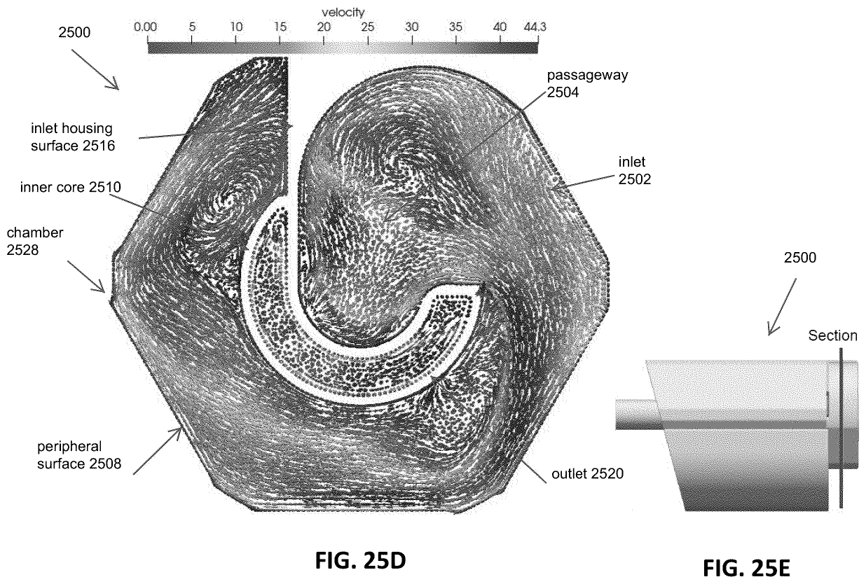

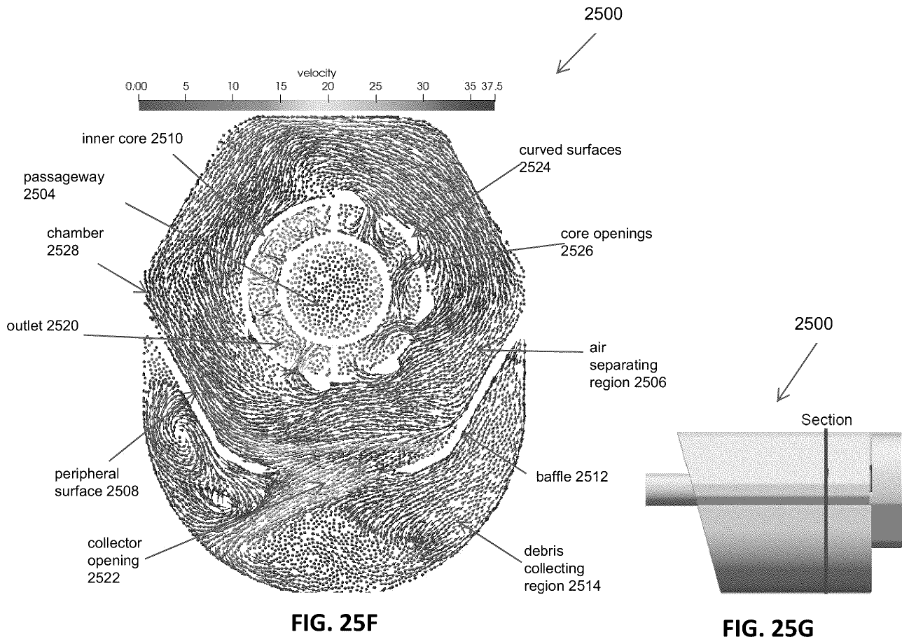

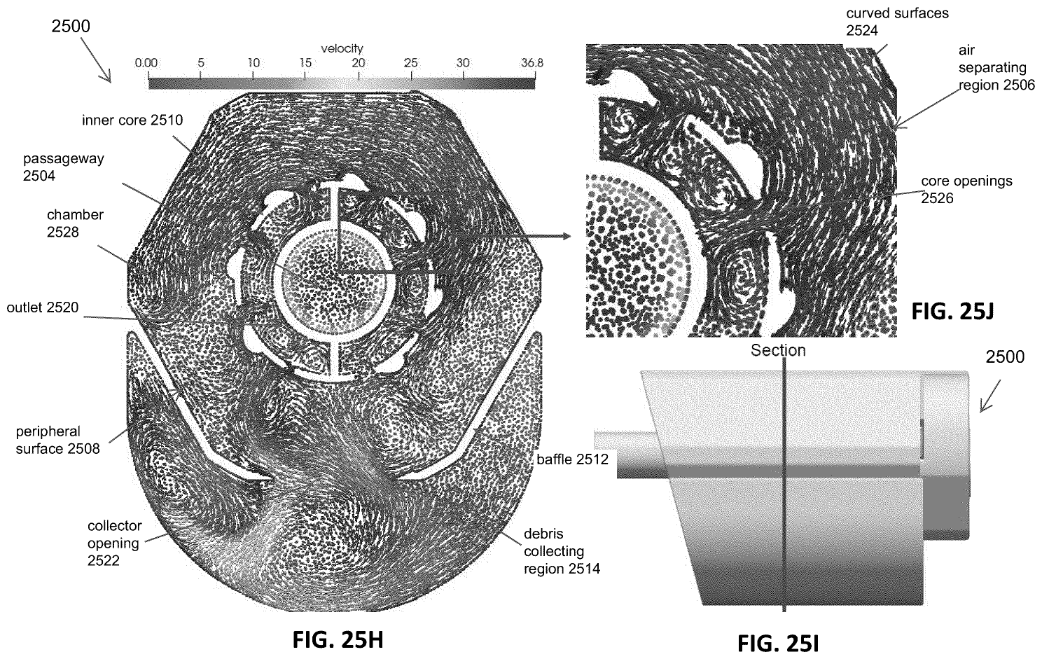

FIG. 25A is a side view of an example Coanda separator 2500. FIGS. 25B, 25D, 25F, and 25H, are computational fluid mechanics diagram illustrating fluid flow paths through Coanda separator 2500 at the cross sections shown in FIGS. 25C, 25E, 25G, and 25I respectively. FIG. 25J is an exploded view of inner core 2510 with curved surfaces 2524 and core openings 2526. At least a portion of passageway 2504 and/or inlet 2502 is curved, as show in FIG. 25D. Passageway 2504 extends longitudinally through chamber 2528 adjacent to outlet 2520. As shown in FIGS. 25F and 25H, the portion of debris collecting region 2514 opposite baffle 2512 is curved. Collector opening 2522 extends longitudinally through chamber 2528 along a midline of baffle 2512. The inner core 2510 is positioned directly above collector opening 2522. Outlet 2520 is separated into a left side and right side such that air can travel through outlet through either the left side or right side.

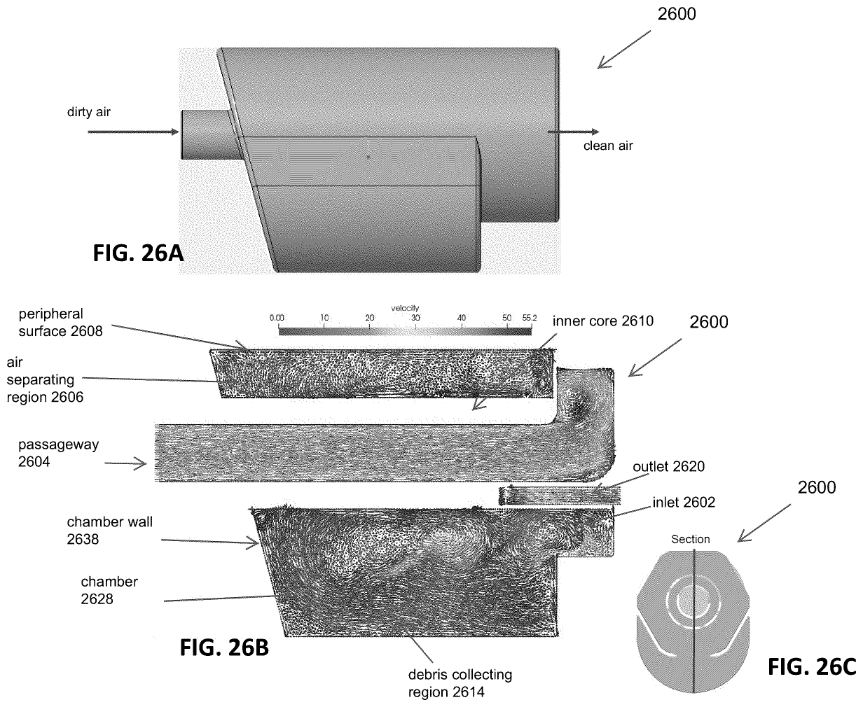

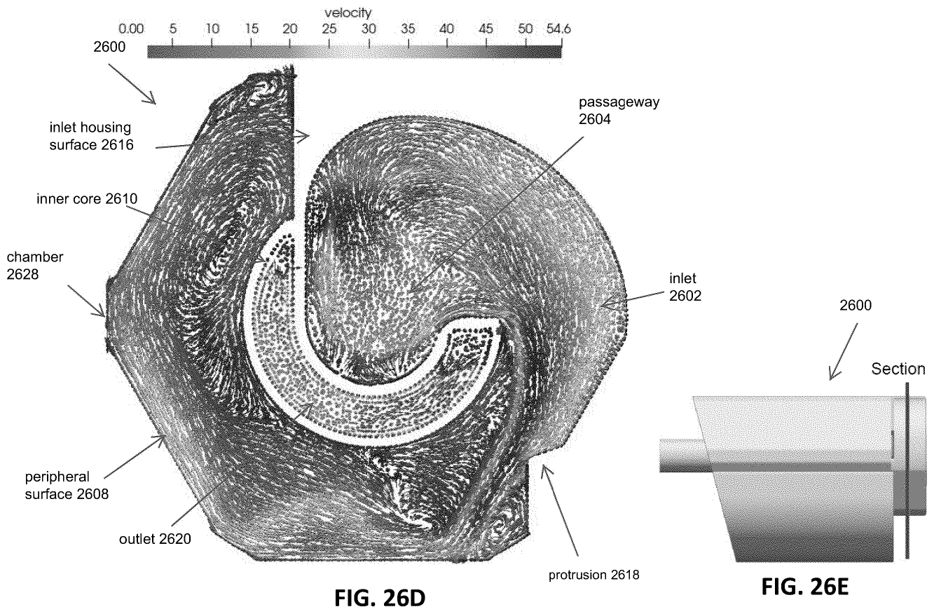

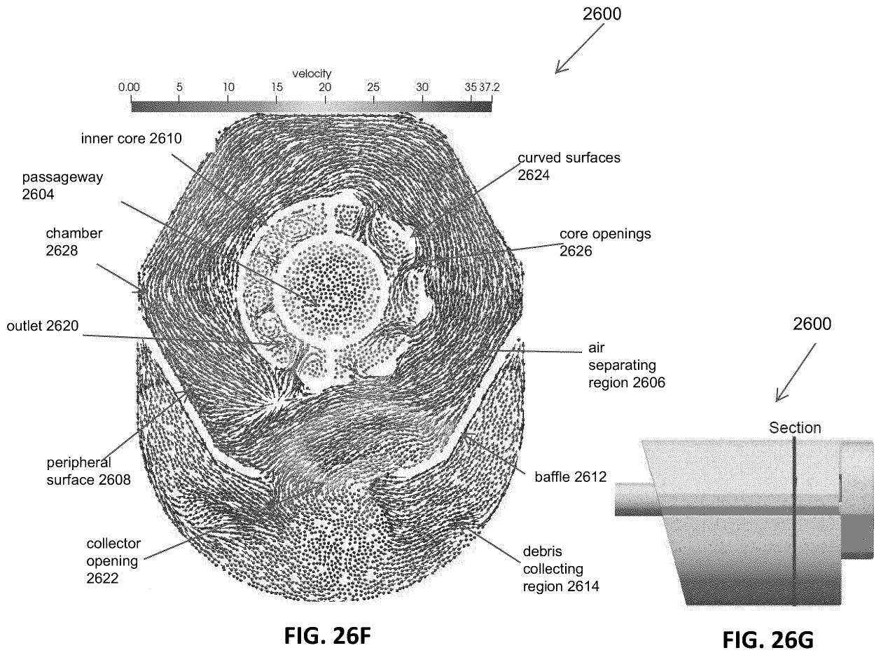

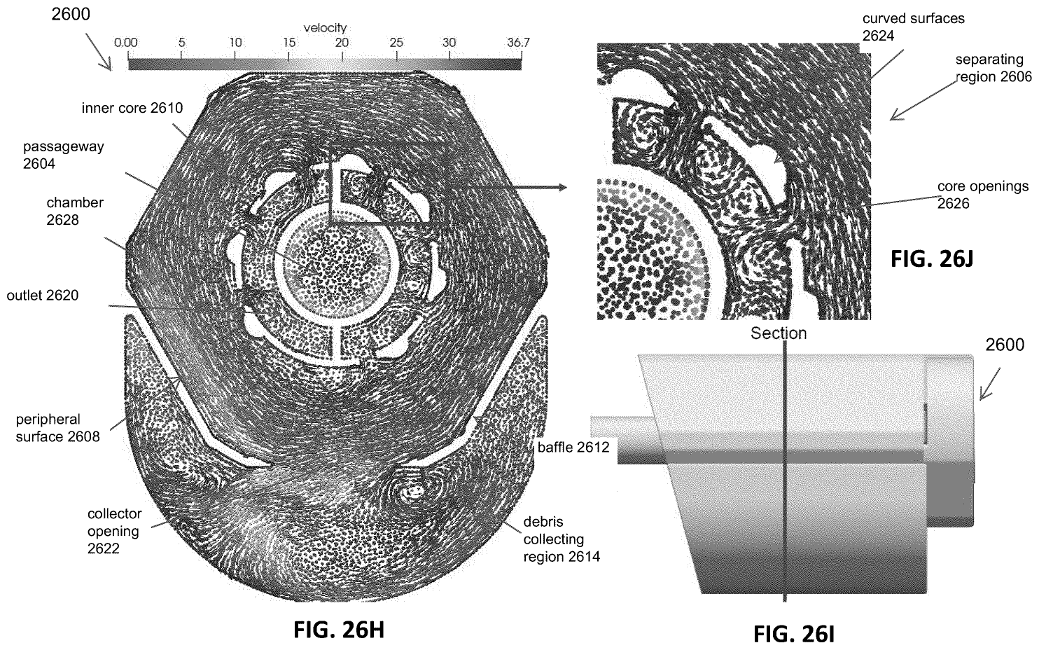

FIG. 26A is a side view of an example Coanda separator 2600. FIGS. 26B, 26D, 26F, and 26H, are computational fluid mechanics diagram illustrating fluid flow paths through Coanda separator 2600 at the cross sections shown in FIGS. 26C, 26E, 26G, and 26I respectively. FIG. 26J is an exploded view of inner core 2610 with curved surfaces 2624 and core openings 2626.

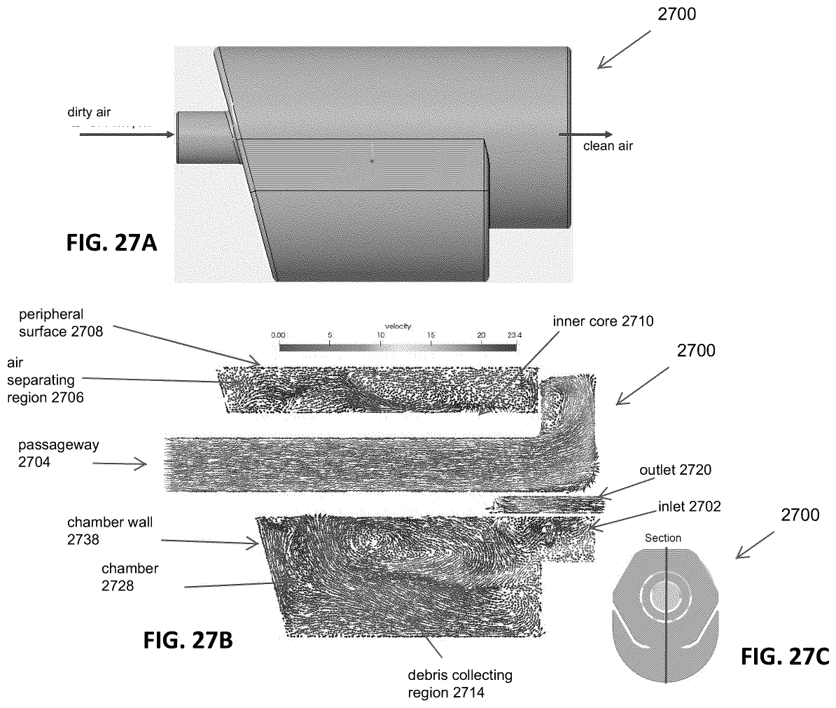

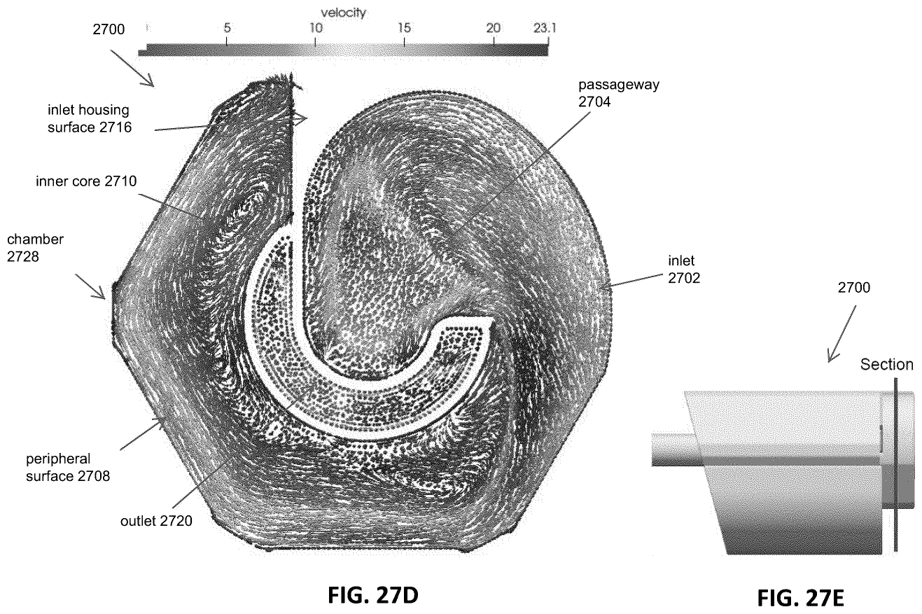

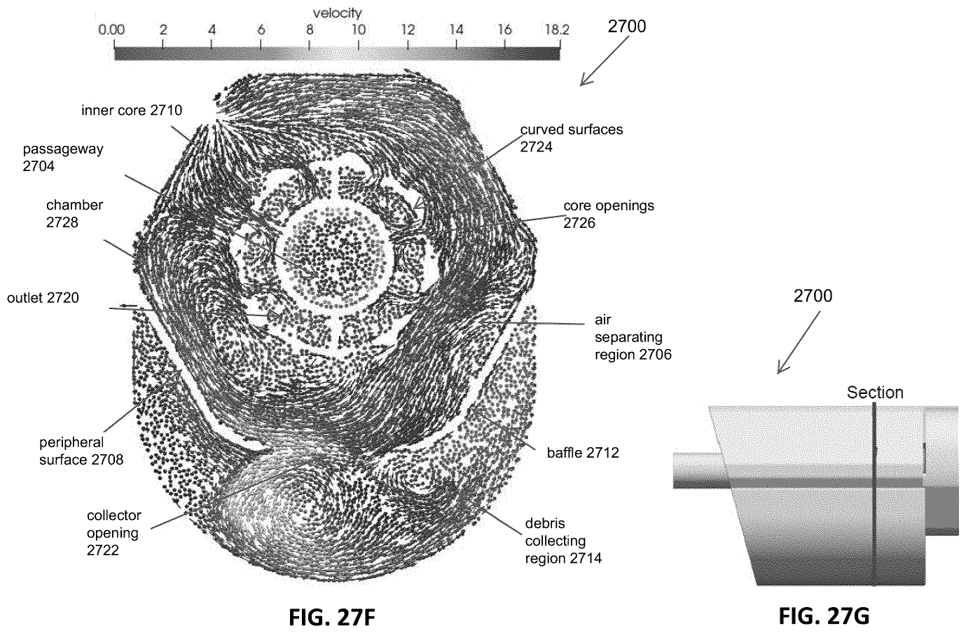

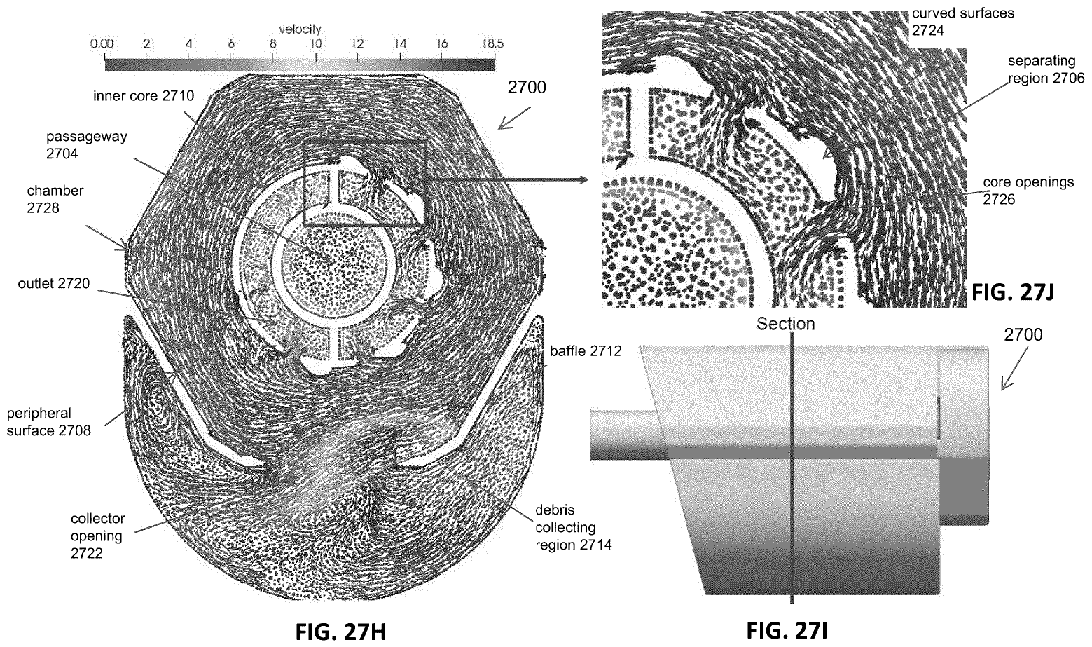

FIG. 27A is a side view of an example Coanda separator 2700. FIGS. 27B, 27D, 27F, and 27H, are computational fluid mechanics diagram illustrating fluid flow paths through Coanda separator 2700 at the cross sections shown in FIGS. 27C, 27E, 27G, and 27I respectively. FIG. 27J is an exploded view of inner core 2710 with curved surfaces 2724 and core openings 2726.

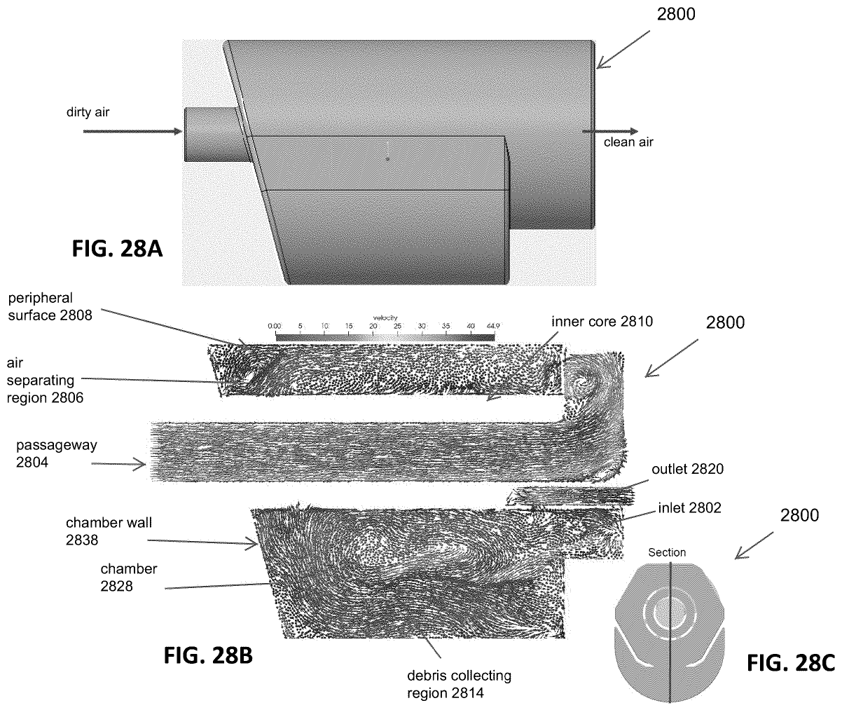

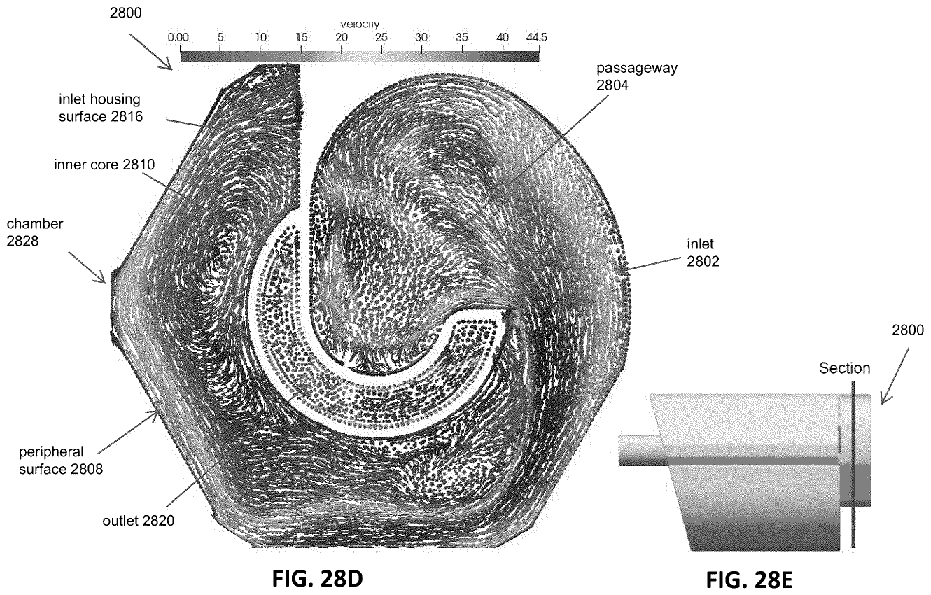

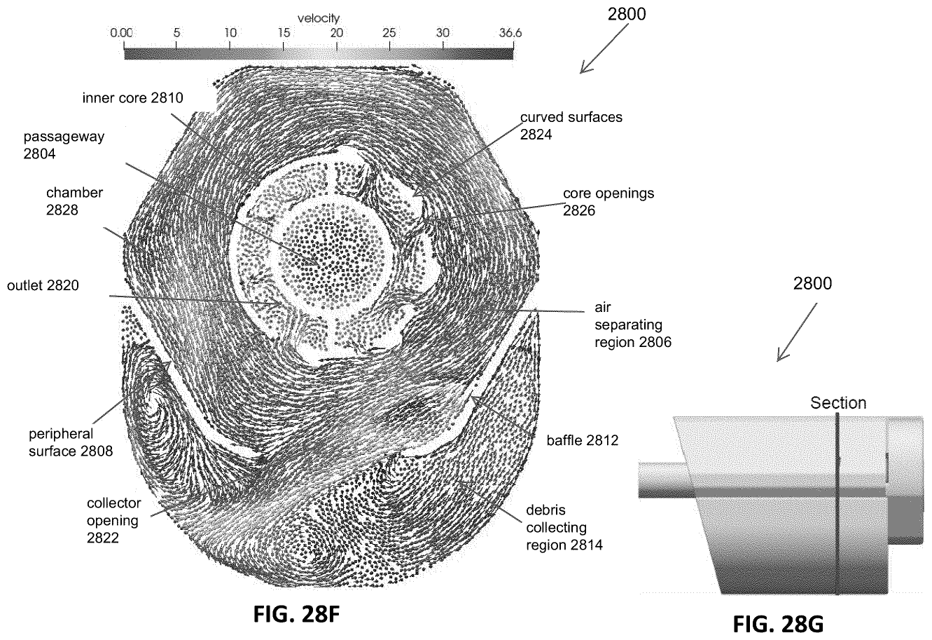

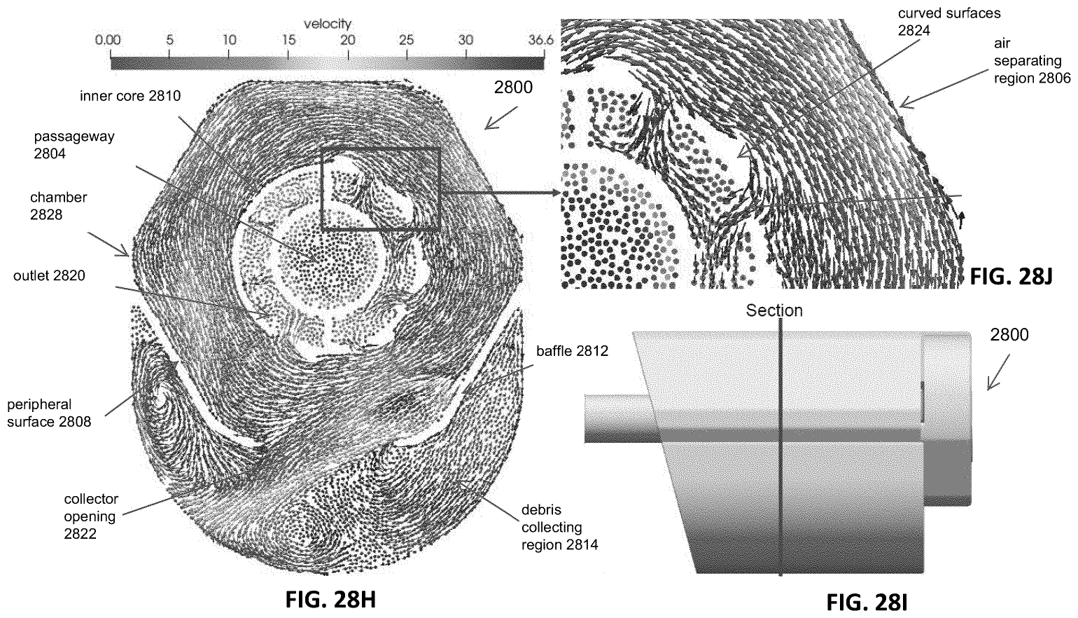

FIG. 28A is a side view of an example Coanda separator 2800. FIGS. 28B, 28D, 28F, and 28H, are computational fluid mechanics diagram illustrating fluid flow paths through Coanda separator 2800 at the cross sections shown in FIGS. 28C, 28E, 28G, and 28I respectively. FIG. 28J is an exploded view of inner core 2810 with curved surfaces 2824 and core openings 2826.

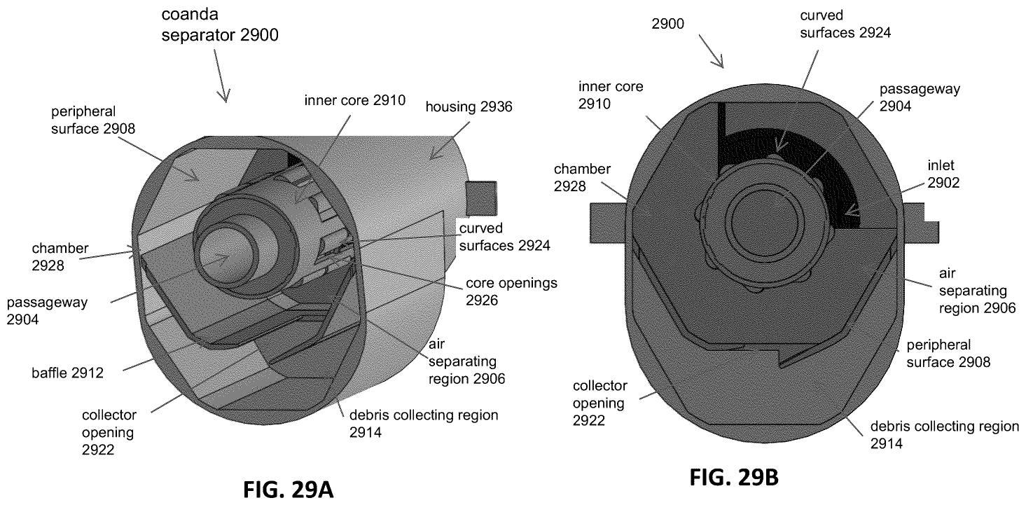

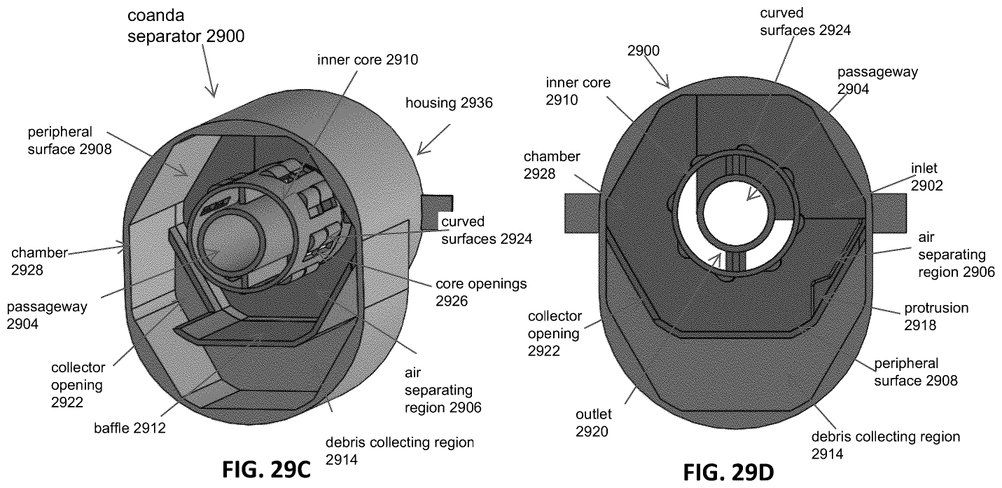

FIGS. 29A-29B illustrate an example Coanda separator 2900 according to some implementations. The collector opening 2922 extends longitudinally through the chamber 2928 along the center of the baffle 2912. As shown in FIG. 29B peripheral surface 2908 is non parallel on either side of collector opening 2922. FIGS. 29C-29D illustrate Coanda separator 2900 according to some implementations wherein collector opening 2922 extends longitudinally through the chamber 2928 along the left side of the baffle 2912 such that inner core 2910 is positioned between collector opening 2922 and inlet 2902. Collector opening 2922 is positioned on a substantially opposite side of chamber 2928 from inlet 2902. Outlet 2920 and/or inner core 2910 are divided into two portions (e.g., left side and right side) which inhibits air from rotating circularly within inner core 2910 as air travels toward outlet 2920.

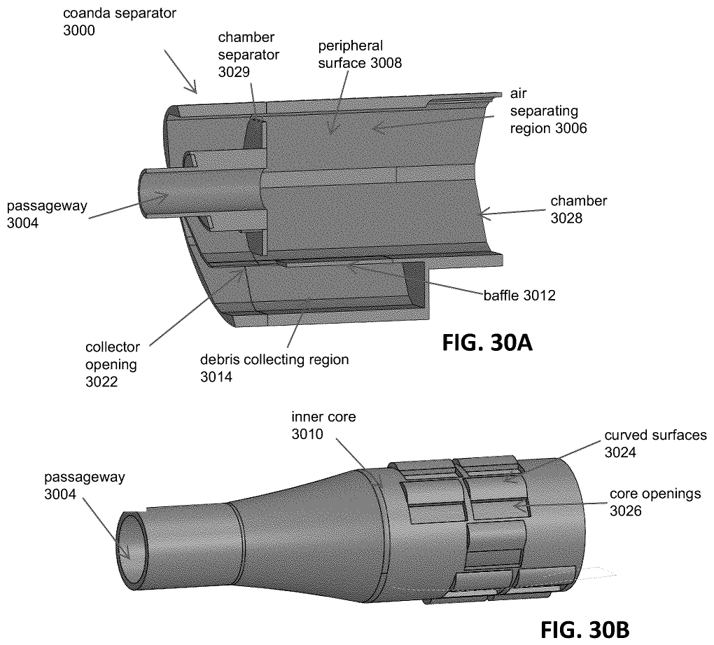

FIG. 30A illustrates an example Coanda separator 3000 with chamber separator 3029. Chamber separator 3029 isolates air separating region 2006 from other portion of chamber 3028. Chamber separator 3029 is positioned transversely within chamber 3028 adjacent to collector opening 3022 and adjacent to the end of baffle 3012. FIG. 30B illustrates an example inner core 3010 with a cylindrical portion and a tapered portion. At least some of the curved surfaces 3024 and/or core openings 3026 are arranged into pairs with each curved surface 3024 and/or core opening 3026 in a pair being disposed longitudinally adjacent to each other on the inner core 3010. At least one of curved surfaces 3024 and/or core openings 3026 is not paired with another curved surface 3024 and/or core opening 3026, respectively.

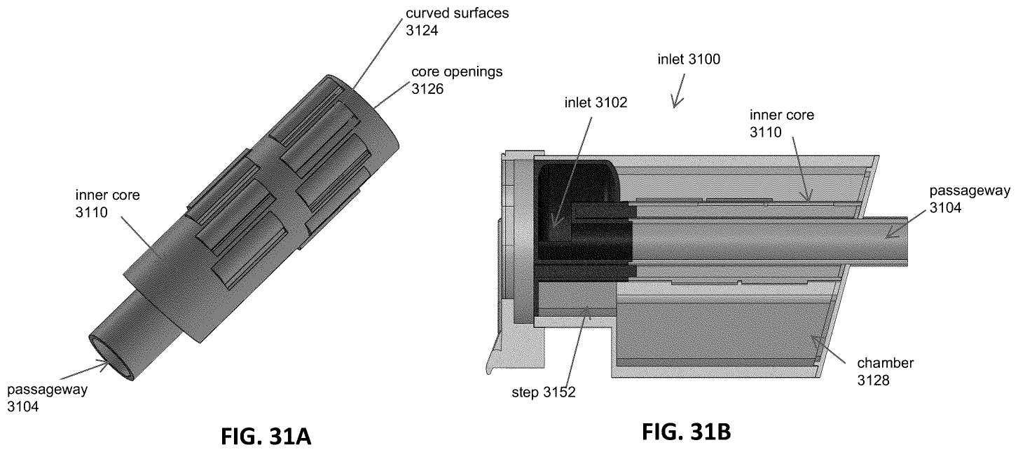

FIG. 31A illustrates an example inner core 3110 with curved surfaces 3124 and/or core openings 3126 arranged in pairs. FIG. 31B illustrates an example Coanda separator 3100 with step 3152 disposed adjacent to inlet 3102. Step 3152 reduces the cross-sectional area of chamber 3128 adjacent to inlet 3102 which can induce airflow from inlet 3102 to circulate around inner core 3110.

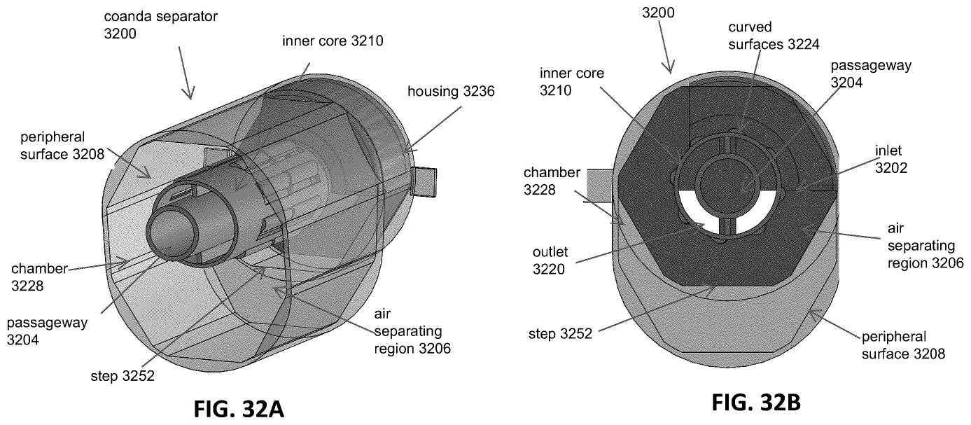

FIGS. 32A-32B illustrate an example Coanda separator 3200 without a baffle wherein chamber 3228 does not include a debris separating region that is separated from air separating region 3206 by a baffle. In this example, debris may collect at a peripheral surface at the bottom of air separating region 3206.

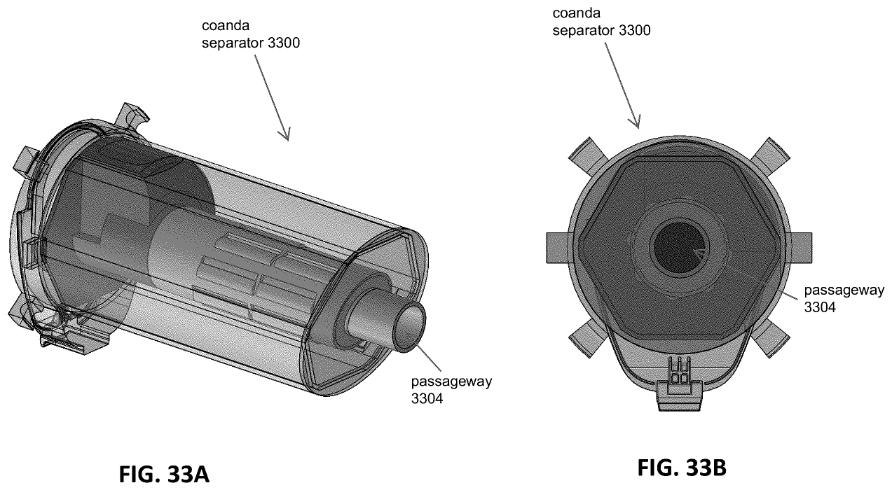

FIGS. 33A-33B illustrate an example Coanda separator 3300 according to some implementations.

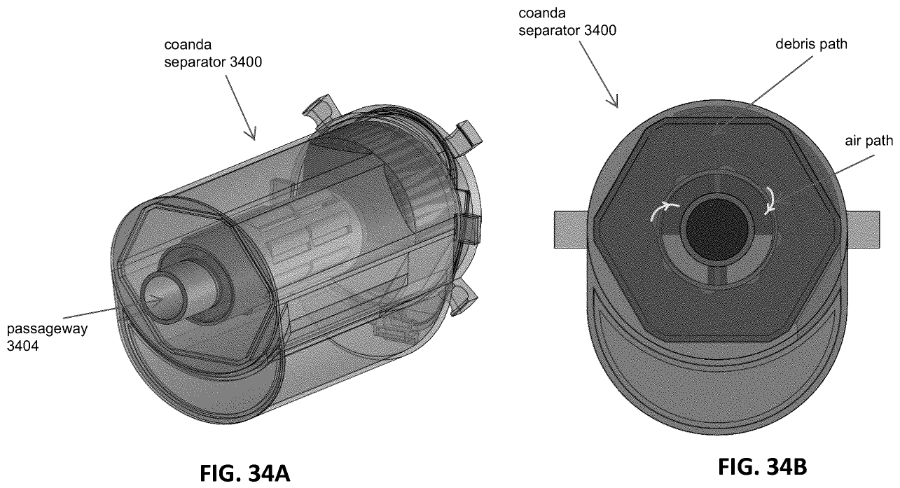

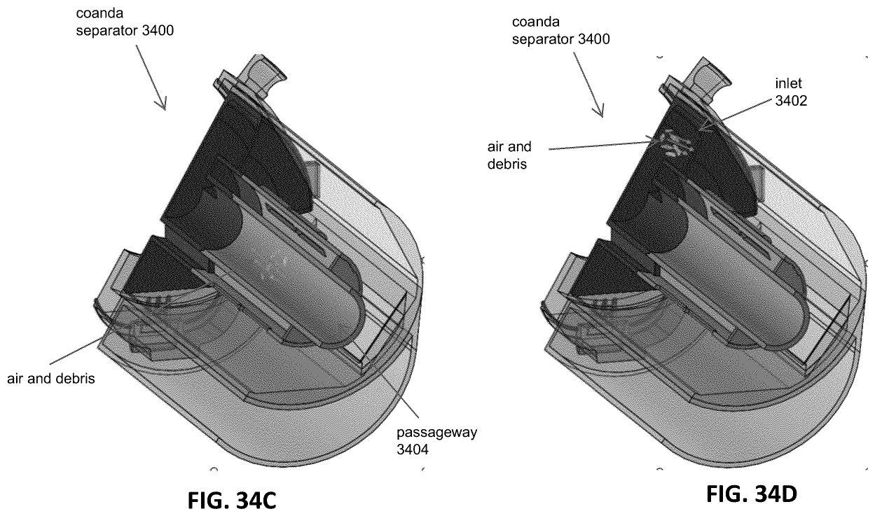

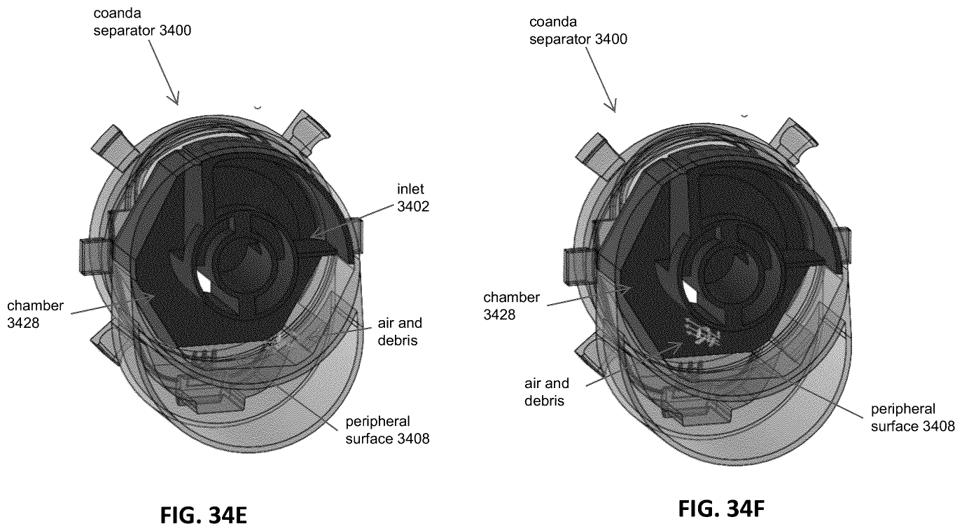

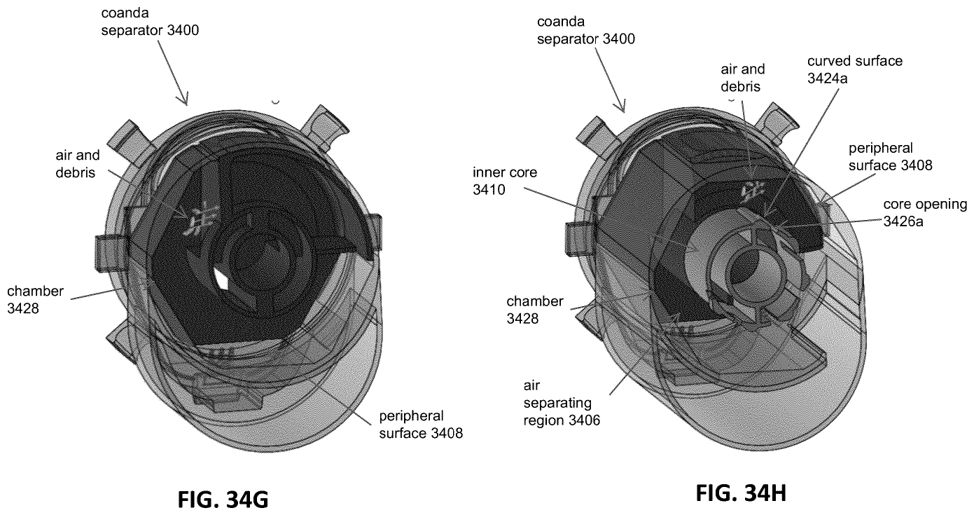

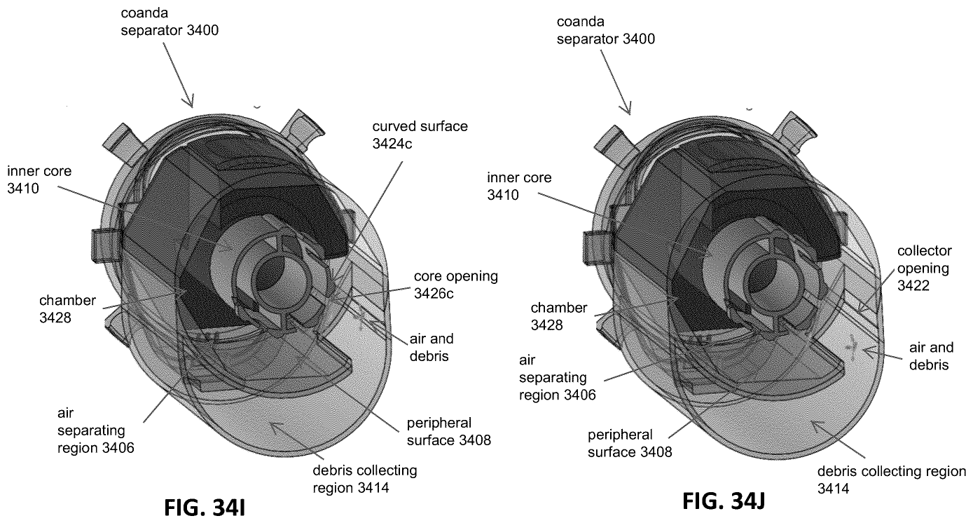

FIGS. 34A-34J illustrate an example Coanda separator 3400. As shown in FIG. 34B, debris and/or air can circulate around Coanda separator 3400 non-circularly as the debris and/or air ricochet off peripheral surface 3408. Air is separated from debris at inner 3410 by a Coanda effect. In FIGS. 34C-34D air and debris travel down passageway 3404 and enter inlet 3402. In FIGS. 34E-34G air and debris enter chamber 3428 from inlet 3402 and circulate around chamber 3428 as the air and debris ricochet off peripheral surface 3408. In FIG. 34H, a portion of the air is separated from the debris as that portion of air adheres to curved surface 3424a toward core opening 3426a due to Coanda effect. The debris is unaffected by Coanda effect and does not follow curved surface 3424a toward core opening 3426a but continues to travel through chamber 3428 and ricochet off peripheral surface 3408. In FIG. 34I, more air is separated from debris at curved surface 3424c and exits chamber 3428 through core opening 3426c. In FIGS. 34I-34J, debris and air enter debris collecting region 3414 through collector opening 3422 which may be due in part to gravity but is also due to velocity of the air and debris as they travel through chamber 3428 such that the debris and air may enter debris collecting region 3414 with more velocity than due to gravity alone.

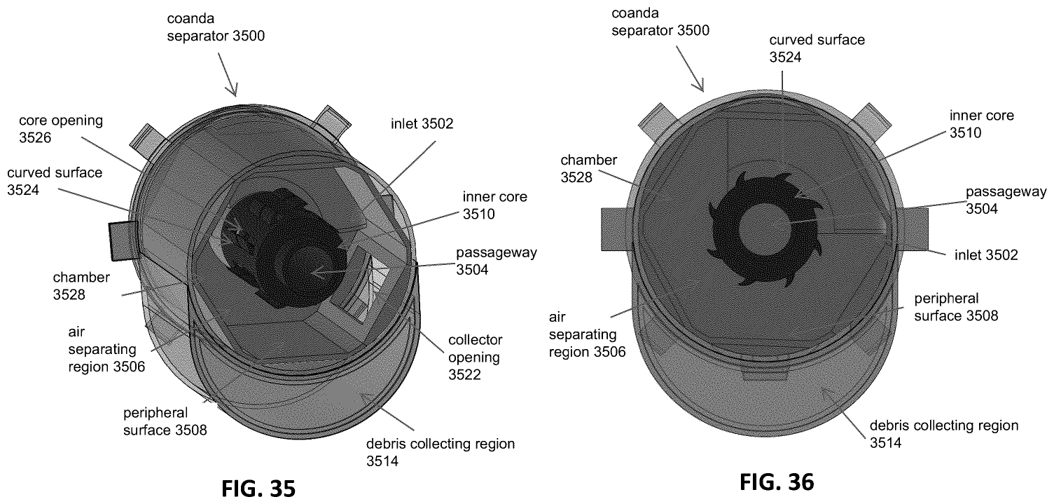

FIGS. 35-36 illustrate an example Coanda separator 3500 with collector opening 3522 positioned on a same side of chamber 3528 as inlet 3502. Collector opening 3522 occupies a single planar face of peripheral surface 3508.

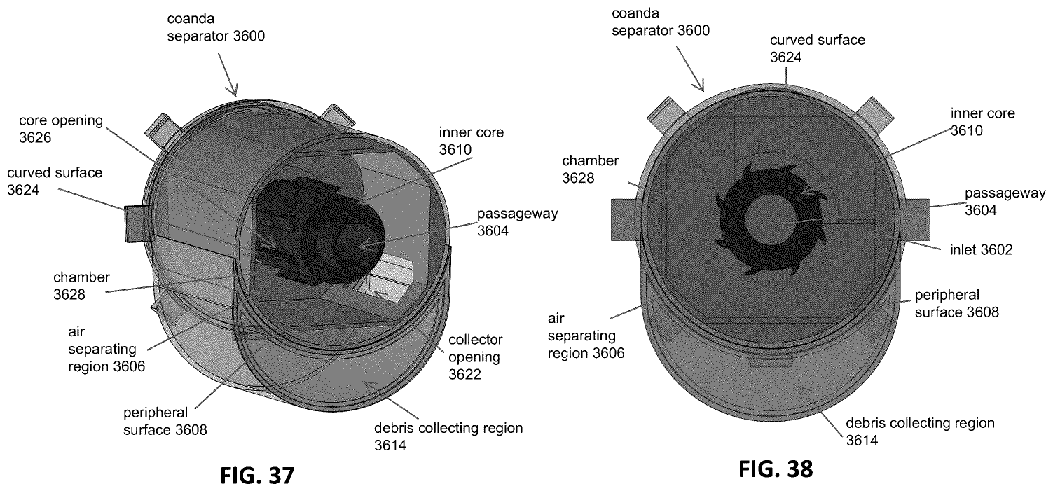

FIGS. 37-38 illustrate an example Coanda separator 3600 with collector opening 3622 positioned on a same side of chamber 3628 as inlet 3602. Collector opening 3622 occupies two adjacent planar faces of peripheral surface 3608. Peripheral surface 3608 has a polygonal cross-sectional profile with eight sides including four long sides and four short sides.

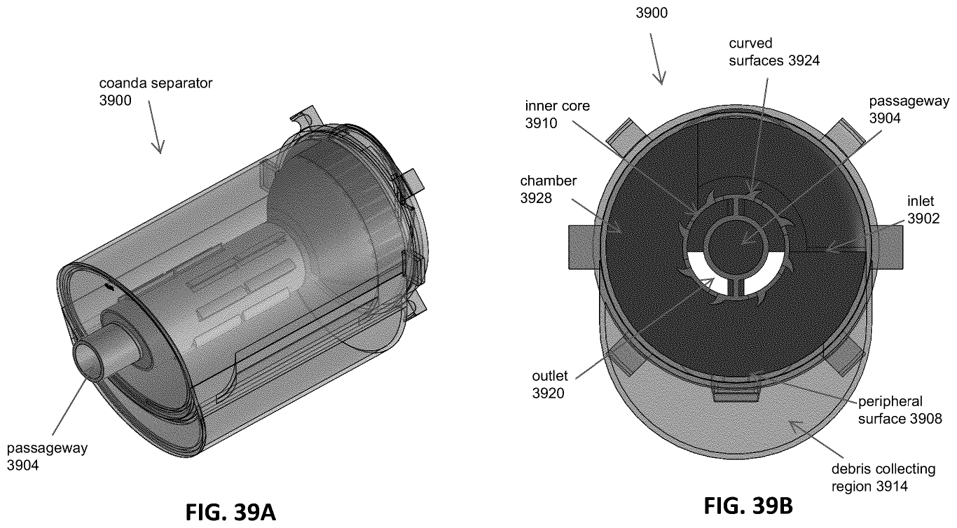

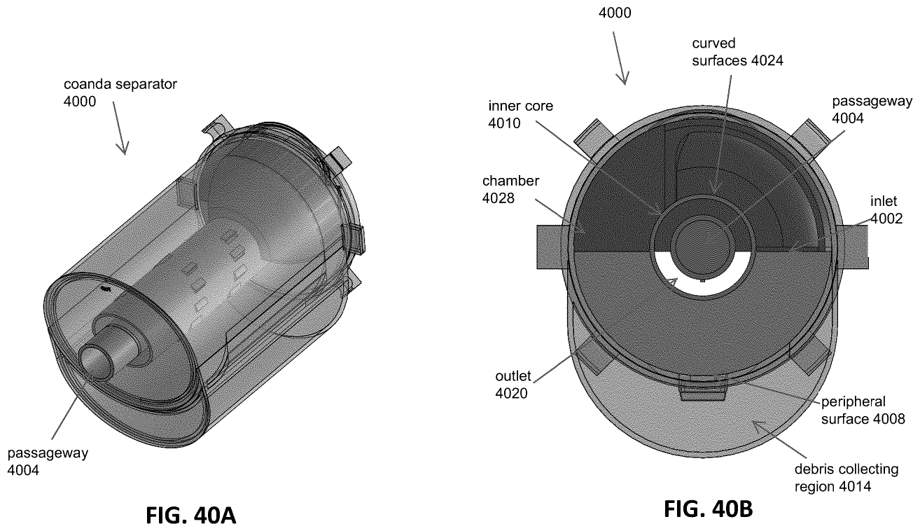

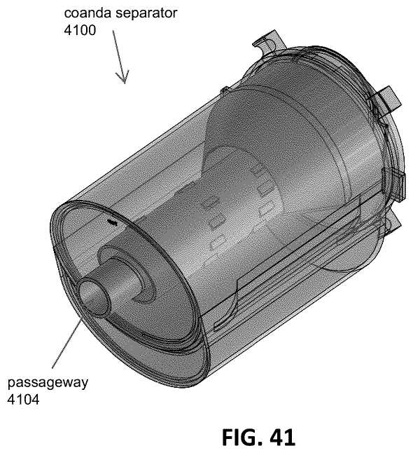

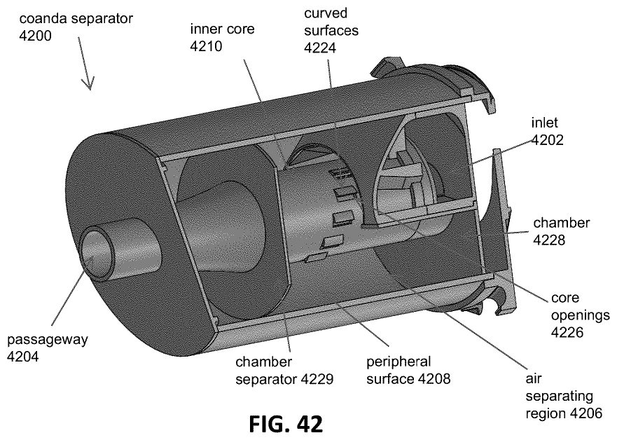

FIGS. 39A-39B illustrate an example Coanda separator 3900. FIGS. 40A-40B illustrate an example Coanda separator 4000. FIG. 41 illustrates an example Coanda separator 4100. FIG. 42 illustrates an example Coanda separator 4200 with chamber separator 4229 that separates air separating region 4206 from other regions of chamber 4228.

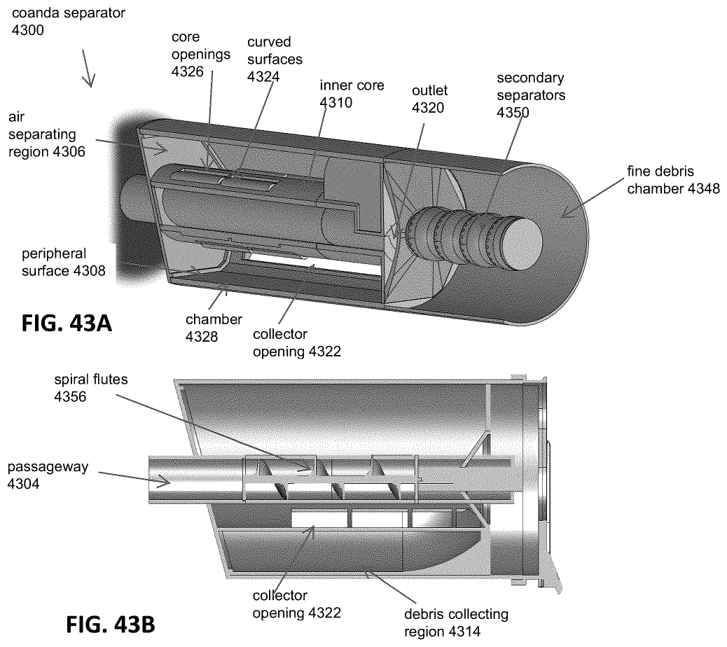

FIGS. 43A-43B illustrate an example Coanda separator 4300 with fine debris chamber 4348 positioned downstream from outlet 4320. Air having been separated from large debris within chamber 4328 can pass through outlet 4320 to fine debris chamber 4348. Fine debris chamber 4348 includes one or more secondary separators 4350 which can be Coanda separators (e.g., one or more curved surfaces separating air from debris with Coanda effect) and/or cyclone separators. The secondary separators 4350 can separate air from debris that is smaller (e.g., smaller mass and/or volume) than in chamber 4328. One or more spiral flutes 4356 are positioned within passageway 4304 and can induce a helical airflow path as air travels through passageway 4304.

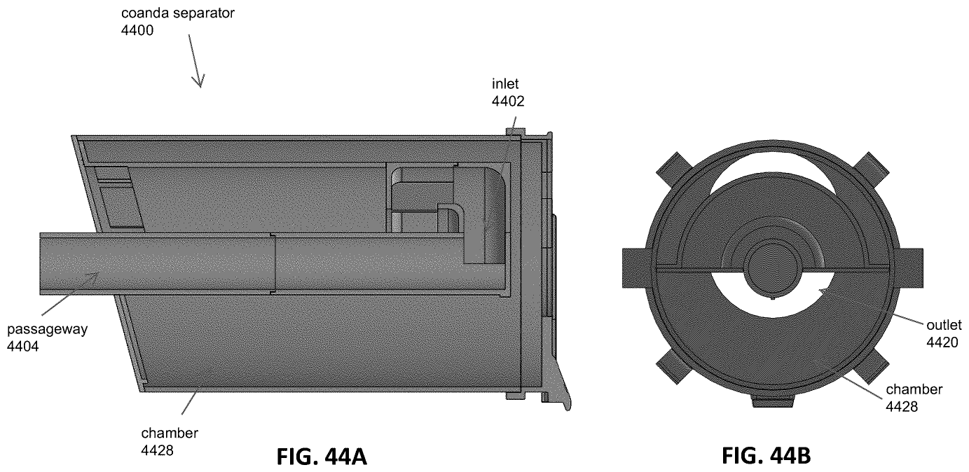

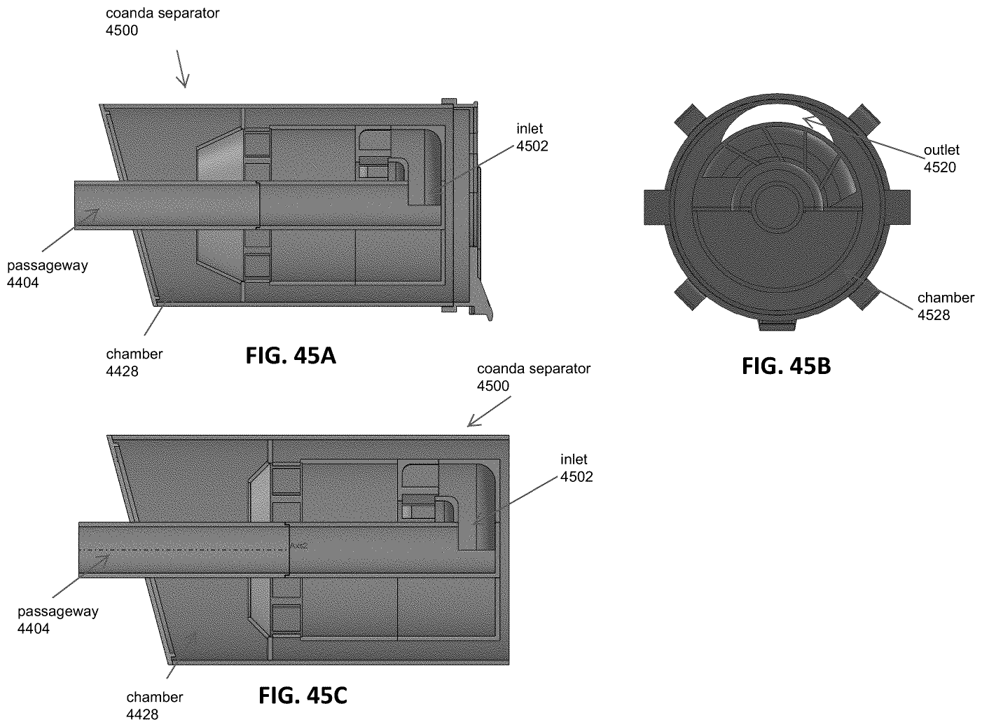

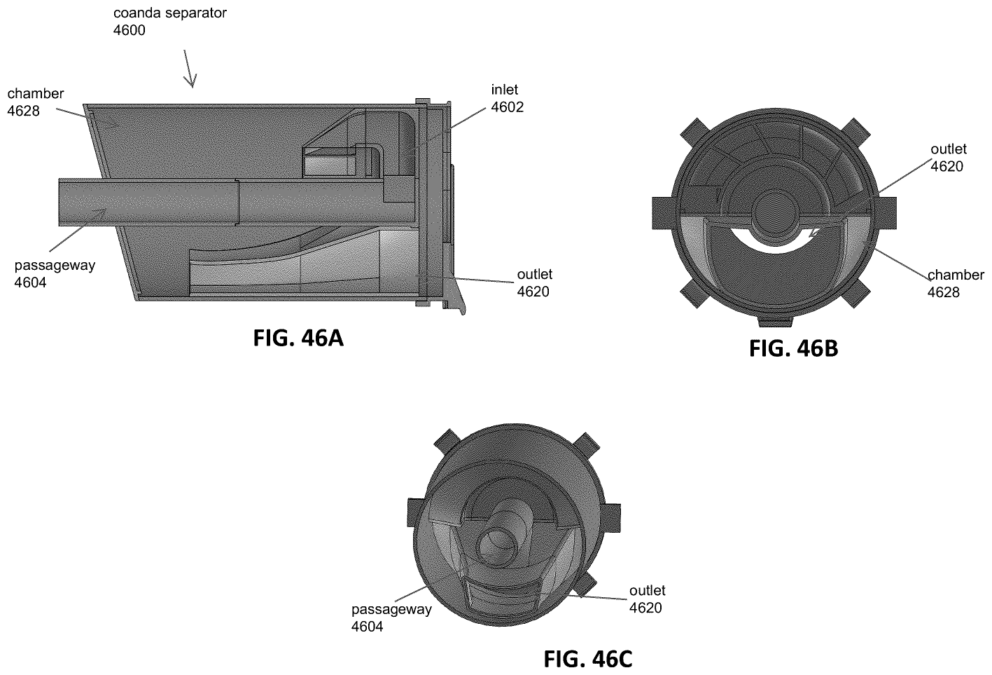

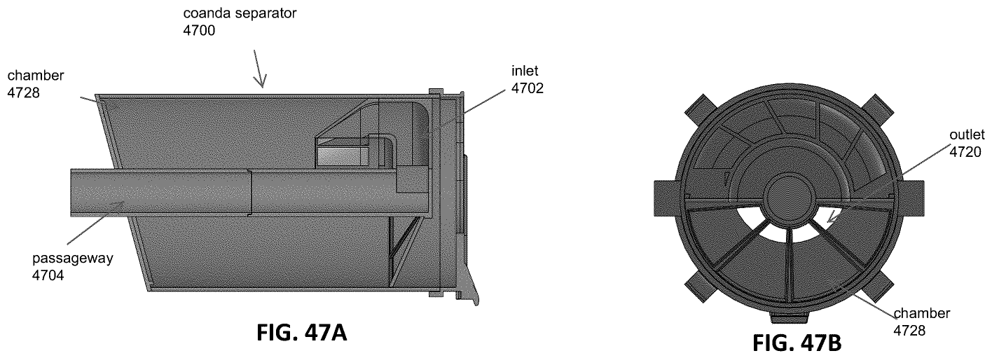

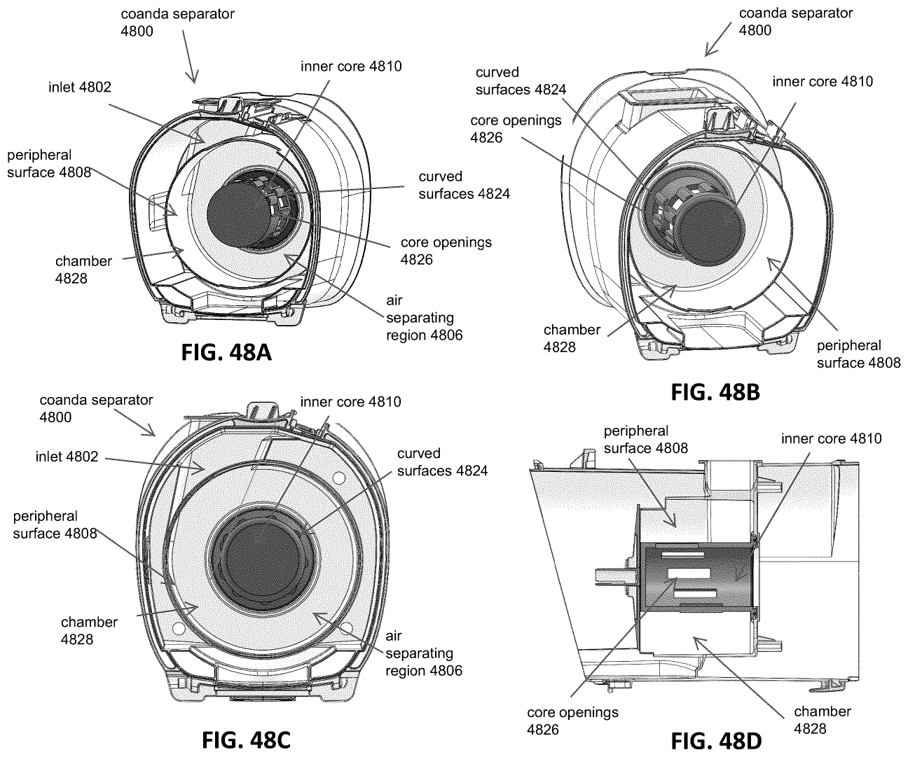

FIGS. 44A-44B illustrate an example Coanda separator 4400. FIGS. 45A-45C illustrate an example Coanda separator 4500 according to various implementations. FIGS. 46A-46C illustrate an example Coanda separator 4600. FIGS. 47A-47B illustrate an example Coanda separator 4700. FIGS. 48A-48D illustrate an example Coanda separator 4800.

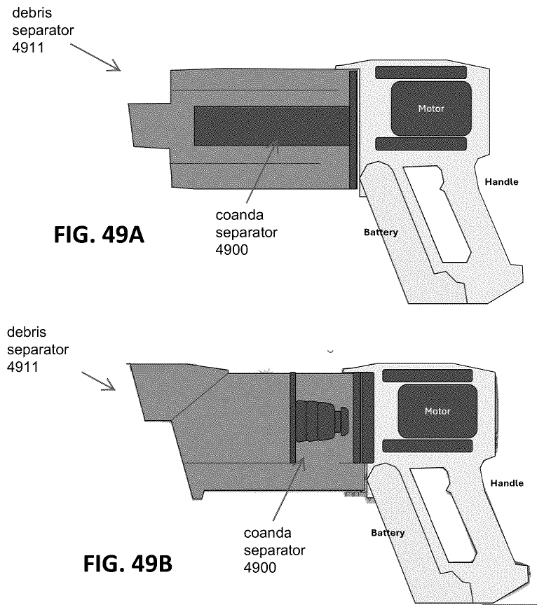

FIGS. 49A-49B illustrate an example surface cleaner 4911 that includes one or more Coanda separators 4900. Coanda separator 4900 can be a primary separator for separating large debris or a secondary separator for separating small debris. Surface cleaner 4911 can be handheld. Surface cleaner 4911 can include a motor for generating airflow, a handle, and a battery. Coanda separator 4900 can include similar structural and/or operational features as any of the example Coanda separators shown and/or described herein.

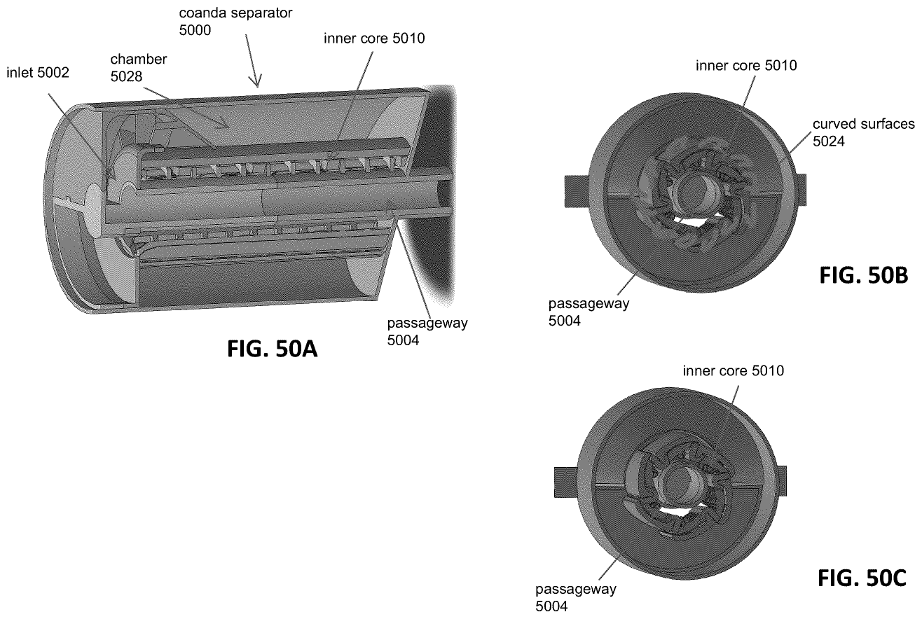

FIGS. 50A-50C illustrate an example Coanda separator 5000. Inner core 5010 includes curved surfaces 5024 as shown in FIG. 50B. In some implementations, inner core 5010 may not include curved surfaces as shown in FIG. 50C.

### Additional Considerations

Although certain implementations and examples have been described herein, it will be understood by those skilled in the art that many aspects of the systems and devices shown and described in the present disclosure may be differently combined and/or modified to form still further implementations or acceptable examples. All such modifications and variations are intended to be included herein within the scope of this disclosure. A wide variety of designs and approaches are possible. No feature, structure, or step disclosed herein is essential or indispensable. The various features and processes described herein may be used independently of one another, or may be combined in various ways. For example, elements may be added to, removed from, or rearranged compared to the disclosed example implementations. All possible combinations and sub-combinations are intended to fall within the scope of this disclosure.

Any methods and processes described herein are not limited to any particular sequence, and the blocks or states relating thereto can be performed in other sequences that are appropriate. For example, described blocks or states may be performed in an order other than that specifically disclosed, or multiple blocks or states may be combined in a single block or state, or certain method or process blocks may be omitted, or certain blocks or states may be performed in a reverse order from what is shown and/or described. The example blocks or states may be performed in serial, in parallel, or in some other manner. Blocks or states may be added to or removed from the disclosed example implementations.

The methods disclosed herein may include certain actions taken by a practitioner; however, they can also include any third-party instruction of those actions, either expressly or by implication.

Conditional language used herein, such as, among others, “can,” “could,” “might,” “may,” “e.g.,” and the like, unless specifically stated otherwise, or otherwise understood within the context as used, is generally intended to convey that certain features, elements, and/or steps are optional. Thus, such conditional language is not generally intended to imply that features, elements, and/or steps are in any way required or that one or more embodiments necessarily include logic for deciding, with or without other input or prompting, whether these features, elements, and/or steps are included or are to be always performed. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 10 degrees, 5 degrees, 3 degrees, or 1 degree. As another example, in certain embodiments, the terms “generally perpendicular” and “substantially perpendicular” refer to a value, amount, or characteristic that departs from exactly perpendicular by less than or equal to 10 degrees, 5 degrees, 3 degrees, or 1 degree.

As used herein, “real-time” or “substantial real-time” may refer to events (e.g., receiving, processing, transmitting, displaying etc.) that occur at a same time as each other, during a same time as each other, or overlap in time with each other. “Real-time” may refer to events that occur at distinct or non-overlapping times the difference between which is imperceptible and/or inconsequential to humans such as delays arising from electrical conduction or transmission. A human may perceive real-time events as occurring simultaneously, regardless of whether the real-time events occur at an exact same time. As a non-limiting example, “real-time” may refer to events that occur within a time frame of each other that is on the order of milliseconds, seconds, tens of seconds, or minutes. For example, “real-time” may refer to events that occur within a time frame of less than 1 minute, less than 30 seconds, less than 10 seconds, less than 1 second, less than 0.05 seconds, less than 0.01 seconds, less than 0.005 seconds, less than 0.001 seconds, etc.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, “system,” “instrument,” “apparatus,” and “device” generally encompass both the hardware (for example, mechanical and electronic) and, in some implementations, associated software (for example, specialized computer programs for operational control) components.

It should be emphasized that many variations and modifications may be made to the herein-described implementations, the elements of which are to be understood as being among other acceptable examples. All such modifications and variations are intended to be included herein within the scope of this disclosure. Any section headings used herein are merely provided to enhance readability and are not intended to limit the scope of the implementations disclosed in a particular section to the features or elements disclosed in that section. The foregoing description details certain implementations. It will be appreciated, however, that no matter how detailed the foregoing appears in text, the systems and methods can be practiced in many ways. As is also stated herein, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

While the above detailed description has shown, described, and pointed out novel features, it can be understood that various omissions, substitutions, and changes in the form and details of the devices or algorithms illustrated can be made without departing from the spirit of the disclosure. As can be recognized, certain portions of the description herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A vacuum cleaner comprising:
a dirty air inlet receiving air and debris;
a clean air outlet discharging the air without the debris;
a suction motor moving the air along a flow path from the dirty air inlet to the clean air outlet; and
a separator positioned within the flow path to divide the air and the debris, the separator including:
a chamber including an inlet downstream of the dirty air inlet, and an outlet upstream of the clean air outlet, at least a portion of the interior of the chamber forming a polygon having side segments;
a core positioned within an approximate center of the chamber including a longitudinal axis and a hollow interior along the longitudinal axis forming a clean air flow path toward the outlet of the chamber;
a plurality of vias through an exterior of the core, each via forming one or more through holes from the hollow interior of the chamber to the clean air flow path within the core; and
a plurality of Coanda foils on the exterior of the core;
the inlet of the chamber directing air toward an exterior of the core along the plurality of Coanda foils, each Coanda foil bending air flow along a surface of the Coanda foil toward one or more of the vias and into the clean air flow path of the core while the debris ricochets around the side segments of the chamber dividing the debris from the air flowing through the vias.

2. The vacuum cleaner of claim 1, comprising an air filter downstream of the separator and upstream of the clean air outlet.

3. The vacuum cleaner of claim 1, wherein the inlet of the chamber directs the air tangential to the exterior of the core.

4. The vacuum cleaner of claim 1, comprising a passageway configured to conduct the air and the debris from the dirty air inlet to the inlet of the chamber.

5. The vacuum cleaner of claim 4, wherein the passageway is positioned outside of the chamber.

6. The vacuum cleaner of claim 4, wherein the passageway extends through the chamber.

7. The vacuum cleaner of claim 6, wherein the passageway extends through the hollow interior of the core along the longitudinal axis of the chamber.

8. The vacuum cleaner of claim 1, comprising a debris collecting region in the chamber configured to collect debris.

9. The vacuum cleaner of claim 8, comprising a baffle configured to separate the debris collecting region from the hollow core.

10. A surface cleaner that removes debris by directing airflow away from a surface, the surface cleaner comprising:
a suction motor moving air along a flow path away from the surface;
a separating chamber including a dirty air inlet upstream of a clean air outlet along the flow path;
a hollow core positioned within the separating chamber, the hollow core including a clean air return along an interior of the hollow core downstream of the dirty air inlet and upstream of the clean air outlet of the separating chamber;
a plurality of curved surfaces protruding from an exterior of the hollow core; and
a plurality of openings along the exterior of the hollow core forming vias from the interior of the separating chamber to the clean air return of the hollow core, the air staying attached to the curved surfaces, bending toward the openings, and flowing through the vias to the clean air return while the debris ricochets off the curved surfaces causing separation from the air.

11. The surface cleaner of claim 10, comprising an inlet housing surface within the chamber configured to disrupt airflow within the separating chamber after the air enters the separating chamber from the dirty air inlet to inhibit air from circulating around the separating chamber in a circle after entering the separating chamber.

12. The surface cleaner of claim 10, wherein the hollow core is positioned along a longitudinal center of the separating chamber.

13. A surface cleaner that provides an airflow away from a surface to remove debris, the surface cleaner comprising:
a dirty air inlet;
a clean air outlet;
a suction motor moving air along a flow path from the dirty air inlet to the clean
air outlet, wherein when the dirty air inlet is positioned proximate the surface, the moving air transports debris away from the surface; and
a Coanda separator positioned within the flow path to separate the air and the debris.

14. The surface cleaner of claim 13, wherein the Coanda separator comprises:
a chamber including an inlet downstream of the dirty air inlet configured to introduce the air entrained with the debris into the chamber, the chamber comprising a peripheral surface having one or more planar faces;
an inner core positioned within the chamber having hollow interior configured to conduct clean air toward the dirty air outlet;
a plurality of core openings configured to conduct the air from the chamber to the hollow interior of the inner core without the debris; and
a plurality of curved surfaces on the inner core adjacent to the plurality of core openings configured to induce the air to travel along the curved surface toward the plurality of core opening with a Coanda effect to separate the air from the debris.

15. The surface cleaner of claim 14, wherein the inlet of the chamber is configured to introduce the air entrained with the debris into the chamber tangentially to the inner core.

16. The surface cleaner of claim 14, wherein the inlet of the chamber is configured to introduce the air entrained with the debris into the chamber at an angle with respect to at least one of the planar faces of the peripheral surface.

17. The surface cleaner of claim 14, wherein the peripheral surface has a polygonal cross-sectional profile.

18. The surface cleaner of claim 14, wherein the plurality of curved surfaces are arranged around a longitudinal axis of the chamber and induce the air to flow toward the plurality of core openings out of the chamber to inhibit the air from forming a cyclone around the longitudinal axis of the chamber.

19. The surface cleaner of claim 14, wherein the Coanda separator is configured to form a pressure gradient in the chamber wherein the air entrained with the debris travels at faster velocities adjacent to the peripheral surface than adjacent to the inner core positioned along a longitudinal axis of the chamber, wherein the pressure gradient inhibits the air from forming a cyclone around the longitudinal axis of the chamber.

20. A multi-stage vacuum cleaner comprising:
a suction motor moving air along a flow path from a dirty air inlet to a clean air outlet, the dirty air inlet configured to receive the air mixed with comparatively larger and smaller debris, the clean air outlet configured to discharge the air without the larger and smaller debris;
a primary separator within the flow path and shaped to divide the comparatively larger debris and the air; and
a secondary separator within the flow path downstream from the primary separator and shaped to divide the comparatively smaller debris from the air,
wherein one or more of the primary separator and secondary separators comprise a Coanda separator.

21. The multi-stage vacuum cleaner of claim 20, wherein the primary separator comprises the Coanda separator shaped to remove the air from the comparatively larger debris.

22. The multi-stage vacuum cleaner of claim 21, wherein the secondary separator comprises an additional Coanda separator shaped to remove the air from the comparatively smaller debris.

23. The multi-stage vacuum cleaner of claim 21, wherein the secondary separator comprises a Cyclone separator shaped to remove the comparatively smaller debris from the air.

24. The multi-stage vacuum cleaner of claim 20, wherein the secondary separator comprises the Coanda separator shaped to remove the air from the comparatively smaller debris.

25. The multi-stage vacuum cleaner of claim 24, wherein the primary separator comprises an additional Coanda separator shaped to remove the air from the comparatively larger debris.

26. The multi-stage vacuum cleaner of claim 24, wherein the primary separator comprises a Cyclone separator shaped to remove the comparatively larger debris from the air.

27. The multi-stage vacuum cleaner of claim 20, wherein the secondary separator comprises more than two (2) secondary separators.

28. The multi-stage vacuum cleaner of claim 20, wherein the other of the primary separator and secondary separator that does not comprises the Coanda separator comprises a filter.
